(19) United States
(12) Patent Application Publication
(10) Pub. No.: US 2010/0027625 A1
(43) Pub. Date: Feb. 4, 2010

(54) APPARATUS FOR ENCODING AND DECODING

(76) Inventors: Tilo Wik, Esslingen (DE); Dieter Weninger, Markt Erlbach (DE); Juergen Herre, Buckenhof (DE)

Correspondence Address: SCHOPPE, ZIMMERMANN , STOCKELER & ZINKLER;C/O KEATING & BENNETT, LLP, 1800 Alexander Bell Drive, SUITE 200, Reston, VA, 20191, US

(21) Appl. No.: 12/514,629

(22) PCT Filed: Nov. 16, 2007
(86) PCT No.: PCT/EP07/09941

§ 371 Date: May 13, 2009

(30) Foreign Application Priority Data
Nov. 16, 2006 (DE) 102006054080.8
Apr. 12, 2007 (DE) 102007017254.2

(51) Int. Cl. H04N 11/04

(52) U.S. Cl. 375/240.12; 375/240.23; 375/E07.001

(57) ABSTRACT

An apparatus for encoding a sequence of samples of an audio signal, with each sample within the sequence having an original position, includes a sorter for sorting the samples depending on their sizes, in order to obtain a sorted sequence of samples, with each sample having a sorting position within the sorted sequence. Furthermore, the apparatus has an encoder for encoding the sorted samples and information on a relation between the original and sorting positions of the samples.

### BACKGROUND OF THE INVENTION

The present invention relates to an apparatus and a method for encoding and decoding information signals, such as may occur in audio and video coding, for example.

In the encoding and decoding of information signals, so-called lossy coding methods are known in the field of conventional technology. For example, there already exist transform-based coding methods, such as MPEG 1/2 layer-3 (MPEG=moving picture expert group, MP3) or Advanced Audio Coding (AAC). These work with a time-frequency transform and a psycho-acoustic model, which is capable of discriminating perceivable signal proportions from non-perceivable signal proportions. The ensuing quantization of the data in the frequency domain is controlled with these models. Yet, if there is only a small data volume available for the encoded signals, so that it can be complied with a low overall bit rate, for example, the result is a rougher quantization, i.e. clearly perceivable coding artefacts are created by the quantization.

In conventional technology, the parametric coding methods are also known, such as Philips Parametric Coding HILN (Harmonic and Individual Lines and Noise), etc., which synthesize the original signal on the decoder side. Thereby, corruption of the original sound characteristic develops at low bit rates, i.e. such coding methods may then have perceivable differences from the original.

In the field of lossless coding, in principle, there are two different approaches. The first method relies on predicting the time signal. The predictor error developed is then entropy-coded and is stored and/or transmitted, e.g. in SHORTEN (cf. Tony Robinson: SHORTEN: Simple lossless and near lossless waveform compression. Technical report CUED/F-INFENG/TR.156, Cambridge University Engineering Department, December 1994) or AudioPaK (cf. Mat Hans, Ronald W. Schafer: Lossless Compression of Digital Audio, IEEE Signal Processing Magazine, July 2001).

As a first processing step, the second method uses a time-frequency transform with ensuing lossy coding of the spectrum developed. In addition, the error developed in the reverse transform may also be entropy-coded so as to guarantee for lossless coding of the signal, e.g. LTAC (Lossless Transform Audio Compression, cf. Tilman Liebchen, Marcus Purat, Peter Noll: Lossless Transform Coding of Audio Signals, 102^{nd} AES Convention, 1997) and MPEG-4 SLS (Scalable Lossless Coding, cf. Ralf Geiger, et. al.: ISO/IEC MPEG-4 High-Definition Scalable Advanced Audio Coding, 120^{th} AES Convention, May 2006).

Furthermore, there are two basic ways of data reduction. The first possibility corresponds to a redundancy reduction. Here, a non-uniform probability distribution of an underlying alphabet of the signal is utilized. Symbols having a higher occurrence probability are represented with e.g. less bits than symbols with a lower occurrence probability. This principle is often also referred to as entropy coding. In the encoding/decoding process, no data is lost. Perfect (lossless) reconstruction of the data thus is possible again. The second possibility concerns irrelevance reduction. In this type of data reduction, information not relevant for the user is removed in a targeted manner. Models of natural perceptual limitations of the human senses are often used as the basis for this. In the case of audio coding, a psycho-acoustic consideration of the input signals serves as a perception model, which then controls the quantization of the data in the frequency domain, cf. e.g. E. Zwicker: Psychoakustik, Springer-Verlag, 1982. Since data is removed from the encoding/decoding process in a targeted manner, perfect reconstruction of the data is no longer possible. Thus, this is a lossy data reduction.

In common transform-based audio coding methods, the input data is transformed from the time into the frequency domain and quantized there with the aid of a psycho-acoustic model. Ideally, this quantization introduces only that much quantization noise into the signal so that it is not perceivable to the listener, which cannot be fulfilled for low bit rates, however—clearly audible coding artefacts develop. Furthermore, at low target bit rates, downsampling with preceding low-pass filtering may often be performed, so that transmission of high-frequency proportions of the original signal then is not easily possible anymore. These processing steps claim significant computation power and entail a limitation of the signal quality.

### SUMMARY

According to an embodiment, an apparatus for encoding a sequence of samples of an information signal, with each sample within the sequence having an original position, may have: a sorter for sorting the samples depending on their sizes, in order to acquire a sorted sequence of samples, with each sample having a sorting position within the sorted sequence; an adjuster for adjusting functional coefficients of a functional rule for adaptation of the functional rule to a partial range of the sorted sequence; and an encoder for encoding the functional coefficients, the samples outside the partial range and information on a relation between the original and sorting positions of the samples.

According to another embodiment, a method of encoding a sequence of samples of an information signal, with each sample within the sequence having an original position, may have the steps of: sorting the samples depending on their sizes, in order to acquire a sorted sequence of samples, with each sample having a sorting position within the sorted sequence; adjusting functional coefficients of a functional rule for adaptation of the functional rule to a partial range of the sorted sequence; and encoding the functional coefficients, the samples outside the partial range and information on a relation between the original and sorting positions of the samples.

According to another embodiment, an apparatus for decoding a sequence of samples of an information signal, with each sample within the sequence having an original position, may have: a receiver for receiving encoded functional coefficients, sorted samples and information on a relation between a sorting position and the original position of samples; a decoder for decoding samples; an approximator for approximating samples on the basis of functional coefficients in a partial range of the sequence; and a re-sorter for re-sorting the samples and the partial range on the basis of the information on the relation between the original and sorting positions, so that each sample has its original position.

According to another embodiment, a method of decoding a sequence of samples of an information signal, with each sample within the sequence having an original position, may have the steps of: receiving encoded functional coefficients, sorted samples and information on a relation between a sorting position and the original position of samples; decoding samples; approximating samples on the basis of the functional coefficients in a partial range of the sequence; and re-sorting the samples and the partial range on the basis of the information on the relation between the original and sorting positions, so that each sample has its original position.

According to another embodiment, an apparatus for encoding a sequence of samples of an information signal, with each sample within the sequence having an original position, may have: a sorter for sorting the samples depending on their sizes, in order to acquire a sorted sequence of samples, with each sample having a sorting position within the sorted sequence; a generator for generating a series of numbers depending on a relation between the original and sorting positions of the samples, and for determining coefficients of a prediction filter on the basis of the series of numbers; and an encoder for encoding the sorted samples and the coefficients.

According to another embodiment, a method of encoding a sequence of samples of an information signal, with each sample within the sequence having an original position, may have the steps of: sorting the samples depending on their sizes, in order to acquire a sorted sequence of samples, with each sample having a sorting position within the sorted sequence; generating a series of numbers depending on a relation between the original and sorting positions of the samples, and determining coefficients of a prediction filter on the basis of the series of numbers; and encoding the sorted samples and the coefficients.

According to another embodiment, an apparatus for decoding a sequence of samples of an information signal, with each sample within the sequence having an original position, may have: a receiver for receiving coefficients of a prediction filter and a sequence of samples, with each sample having a sorting position; a predictor for predicting a series of numbers on the basis of the coefficients; and a re-sorter for re-sorting the sequence of samples on the basis of the series of numbers, so that each sample has its original position.

According to another embodiment, a method of decoding a sequence of samples of an information signal, with each sample within the sequence having an original position, may have the steps of: receiving coefficients of a prediction filter and a sequence of samples, with each sample having a sorting position; predicting a series of numbers on the basis of the coefficients; and re-sorting the sequence of samples on the basis of the series of numbers, so that each sample has its original position.

According to another embodiment, an apparatus for encoding a sequence of samples, with each sample within the sequence having an original position, may have: a sorter for sorting the samples depending on their sizes, in order to acquire a sorted sequence of samples, with each sample having a sorting position within the sorted sequence; and an encoder for encoding the sorted samples and for encoding a series of numbers with information on the relation between the original and sorting positions of the samples, with each element within the series of numbers being unique, and with the encoder associating a number of bits with an element of the series of numbers, such that the number of bits associated with a first element is greater than the number of bits associated with a second element if, prior to the encoding of the first element, less elements have already been encoded than prior to the encoding of the second element.

According to another embodiment, a method of encoding a sequence of N samples, with each sample within the sequence having an original position, may have the steps of: sorting the samples depending on the sizes, in order to acquire a sorted sequence of samples, with each sample having a sorting position within the sorted sequence; encoding the sorted samples; and encoding a series of numbers with information on the relation between the original and sorting positions of the samples, with each element within the series of numbers being unique, and with a number of bits being associated with an element of the series of numbers when encoding, such that the number of bits associated with a first element is greater than the number of bits associated with a second element if, prior to the encoding of the first element, less elements have already been encoded than prior to the encoding of the second element.

According to another embodiment, an apparatus for decoding a sequence of samples, with each sample within the sequence having an original position, may have: a receiver for receiving an encoded series of numbers and a sequence of samples, each sample having a sorting position; a decoder for decoding a decoded series of numbers with information on a relation between the original and sorting positions on the basis of the encoded series of numbers, with each element within the encoded series of numbers being unique, and with the decoder associating a number of bits with an element of the series of numbers, such that the number of bits associated with a first element is greater than the number of bits associated with a second element if, prior to the decoding of the first element, less elements have already been decoded than prior to the encoding of the second element; and a re-sorter for re-sorting the sequence of samples on the basis of the decoded series of numbers, so that each sample within the decoded sequence has its original position.

According to another embodiment, a method of decoding a sequence of samples, with each sample within the sequence having an original position, may have the steps of: receiving an encoded series of numbers and a sequence of samples, with each sample having a sorting position; decoding the encoded series of numbers with information on a relation between the original and sorting positions on the basis of the encoded series of numbers, with each element within the decoded series of numbers being unique, and with a number of bits being associated with an element of the series of numbers when decoding, such that the number of bits associated with a first element is greater than the number of bits associated with a second element if, prior to the decoding of the first element, less elements have already been decoded than prior to the encoding of the second element; and re-sorting the sequence of samples on the basis of the decoded series of numbers, so that each sample within the decoded sequence has its original position.

The present invention is based on the finding that an information signal can be encoded with less effort if sorting is performed beforehand. One can assume that an information signal, or also an audio signal, includes a sequence of samples, wherein the samples may originate from a time or frequency signal, i.e. it may also be a sampled spectrum. The term sample is thus not to be understood as limiting. In embodiments of the present invention, a basic processing step may therefore be to perform the sorting of the input signal depending on its amplitude, wherein this may also take place after possibly performed preprocessing. As preprocessing, time/frequency transform, prediction or also multi-channel redundancy reduction, e.g. in case of multi-channel signals, generally also decorrelation methods, could be performed in the field of audio signals. In addition, possibly variable division of the signal into defined time portions, so-called frames, may also take place prior to these processing steps. Further division of these time portions into sub-frames, which then are sorted individually, is possible.

In embodiments, after the sorting step, there are the sorted data on the one hand and a reverse sorting rule on the other hand, which is present as a permutation of the indices of the original input values. Both data sets are then coded as effectively as possible. To this end, embodiments offer several possibilities, such as prediction with ensuing entropy coding of the residual signal, i.e. determining prediction coefficients for a prediction filter and determining the residual signal, as a difference between an output signal of the prediction filter and the input signal.

In other embodiments, curve fitting with suitable functional rules and functional coefficients with ensuing entropy coding of the residual signal is performed. In other embodiments, lossy coding may be performed, and hence the coding of the residual signal may also be omitted.

Embodiments may also perform permutation coding, for example by establishing inversion charts and ensuing entropy coding, with details on inversion charts to be found in Donald E. Knuth: The Art of Computer Programming, Volume 3. Sorting and Searching, Addison-Wesley, 1998, for example.

In other embodiments, also prediction of inversion charts and ensuing entropy coding of the residual signal may be performed, as well as prediction of the permutation and ensuing entropy coding of the residual signal. Embodiments may also achieve lossy coding by omitting the residual signal.

Alternatively, establishing numberings for the permutations may also be performed, cf. A. A. Babaev: Procedures of encoding and decoding of permutations, Kibernetika, No. 6, 1984, pp. 77-82. Furthermore, in embodiments, combinatorial selection methods with ensuing numbering may be employed.

### BRIEF DESCRIPTION OF THE DRAWINGS

Embodiments of the present invention will be detailed subsequently referring to the appended drawings, in which:

FIG. 1A shows an embodiment of an apparatus for encoding;

FIG. 1B shows an embodiment of an apparatus for decoding;

FIG. 2A shows an embodiment of an apparatus for encoding;

FIG. 2B shows an embodiment of an apparatus for decoding;

FIG. 3A shows an embodiment of an apparatus for encoding;

FIG. 3B shows an embodiment of an apparatus for decoding;

FIG. 4A shows an embodiment of an apparatus for encoding;

FIG. 4B shows an embodiment of an apparatus for decoding;

FIGS. 5A and 5B show embodiments of an audio signal, of a permutation and of an inversion chart;

FIG. 6 shows an embodiment of an encoder;

FIG. 7 shows an embodiment of a decoder;

FIG. 8 shows a further embodiment of an encoder;

FIG. 9 shows a further embodiment of a decoder;

FIG. 10 shows an example of a frequency spectrum with approximation of an audio signal;

FIG. 11 shows an example of a sorted frequency spectrum and its approximation of an audio signal;

FIG. 12 shows an example of a sorted differentially coded signal and its residual signal;

FIG. 13 shows an example of a sorted time signal;

FIG. 14 shows an example of sorted time values and corresponding curve fitting; and

FIG. 15 is a comparison of the coding efficiency of differential coding and curve fitting.

FIG. 16 shows exemplarily processing steps of most lossless audio compression algorithms;

FIG. 17 shows an embodiment of a structure of prediction coding;

FIG. 18 shows an embodiment of a structure of a reconstruction in prediction coding;

FIG. 19 shows an embodiment of warmup values of a prediction filter;

FIG. 20 shows an embodiment of a prediction model;

FIG. 21 is a block diagram of a structure of an LTAC encoder;

FIG. 22 is a block diagram of an MPEG-4 SLS encoder;

FIG. 23 shows stereo redundancy reduction after decorrelation of individual channels;

FIG. 24 shows stereo redundancy reduction prior to decorrelation of individual channels;

FIG. 25 is an illustration of the connection between predictor order and overall bit consumption;

FIG. 26 is an illustration of the connection between quantization parameter g and overall bit consumption;

FIG. 27 is an illustration of a magnitude frequency course of a fixed predictor as a function it its order p;

FIG. 28 is an illustration of the connection between permutation length, number of transpositions and codability measure;

FIGS. 29A to 29H are an illustration of inversion charts in the 10^{th} block (frame) of a noise-like piece;

FIGS. 30A to 30H are an illustration of inversion charts in the 20^{th} block (frame) of a tonal piece;

FIGS. 31A and 31B are an illustration of a permutation, developed from sorting time values, of a noise-like piece in the 10^{th} block and a tonal piece;

FIG. 32A shows part of an audio signal, the corresponding permutation and the inversion chart LS, and FIG. 32B the permutation and the inversion chart LS from the left image in an enlarged manner;

FIG. 33A shows part of an audio signal, the corresponding permutation and the inversion chart LS, and FIG. 33B the permutation and the inversion chart LS from the left image in an enlarged manner;

FIG. 34A shows a probability distribution and FIG. 34B shows a length of the code words of a residual signal developed through prediction (fixed predictor) of an inversion chart LB;

FIG. 35A shows a probability distribution and FIG. 35B shows a length of code words of a residual signal developed by differential coding of sorted time values;

FIG. 36 shows a percentage proportion of a sub-block decomposition with a smallest amount of data of a forward-adaptive Rice coding via a residual signal of a fixed predictor of a piece including side information for parameters, the overall block length being 1024 time values;

FIG. 37 shows a percentage proportion of a sub-block decomposition with a smallest amount of data of a forward-adaptive Golomb coding via a residual signal of a fixed predictor of a piece including side information for parameters, the overall block length being 1024 time values;

FIG. 38 is an illustration on the operation of a history buffer;

FIGS. 39A and 39B are an illustration on the operation of an adaptation as compared with an optimal parameter for the entire block;

FIG. 40 shows an embodiment of forward-adaptive arithmetic coding utilizing backward-adaptive Rice coding;

FIG. 41 is an illustration of the influence of the block size on the compression factor F;

FIG. 42 is an illustration on the lossless MS coding;

FIG. 43 is a further illustration on the lossless MS coding; and

FIG. 44 is an illustration on the selection of a best variant for stereo redundancy reduction.

### DETAILED DESCRIPTION OF THE INVENTION

With respect to the following description, it is to be noted that the same or similarly acting functional elements have the same reference numerals in the different embodiments, and hence the descriptions of these functional elements are mutually interchangeable in the various embodiments illustrated in the following. Furthermore, it is again to be pointed out that, in general, discrete values of a signal are referred to as samples in the following embodiments. The term sample is not to be seen as limiting, as samples may have developed by sampling a time signal, a spectrum, a generic information signal, etc.

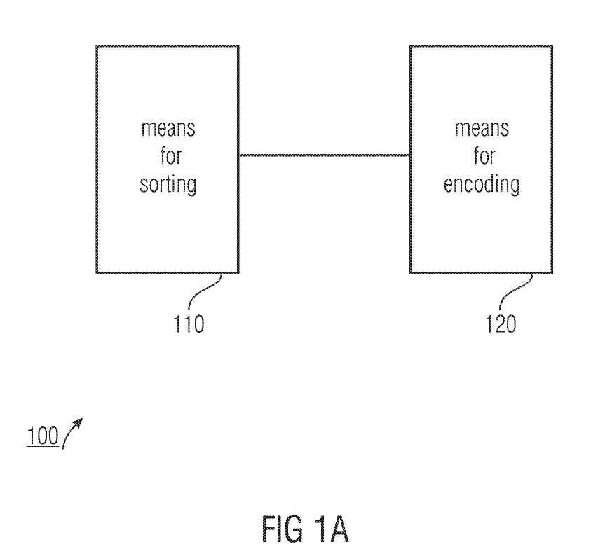

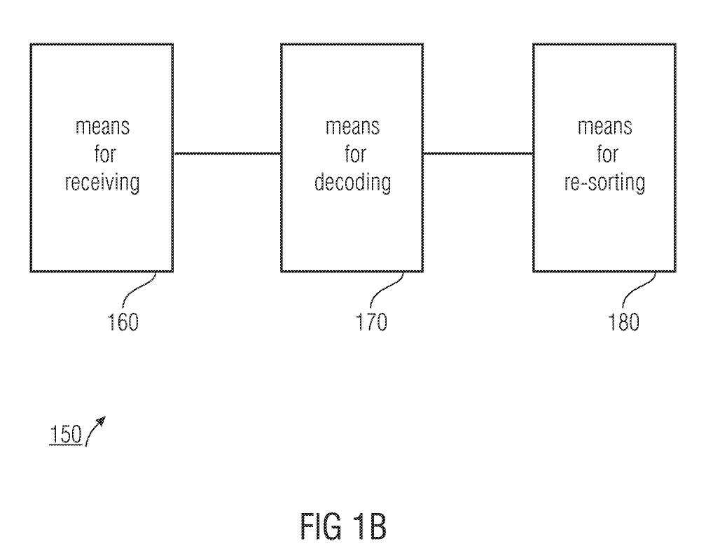

FIG. 1A shows an apparatus 100 for encoding a sequence of samples of an audio signal, each sample within the sequence having an original position. The apparatus 100 includes means 110 for sorting the samples depending on their sizes (after processing possibly taking place, e.g. time/frequency transform, prediction, etc.), in order to obtain a sorted sequence of samples, each sample having a sorting position within the sorted sequence. Furthermore, the apparatus 100 comprises means 120 for encoding the sorted samples and information on a relation between the original and sorting positions of the samples.

The apparatus 100 may further comprise preprocessing means formed to perform filtering, time/frequency transform, prediction or multi-channel redundancy reduction for generating the sequence of samples. In embodiments, the means 120 for encoding may be formed to encode the information via the relation between the original and sorting positions as an index permutation. Optionally, the means 120 for encoding may encode the information via the relation between the original and sorting positions as an inversion chart. The means 120 for encoding may further be formed to encode the sorted samples or the information on the relation between the original and the sorting positions with a differential and ensuing entropy coding or only entropy coding.

In other embodiments, the means 120 may determine and encode coefficients of a prediction filter based on the sorted samples, a permutation or an inversion chart. Furthermore, a residual signal, which corresponds to a difference between the samples and an output signal of the prediction filter, may be encoded and allow for lossless coding. The residual signal may here be encoded with entropy coding. In a further embodiment, the apparatus 100 may comprise means for adjusting functional coefficients of a functional rule for adaptation to at least one partial area of the sorted sequence, and the means 120 for encoding may be formed to encode the functional coefficients.

FIG. 1B shows an embodiment of an apparatus 150 for decoding a sequence of samples of an audio signal, wherein each sample within the sequence has an original position. The apparatus 150 here includes means 160 for receiving a sequence of encoded samples, wherein each encoded sample within the sequence of encoded samples has a sorting position, and the means 160 is further formed for receiving information on a relation between the original and sorting positions of the samples. The apparatus 150 further comprises means 170 for decoding the samples and the information on the relation between the original and sorting positions and further includes means 180 for re-sorting the samples on the basis of the information on the relation between the original and sorting positions, so that each sample has its original position.

In embodiments, the means 160 for receiving may be formed to receive the information on the relation between the original and sorting positions as an index permutation. Furthermore, the means 160 for receiving may be formed to receive the information on the relation between the original and sorting positions as an inversion chart. In embodiments, the means 170 for decoding may be formed to decode the encoded samples or the information on the relation between the original and sorting positions with entropy and ensuing differential decoding or only entropy decoding. The means 160 for receiving may optionally receive encoded coefficients of a prediction filter, and the means 170 for decoding may be formed to decode the encoded coefficients, wherein the apparatus 150 may further comprise means for predicting samples or relations between the original and sorting positions based on the coefficients.

In further embodiments, the means 160 for receiving may be formed to further receive a residual signal, which corresponds to a difference between the samples and an output signal of the prediction filter, and the means 170 for decoding may further be formed to adapt the samples on the basis of the residual signal. The means 170 may optionally decode the residual signal with entropy decoding. The means 160 for receiving further could receive functional coefficients of a functional rule, and the apparatus 150 further could comprise means for adapting a functional rule to at least one partial range of the sorted sequence, and the means 170 for decoding could be formed to decode the functional coefficients.

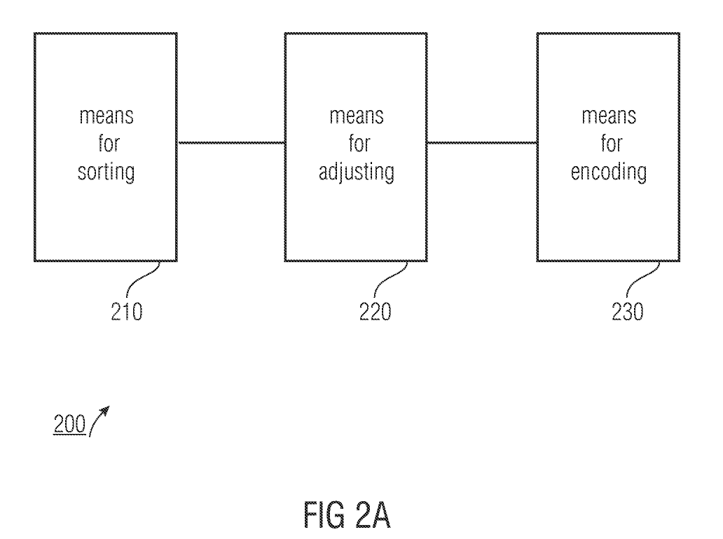

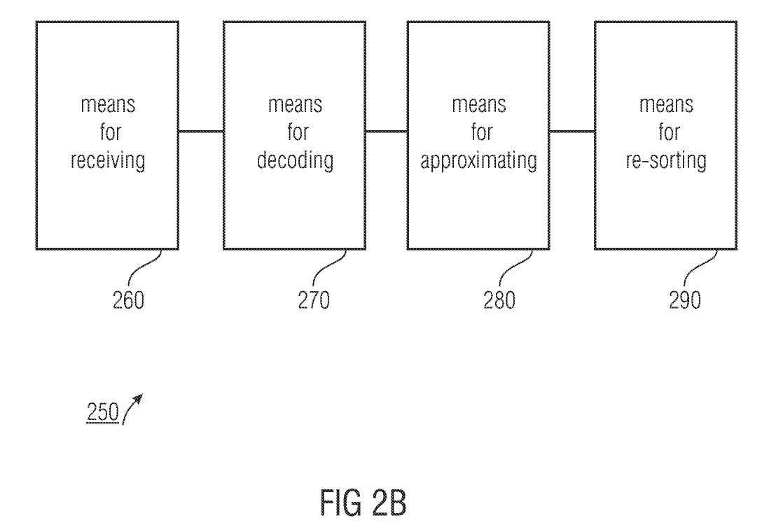

FIG. 2A shows an embodiment of an apparatus 200 for encoding a sequence of samples of an information signal, each sample within the sequence having an original position. The apparatus 200 includes means 210 for sorting the samples depending on their sizes, to obtain a sorted sequence of samples, with each sample having a sorting position within the sorted sequence. The apparatus 200 further includes means 220 for adjusting functional coefficients of a functional rule for adaptation to at least one partial range of the sorted sequence and means 230 for encoding the functional coefficients, the samples outside the partial range and information on a relation between the original and sorting positions of the samples.

The apparatus 200 may further comprise preprocessing means formed to perform filtering, time/frequency transform, prediction or multi-channel redundancy reduction for generating the sequence of samples. In embodiments, the information signal may include an audio signal. The means 230 for encoding may be formed to encode the information on the relation between the original and sorting positions as an index permutation. Furthermore, the means 230 for encoding may be formed to encode the information on the relation between the original and sorting positions as an inversion chart. Optionally, the means 220 for encoding may also be formed to encode the sorted samples, the information on the relation between the original and sorting positions with differential and ensuing entropy coding or only entropy coding. The means 230 for encoding could further be formed to determine and encode coefficients of a prediction filter on the basis of the samples, a permutation or an inversion chart.

In further embodiments, the means 230 for encoding may further be formed to encode a residual signal, which corresponds to a difference between the samples and an output signal of the prediction filter. The means 230 for encoding may again be adapted to encode the residual signal with entropy coding.

FIG. 2B shows an embodiment of an apparatus 250 for decoding a sequence of samples of an information signal, each sample within the sequence having an original position. The apparatus 250 includes means 260 for receiving encoded functional coefficients, sorted samples and information on a relation between a sorting position and the original position of samples. The apparatus 250 further includes means 270 for decoding samples and means 280 for approximating samples on the basis of the functional coefficients at least in one partial range of the sequence. The apparatus 250 further includes means 290 for re-sorting the samples and the approximated partial range, based on the information on the relation between the original and sorting positions, so that each sample has its original position.

In embodiments, the information signal may include an audio signal. The means 260 for receiving may be formed to receive the information on the relation between the original and sorting positions as an index permutation. Furthermore, the means 260 for receiving may be formed to receive the information on the relation between the original and sorting positions as an inversion chart. The means 270 may optionally decode the sorted samples or the information on the relation between the original and sorting positions with entropy and ensuing differential decoding or only entropy decoding. The means 260 for receiving may further be adapted to receive encoded coefficients of a prediction filter, and the means 270 for decoding may be formed to decode the encoded coefficients, wherein the apparatus 250 may further comprise means for predicting samples on the basis of the coefficients.

In further embodiments, the means 260 for receiving may be formed to receive a residual signal which corresponds to a difference between the samples and an output signal of the prediction filter or the means 280 for approximating, and the means 270 for decoding may be formed to adapt the samples on the basis of the residual signal. The means 270 for decoding may optionally decode the residual signal with entropy decoding.

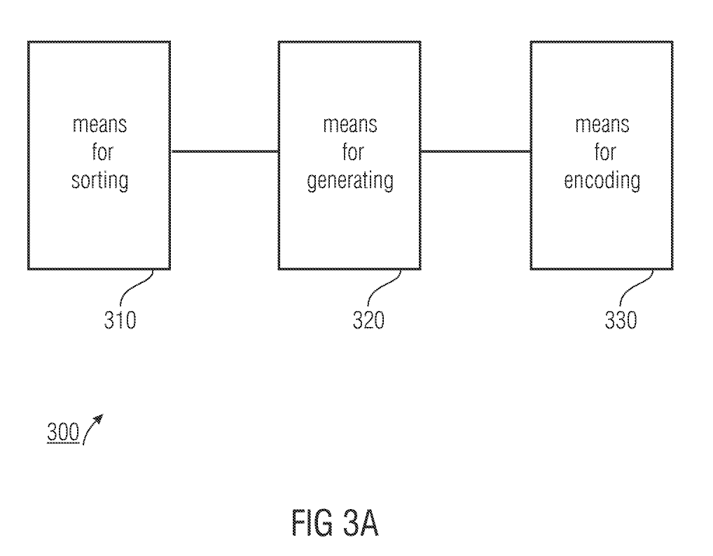

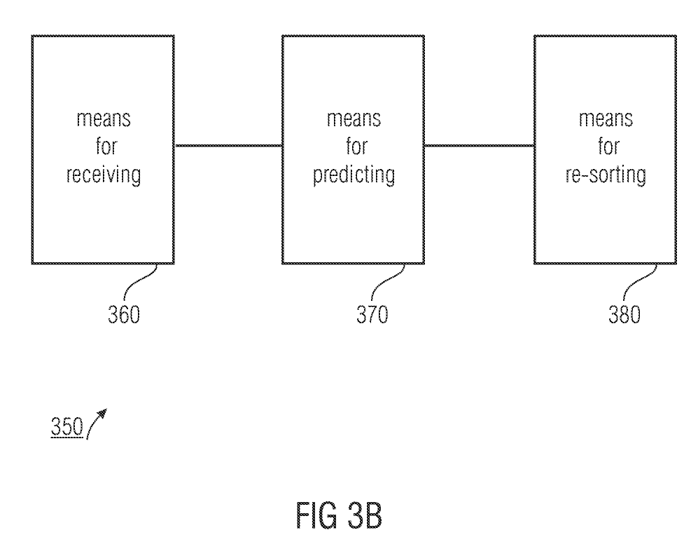

FIG. 3A shows an apparatus 300 for encoding a sequence of samples of an information signal, with each sample within the sequence comprising an original position. The apparatus 300 includes means 310 for sorting the samples in according with their size, to obtain a sorted sequence of samples, each sample having a sorting position within the sorted sequence. The apparatus 300 further includes means 320 for generating a series of numbers depending on a relation between the original and sorting positions of the samples and for determining coefficients of a prediction filter on the basis of the series of numbers. The apparatus 300 further comprises means 330 for encoding the sorted samples and the coefficients.

The apparatus 300 may further comprise preprocessing means formed to perform filtering, time/frequency transform, prediction or multi-channel redundancy reduction for generating the sequence of samples. In embodiments, the information signal may comprise an audio signal. The means 320 for generating the series of numbers may be formed to generate an index permutation. Optionally, the means 320 for generating the series of numbers may generate an inversion chart. The means 320 for generating the series of numbers may be adapted to further generate a residual signal, which corresponds to a difference between the series of numbers and a prediction series predicted on the basis of the coefficients. The means 330 for encoding may be adapted to encode the sorted samples according to differential and ensuing entropy coding or only entropy coding. The means 330 for encoding may further be formed to encode the residual signal.

FIG. 3B shows an embodiment of an apparatus 350 for decoding a sequence of samples of an information signal, with each sample within the sequence having an original position. The apparatus 350 includes means 360 for receiving coefficients of a prediction filter and a sequence of samples, with each sample having a sorting position. The apparatus further includes means 370 for predicting a series of numbers on the basis of the coefficients and means 380 for re-sorting the sequence of samples on the basis of the series of numbers, so that each sample has its original position.

In embodiments, the information signal may comprise an audio signal. Furthermore, the means 370 for predicting the series of numbers may predict an index permutation as the series of numbers. The means 370 for predicting the series of numbers could also predict an inversion chart as the series of numbers. The means 360 for receiving may further be formed to receive an encoded residual signal, and the means 370 for predicting may be formed to take the residual signal into account in the prediction of the series of numbers. The apparatus 350 may further comprise means for decoding, which is formed to decode samples according to entropy and ensuing differential decoding or only entropy decoding.

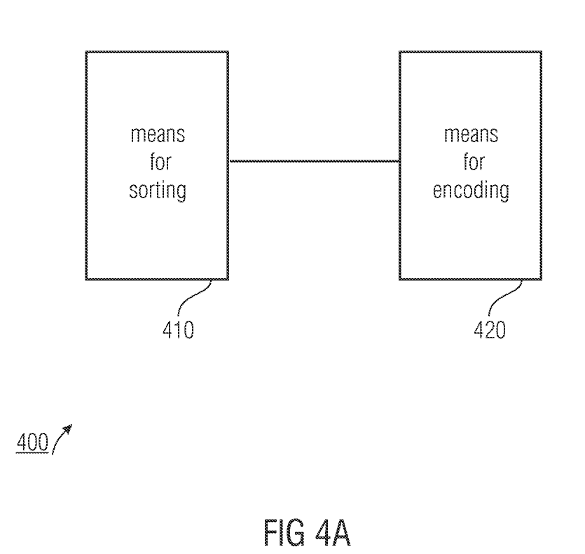

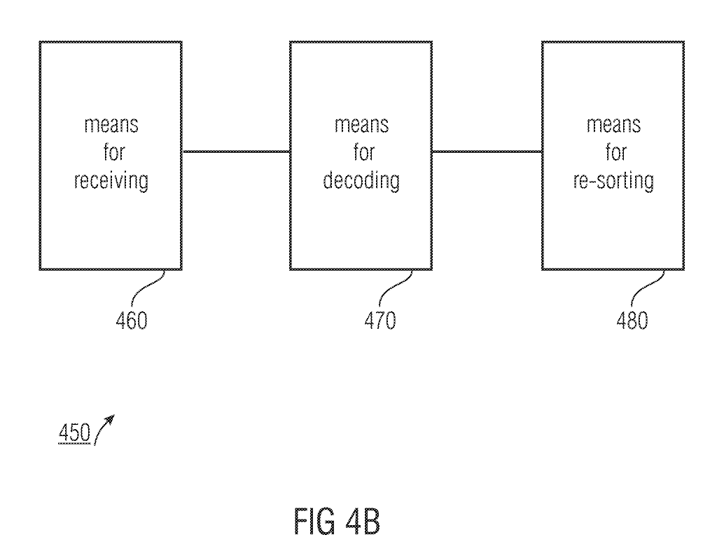

FIG. 4A shows an embodiment of an apparatus 400 for encoding a sequence of samples, with each sample within the sequence having an original position. The apparatus 400 includes means 410 for sorting the samples depending on their sizes to obtain a sorted sequence of samples, with each sample having a sorting position within the sorted sequence. The apparatus 400 further includes means 420 for encoding the sorted samples and for encoding a series of numbers with information on the relation between the original and sorting positions of the samples, wherein each element within the series of numbers is unique, and wherein the means 420 for encoding associates a number of bits with each element of the series of numbers, such that the number of bits associated with the first element is greater than the number of bits associated with the second element if, prior to the encoding of the first element, less elements have already been encoded than prior to the encoding of the second element.

The means 420 for encoding may here be formed to encode a series of numbers of the length N and to encode a number of X elements at the same time, wherein G bits are associated with the number of X elements according to

$$G = ⌈ {log}_{2} ( \frac{N !}{( N - X ) !} ) ⌉ with 0 < X \leq N ,$$

wherein the brackets open at the bottom indicate that the value in the brackets is rounded to the next higher integer number.

In another embodiment, the means 420 for encoding may be formed to encode a series of numbers of the length N, wherein X is a number of already encoded elements of the series of numbers, wherein G bits are associated with the next element of the series of numbers according to

G=┌log₂(N−X)┐ with 0≦X<N.

FIG. 4B shows an embodiment of an apparatus 450 for decoding a sequence of samples, with each sample within the sequence having an original position. The apparatus 450 includes means 460 for receiving an encoded series of numbers and a sequence of samples, with each sample having a sorting position. The apparatus 450 further includes means 470 for decoding a decoded series of numbers with information on a relation between the original and sorting positions on the basis of the encoded series of numbers, wherein each element within the decoded series of numbers is unique, and the means 470 for decoding associates a number of bits with an element of the series of numbers, such that the number of bits associated with the first element is greater than the number of bits associated with the second element if, prior to the decoding of the first elements, less elements have already been decoded than prior to the encoding of the second element. The apparatus 450 further includes means 480 for re-sorting the sequence of samples on the basis of the decoded series of numbers, so that each sample within the decoded sequence has its original position.

In embodiments, the means 470 for decoding may be formed to decode a series of numbers of the length N and to decode a number of X elements at the same time, wherein G bits are associated with the number of X elements according to

$$G = ⌈ {log}_{2} ( \frac{N !}{( N - X ) !} ) ⌉ with 0 < X \leq N .$$

The means 470 for decoding may further be formed to decode a series of numbers of the length N, wherein X is a number of already encoded elements of the series of numbers, wherein G bits are associated with the next element of the series of numbers according to

G=┌log₂(N−X)┐ with 0≦X<N.

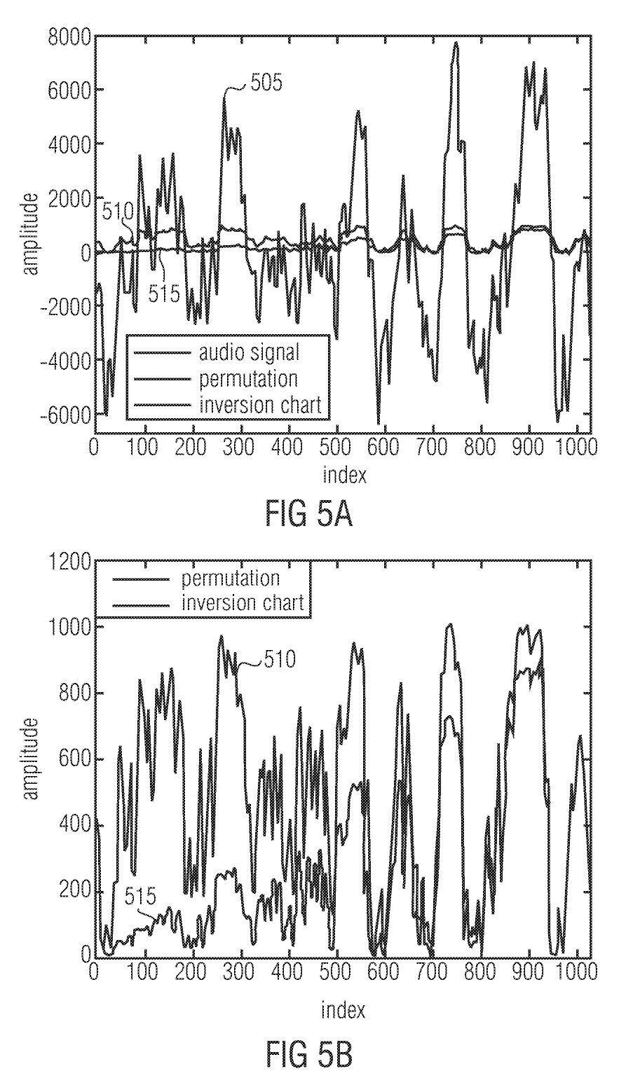

FIG. 5A shows waveforms of an audio signal 505 (large amplitudes), a permutation 510 (medium amplitudes) and an inversion chart 515 (small amplitudes). In FIG. 5B, the permutation 510 and the inversion chart 515 are illustrated again in another scaling for reasons of better overview.

From the courses illustrated in FIGS. 5A, 5B, a correlation between the audio signal 505, the permutation 510 and the inversion chart 515 can be seen. The correlation transfer of the input signal to the permutation and/or inversion chart can be seen clearly. According to embodiments, apart from encoding the sorted samples, permutation coding by establishing inversion charts, which then are entropy coded, may take place. It can be seen from FIGS. 5A, 5B that a prediction of the permutation and/or the inversion charts is also possible due to the correlations, wherein the respective residual signal may, for example, be entropy coded in the case of lossless coding.

The prediction is possible because a correlation present in the input signal transfers to the arising permutation and/or inversion chart, cf. FIGS. 5A, 5B. Known FIR (finite impulse response) and IIR (infinite impulse response) structures may be employed here as prediction filters. The coefficients of such a filter are then selected such that the original output signal is present at its output or may be output there, for example on the basis of a residual signal at the input of the filter. In embodiments, the corresponding coefficients of the filter and the residual signal may then be transmitted more inexpensively, i.e. with less bits or transmission rate than the original signal itself. In a receiver and/or a decoder, the original signal is then predicted or reconstructed on the basis of the transmitted coefficients and may be a residual signal. The number of coefficients and/or the order of the prediction filter here, on the one hand, determine the bits needed for transmission and, on the other hand, the accuracy with which the original signal can be predicted or reconstructed.

The inversion charts are an equivalent representation of the permutation, but better suited for entropy coding. For lossy coding, it is also possible to perform the reverse sorting in an only incomplete manner so as to save some amount of data.

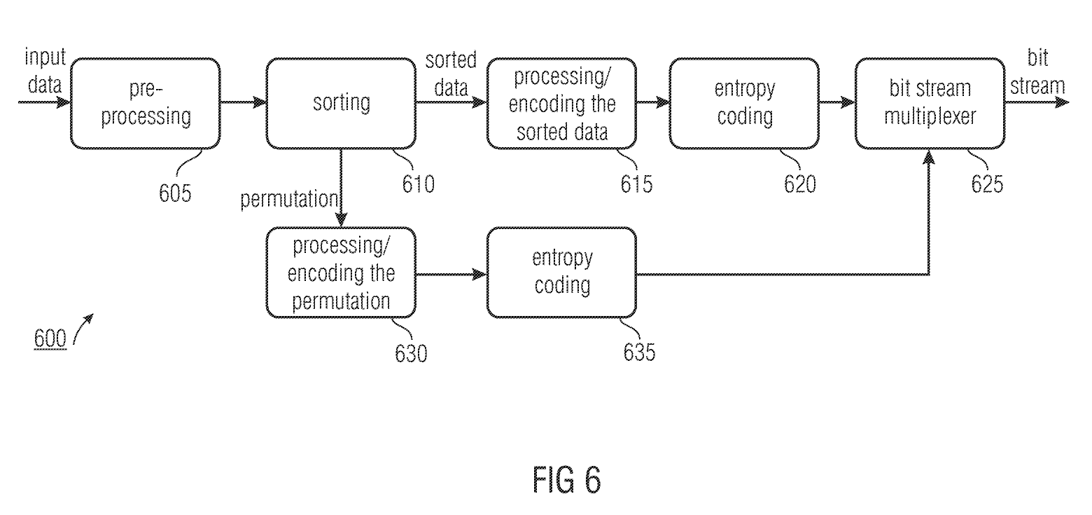

FIG. 6 shows an embodiment of an encoder 600. In the encoder 600, preprocessing 605 of the input data may take place (e.g. time/frequency transform, prediction, stereo redundancy reduction, filtering for band limitation, etc.). The preprocessed data is then sorted 610, wherein sorted data and a permutation are obtained. The sorted data may then be processed further or encoded 615, and differential coding may, for example, take place here. The data may then be entropy coded 620 and made available to a bit multiplexer 625 in the following. The permutation may also at first be processed or encoded 630, for example by determining an inversion chart with possibly ensuing prediction, whereupon entropy coding 635 may also take place here before supplying the entropy-coded permutation and/or inversion chart to the bit multiplexer 625. The bit multiplexer 625 then multiplexes the entropy-coded data and the permutation into a bitstream.

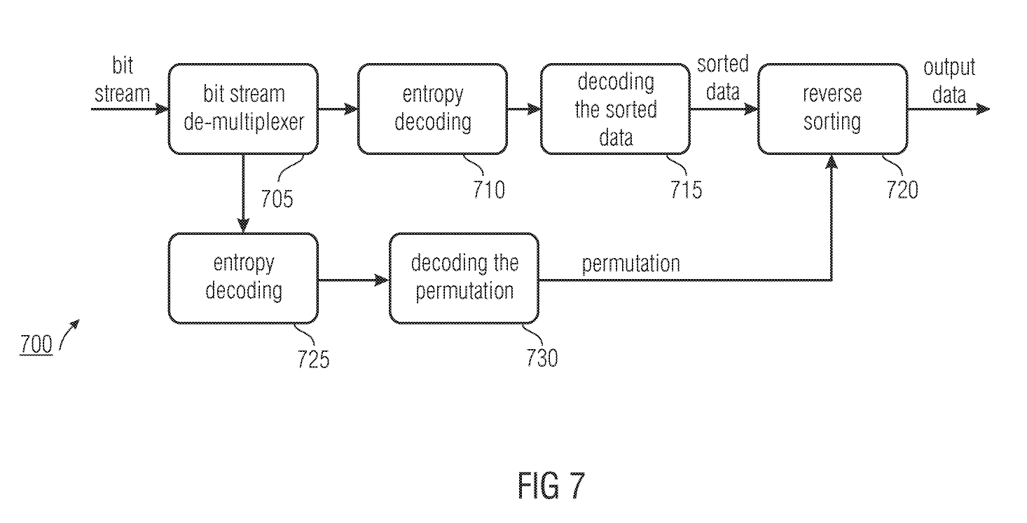

FIG. 7 shows an embodiment of a decoder 700, which for example obtains a bitstream in accordance with the encoder 600. The bitstream then at first is demultiplexed in a bitstream demultiplexer 705, whereupon encoded data is supplied to entropy decoding 710. The entropy-decoded data may then be decoded further in a decoding of the sorted data 716, e.g. in a differential decoding. The decoded, sorted data then is supplied to a reverse sorting 720. From the bitstream multiplexer 705, the encoded permutation data are further supplied to an entropy decoding 725, which may have further decoding of the permutation 730 downstream. The decoded permutation then is also supplied to the reverse sorting 720. The reverse sorting 720 may then output the output data on the basis of the decoded permutation data and the decoded sorted data.

Embodiments may further have an encoding system comprising three modes of operation. Mode 1 could allow for high compression rates with the aid of a psycho-acoustic consideration of the input signal. Mode 2 could allow for medium compression rates without psycho-acoustics, and mode 3 could allow for lower compression rates, but with lossless coding, see also Tilo Wik, Dieter Weninger: Verlustlose Audiokodierung mit sortierten Zeitwerten und Anbindung an filterbankbasierte Kodierverfahren, October 2006.

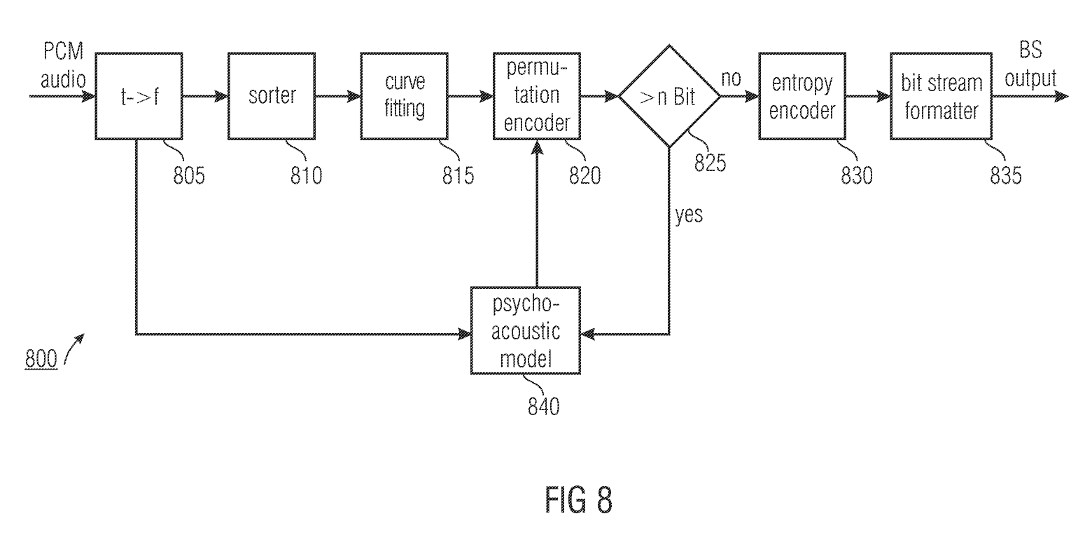

All modes could have the omission of the processing stages of quantization, re-sampling and low-pass filtering in common. Thus, the full bandwidth of the input signal could be transmitted in all 3 stages. FIG. 8 shows a further embodiment of an encoder 800. FIG. 8 shows the block circuit diagram of an encoder 800 and/or an encoding method for modes 1 and 2. The input signal is transformed into the frequency domain by means of a time/frequency transform 805, e.g. an MDCT (Modified Discrete Cosine Transform), cf. J. Princen, A. Bradley: Analysis/Synthesis Filter Bank Design Based on Time Domain Aliasing Cancellation, IEEE Trans. ASSP 1986.

Thereafter, the spectral lines are sorted 810 (sorting) depending on the sizes of their amplitudes. Since the arising sorted spectrum has a relatively simple curve shape, it may be approximated easily by a functional rule by means of curve fitting 815, in embodiments, e.g. see Draper, N. R and H. Smith, Applied Regression Analysis, 3^{rd} Ed., John Wiley & Sons, New York, 1998. So as to bring the permutation of the spectral line indices developed by the re-sorting into the original order again on the decoder side, and hence be able to reconstruct the original spectrum, a reverse-sorting rule 820 may now be found and written into the bitstream, containing an amount of data as small as possible. For example, this may be brought about by run-length coding 820 for mode 1 and by a special permutation encoder 820, which is capable of working with an inversion chart, for mode 2.

The data of the run-length coding and/or the permutation encoder 820 then is encoded additionally by an entropy coding method or entropy encoder 830 and finally written into the bitstream, including some additional information, e.g. the coefficients of the above-mentioned functional rule, indicated by the bitstream formatter 835. Ways of controlling the amount of data arising (variable bit rates) e.g. are the variation of the quality of the curve fitting, by selectively adding a psycho-acoustic consideration in a psycho-acoustic model 840 of the input signal, as well as by different encoder strategies of the permutation encoder 820 and/or the run-length coding 820. To this end, FIG. 8 further shows a block 825 monitoring the bit rate developed in the encoder process and providing feedback to the psycho-acoustic model, if needed, when the data rate still is too high.

The block circuit diagram of FIG. 8 shows a psycho-acoustic model 840 for bit rate control, which may, for example, be activated only for mode 1, and this way of control may be omitted in mode 2 in favor of the coding quality. In operation mode 1, a higher compression rate than in the two other modes of operation is achieved. To this end, with the aid of psycho-acoustic consideration 840 of the input signal, lines of the frequency spectrum are set to zero in a targeted manner, or elements of the index permutation excluded from the back-sorting as an alternative, so as to be able to save data in the transmission of the reverse-sorting rule 820. In contrast thereto, the frequency spectrum is reconstructed completely in operation mode 2, with only very few errors occurring here due to minor inaccuracies of the curve approximation 815.

Furthermore, operation mode 2 can be extended to a lossless mode by adding a residual signal. Both in mode 1 and mode 2, the entire frequency spectrum can be transmitted, i.e. the data reduction in mode 1 can only be achieved by way of a downsized reverse-sorting rule 820.

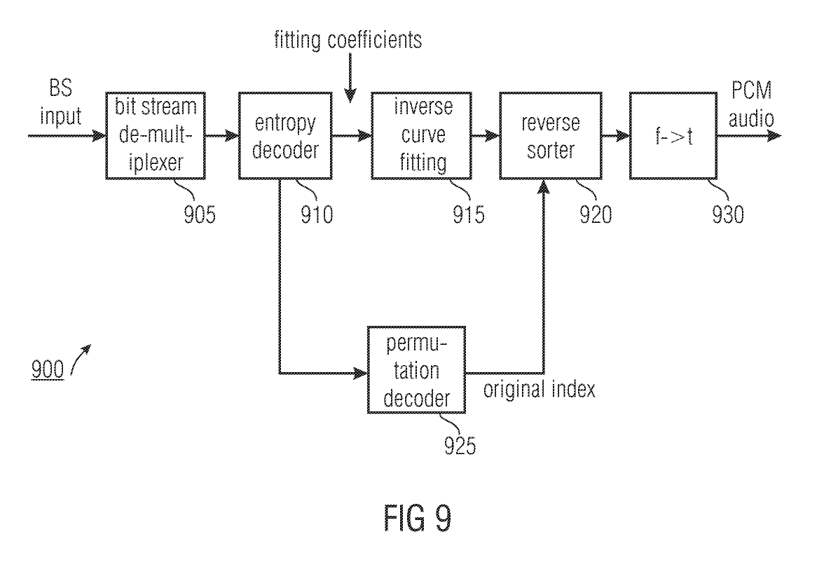

FIG. 9 shows a further embodiment of a decoder 900 and/or decoding process of modes 1 and 2, which passes through the steps of encoding and/or of the encoder 800 substantially in reverse direction. At first, the bitstream is unpacked by the bitstream demultiplexer 905 and decoded in an entropy decoder 910. From the decoded functional coefficients of a functional rule, the function or spectral function may then be reconstructed by an “inverse curve fitting” block, i.e. an inverse curve fitting 915, and supplied to a reverse sorter 920. The reverse sorter 920 further obtains a permutation from a permutation decoder 925, which decodes the permutation on the basis of the entropy-decoded permutation. With the aid of the permutation and the spectral function reconstructed with the aid of the transmitted functional coefficients, the reverse sorter 920 may bring its spectral lines back into the original order. Finally, the reconstructed spectrum is transformed back into the time domain by a reverse transform 930, e.g. inverse MDCT.

In other embodiments, the time/frequency transform may also be omitted and an information signal directly sorted, as described above, encoded and transmitted in the time domain.

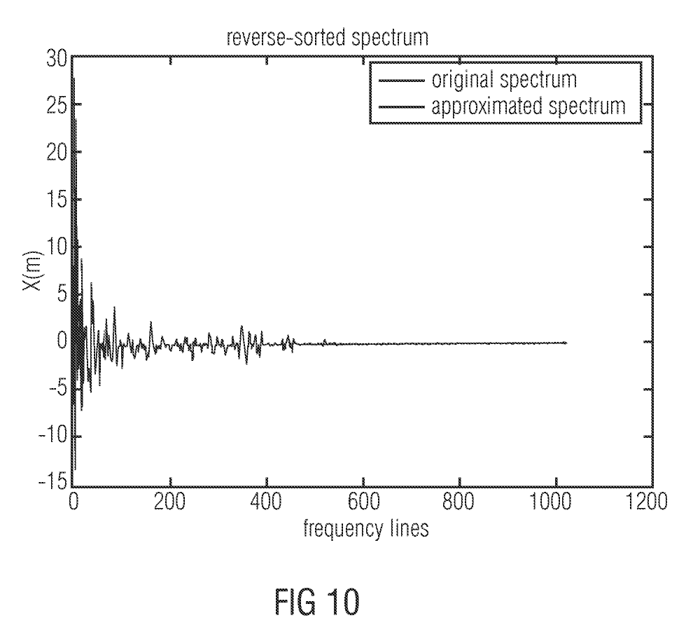

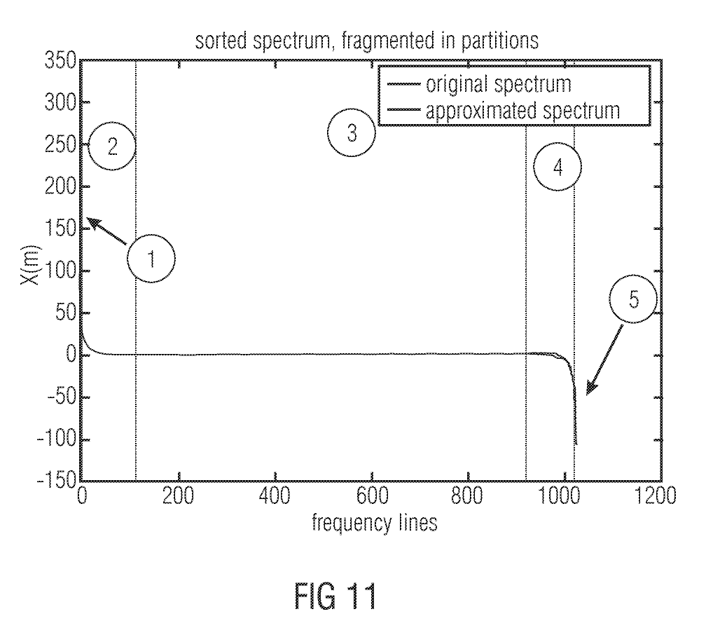

FIG. 10 shows an example of a frequency spectrum of an audio signal with 1024 frequency lines and its approximated spectrum, wherein original and approximation are almost identical. FIG. 11 shows the accompanying sorted spectrum and its approximation. It can be seen clearly that the sorted spectrum can be approximated with significantly more ease and accuracy by a functional rule than the original spectrum. So as to approximate the spectrum from FIG. 11, it can be divided into, e.g., 5 regions (partitions), which are illustrated in FIG. 11, in embodiments, with region 3 being approximated, e.g., by a straight line and regions 2 and 4 by corresponding suitable functions (e.g. polynomials, exponential functions, etc.). The number of amplitude values in regions 1 and 5 can be chosen to be very small in embodiments, e.g. 3, but since these are tremendously important for sound quality, they should be either approximated very accurately or transmitted directly.

For the entire spectrum, according to embodiments, only the types of functions and their coefficients and/or the amplitude values for regions 1 and 5, if needed, are transmitted in the end. The division into five regions chosen here only serves as an example, with it being possible to choose other subdivisions at any time, of course, such as to improve the quality of the approximation. FIG. 10 additionally also shows the approximated and again reverse-sorted spectrum, wherein it can be seen clearly that the reconstructed spectrum comes to lie very closely to the original spectrum.

In embodiments, a series of numbers of the spectral line indices, which represents a permutation of the index set, develops by way of the re-sorting. In embodiments, the series of numbers of these re-sorted indices can be transmitted directly, with relatively large amounts of data arising, which cannot be reduced by entropy coding, since they are completely uniformly distributed. So as to map the uniformly distributed series of numbers of the indices of the sorted spectral lines, this series of numbers logically is unsorted, to a non-uniformly distributed series, inversion chart formation may be applied to the indices in embodiments, which is a bijective, i.e. uniquely reversible mapping, and provides a non-uniformly distributed result, cf., e.g., Donald E. Knuth: The Art of Computer Programming, Volume 3: Sorting and Searching, Addison-Wesley, 1998.

A non-uniformly distributed series of numbers now is entropy coded, and hence the data volume to be transmitted is reduced. In the following, a brief example of the functioning of the inversion chart will be explained. Let us assume a set of number pairs A={(x₁, y₁), . . . , (xₙ, yₙ)}, wherein the xᵢ is to represent an indexing of yᵢ, so that the xᵢ form a strictly monotonously rising series. The yᵢ could, e.g., be amplitude values of a frequency spectrum, e.g. A={(1,5), (2,3), (3,1), (4,2), (5,8), (6,2.3), (7,2), (8,4.5), (9,6)}

Now, A is sorted on the basis of the quantity of yᵢ so that the yᵢ form a monotonously decreasing series. The xᵢ thereby become an unsorted series of numbers, i.e. a permutation of the original xᵢ.

### A′={(5,8), (9,6), (1,5), (8,4.5), (2,3), (6,2.3), (4,2), (7,2), (3,1)}

xᵢ′={5, 9, 1, 8, 2, 6, 4, 7, 3}
yᵢ′={8, 6, 5, 4.5, 3, 2.3, 2, 2, 1}

Inversion chart formation of xᵢ:

$$\begin{matrix}{x}_{i}^{′} & 5 & 9 & 1 & 8 & 2 & 6 & 4 & 7 & 3 & ( uniformly distributed ) \\ {x}_{i}^{′ - 1} & 2 & 3 & 6 & 4 & 0 & 2 & 2 & 1 & 0 & ( \begin{matrix}non \text{-} uniformly \\ distributed\end{matrix} )\end{matrix}$$

The inversion of the inversion chart again yields the original series of numbers:

$$\begin{matrix}{x}_{9}^{′ - 1} = 0 & 9 & & & & & & & & \\ {x}_{8}^{′ - 1} = 1 & 9 & 8 & & & & & & & \\ {x}_{7}^{′ - 1} = 2 & 9 & 8 & 7 & & & & & & \\ {x}_{6}^{′ - 1} = 2 & 9 & 8 & 6 & 7 & & & & & \\ {x}_{5}^{′ - 1} = 0 & 5 & 9 & 8 & 6 & 7 & & & & \\ {x}_{4}^{′ - 1} = 4 & 5 & 9 & 8 & 6 & 4 & 7 & & & \\ {x}_{3}^{′ - 1} = 6 & 5 & 9 & 8 & 6 & 4 & 7 & 3 & & \\ {x}_{2}^{′ - 1} = 3 & 5 & 9 & 8 & 2 & 6 & 4 & 7 & 3 & \\ {x}_{1}^{′ - 1} = 2 & 5 & 9 & 1 & 8 & 2 & 6 & 4 & 7 & 3 = {x}_{i}^{′}\end{matrix}$$

In principle, still further ways of inversion chart formation are possible, e.g. see

Donald E. Knuth: The Art of Computer Programming, Volume 3: Sorting and Searching, Addison-Wesley, 1998;

D. H. Lehmer: Teaching Combinatorial Tricks to a Computer, Proc. Of Symposium Appl. Math., Combinatorial Analysis, Vol. 10, American Mathematical Society, Providence, R.I., 1960, 179-193;

D. H. Lehmer, The Machine Tools of Combinatorics, Applied Combinatorial Mathematics, John Wiley and Sons, Inc. N.Y., 1964; and

Ziya Arnavut: Permutations Techniques in Lossless Compression, Dissertation, 1995.

Furthermore, in other embodiments, differential coding would be possible after the formation of the inversion chart, such as is described in, e.g., Ziya Arnavut: Permutations Techniques in Lossless Compression, Dissertation, 1995, or other post-processing procedures (e.g. prediction) which reduce the entropy.

Embodiments of the present invention work on the basis of a completely different principle than already existing systems. By avoiding the computation steps of quantization, re-sampling and low-pass filtering, and by selectively omitting psycho-acoustic consideration, embodiments may save some computational complexity. The quality of the coding for mode 2 exclusively depends the quality of the approximation of the functional rule to the sorted frequency spectrum, whereas the quality for mode 1 is mainly determined by the psycho-acoustic model used.

The bit rate of all modes largely depends on the complexity of the reverse-sorting rule to be transmitted. The bit rate scalability is given in a wide range, and any gradation is possible, from high compression to lossless coding at higher data rates. Due to the functional principle, the full frequency bandwidth of the signal can be transmitted even at relatively low bit rates. The low requirements with respect to computation power and memory space allow for using and implementing embodiments not only on conventional PCs, but also on portable terminals.

Furthermore, use in the field of MPEG-4 Scalable, MPEG Surround, cf. J. Breebaart, J. Herre, C. Faller et al.; MPEG Spatial Audio Coding/MPEG Surround: Overview and Current Status; 119^{th} AES Convention, October 2005,

Binaural Cue Coding, cf. C. Faller, F. Baumgarte; Binaural Cue Coding Applied to Stereo and Multi-Channel Audio Compression; 112^{th} AES Convention, May 2002,

or in the low-delay area, here may be also in connection with an application in the time domain, would be possible.

Since the functional principle of embodiments does not impose any restrictive requirements on the signal to be encoded, applications of the lossless mode, in particular, outside audio coding may occur, such as in video coding or other fields.

Since the developing bit rates significantly depend on the complexity of the reverse-sorting rule to be transmitted, even further embodiments are conceivable. Improvement is possible, for example, if a key is transmitted with which the obtained permutation can be identified uniquely on the decoder side. Already existing work in the field of “Restricted Permutations” can be used as a basis in this respect, cf. V. Vatter; Finitely Labeled Generating Trees and Restricted Permutations; Journal of Symbolic Computation, 41 (2006), 559-572.

Additionally, embodiments may provide for the transmission of an error or residual signal, with which the quality of modes 1 and 2 could be enhanced, and mode 2 even be extended to a lossless mode. Furthermore, a transmitted error signal could allow for intelligent reverse sorting for the frequency lines excluded from the reverse sorting in mode 1, and hence further improve the quality of this mode.

Embodiments may also provide for synthesization of frequency lines for mode 1, working in a way similar to SBR (Spectral Band Replication), but is not exclusively in charge of the upper frequency range here, but reconstructs deleted intermediate frequency ranges. Psycho-acoustic consideration specially tuned to the errors arising in the approximation could enhance the quality and lower the bit rate, in further embodiments. Since the principle of re-sorting and ensuing curve approximation does not depend on signals from the frequency domain, other embodiments may also be employed in the time domain also for mode 2. Since modes 2 and 3 omit the employment of psycho-acoustic consideration, embodiments may also be employed outside audio coding.

Embodiments may further provide optimized processing of stereo signals adapted to the particularities of this method, and hence may once again reduce the bit consumption and the computation effort as opposed to twofold mono-coding.

Embodiments make use of a sorting model. In a coding method working in accordance with the sorting model, sorting of the data to be encoded takes place. Thereby, artificial correlation of the data is brought about, on the one hand, whereby the data can be encoded more easily. On the other hand, a permutation of the original positions of the time values develops by way of the sorting. For a decoder to be able to again reconstruct original information or an audio signal, a back-sorting rule (permutation) may be encoded and transmitted apart from the encoded time values. Thereby, the original problem of performing only encoding of the time values is now split into two partial problems, i.e. encoding of the sorted time value and encoding of the reverse-sorting rule. FIG. 11 illustrates the scheme of a so-called “sorted-lossless” coding. For example, an audio signal is mapped to a signal with stronger correlation by way of sorting. Then, the sorted time values and a reverse-sorting rule are encoded.

From the principle described on the basis of FIG. 11, the name SOLO (Sorted Lossless) for the novel lossless coding method or audio coding method can be derived. Each of the two partial problems has very specific properties. For the encoding of the sorted time values, e.g. differential coding lends itself, in embodiments. The encoding of the permutation may, e.g., take place in the equivalent inversion chart representation. In the following, the two partial problems will be explained in detail. In addition to the sorting model, also traditional decorrelation methods, such as the predictive modeling, may be used in SOLO, however.

In the case of the sorting model, an additional processing step, the processing of the permutation, is added as compared with conventional coding methods. Hence, in embodiments, four basic processing steps result:

1. block division (framing)
2. decorrelation of the unsorted/sorted time values
3. processing of the permutation
4. entropy coding of the data from 2. and 3.

In the differential coding, as implied by the name, it is not the actual value, but the difference of successive values that is encoded. If the differences are smaller than the original values, higher compression can be achieved.

Let iεN (N=set of natural numbers) with 1≦i≦n<∞ and x₁εZ (Z=set of integers), then the differential encoding can be defined as:

$$δ ( x ) = \{ \begin{matrix}{x}_{i} & if i = 1 \\ {x}_{i - 1} - {x}_{i} & else\end{matrix}$$

The differential coding is invertible. Let iεN (N=set of natural numbers) with 1≦i≦n<∞ and x₁εZ (Z=set of integers), then the inverse differential coding can be defined as:

$${δ}^{- 1} ( x ) = \{ \begin{matrix}{x}_{i} & if i = 1 \\ {x}_{i - 1} - δ ( {x}_{i} ) & else\end{matrix}$$

Since the differential coding is a simple kind of prediction, here a warmup (a time value at i=1) is also excluded from the entropy coding here. δ has the property of the residual signal lying completely within the set of positive natural numbers in the case of the decreasingly sorted time values. Thereby, subsequent entropy coding can be made easier. Differential coding works optimally when the values to be encoded lie very closely together, i.e. are strongly correlated. By way of the sorting of the time values, the time values are brought into strong correlation.

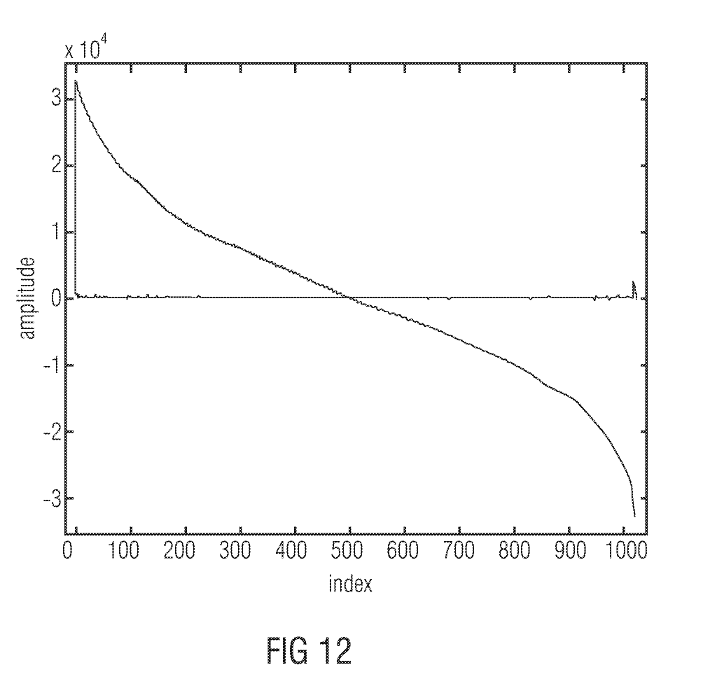

FIG. 12 shows an exemplary course of a differentially coded, sorted signal and its residual signal, i.e. FIG. 12 shows the effect of differential encoding applied to sorted time values. The matching value of the sorted and the decorrelated time signal at the index 1 (warmup or warmup phase) can be seen clearly. Furthermore, the substantially smaller dynamic range of the residual signal of the differential coding as opposed to the sorted time values is noticeable. Details on FIG. 12 can be taken from the following table. The differential coding thus represents a simple and efficient method to encode sorted time values.

| | max. value | | |
|---|---|---|---|
| | (without warmup) | min. value | warmup |
| sorted time values | 32425 | −32768 | 32767 |
| residual signal δ | 2630 | 0 | 32767 |

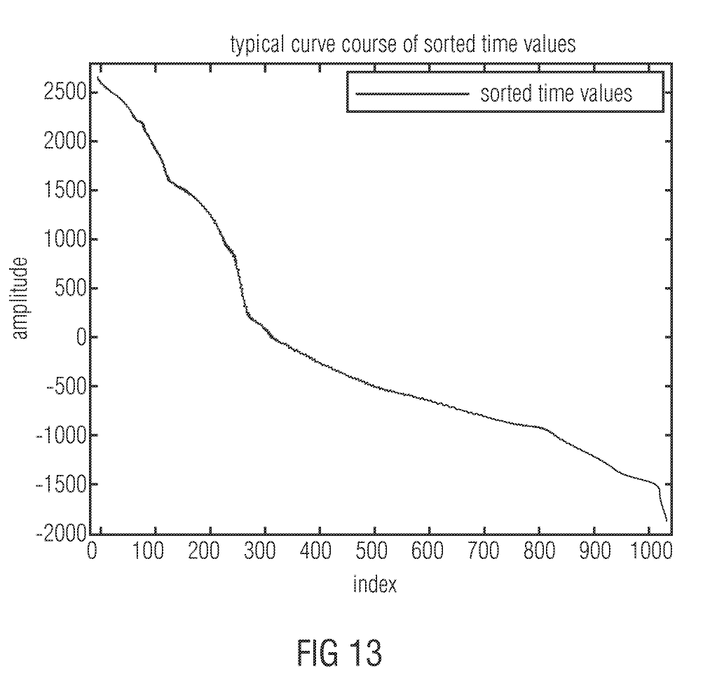

Curve fitting (CF) is a technique with which it is attempted to adapt a given mathematical model function to data points, here the sorted time values, as well as possible, in embodiments. The effectiveness of the curve fitting is determined, to a very substantial extent, by the fact of what shape the curves to be described have. It is certain that, depending on the kind of sorting, monotonously falling and/or monotonously rising curve shapes are concerned. FIGS. 12 and 13 show two representative curve shapes of sorted time values. The non-uniform curve shape in FIG. 13 is noteworthy. Such curve courses, which occur in about 40% (related to a selection of different audio signals) of cases, mostly cannot be described particularly well by way of curve fitting.

So as to approximate curve courses, as shown in FIGS. 12 and 13, the following function is chosen. In experiments, this function has proven well suited for describing the curve forms present here.

f_{cf1}(x)=c₁·e^{-λ}^{₁}^{x}+c₂·e^{-λ}^{₂}^{x}

The coefficients c₁, c₂, λ₁, λ₂ are elements of the set of real numbers and may be determined e.g. with the Nelder-Mead Simplex Algorithm, cf. NELDER, J. A.; MEAD, R. A.: A Simplex Method for Function Minimization. Computer Journal, Vol. 7, p. 308-313, 1965.

This algorithm is a method of optimizing non-linear functions of several parameters. Similar to the Regula falsi method with step size control, the tendency of the values is approximated in the direction of optimum. The Nelder-Mead Simplex Algorithm converges about linearly and is relatively simple and robust. The function f_{cf1} has the advantage that it can be adapted very flexibly to a whole series of curve courses. However, it is disadvantageous that relatively much side information (four coefficients) is needed. Moreover, it is noticeable that parts of the sorted curves, e.g. the middle portion of FIG. 12, could be described well by a first-order polynomial (straight line) and only two real coefficients a, b would be needed. For this reason, a second function is to be applied as an alternative:

f_{cf2}(x)=ax+b.

Curve fitting across the entire number of sorted time values of a block certainly is too inaccurate. For this reason, it seems expedient to divide the block into several smaller partitions. However, if the block is decomposed into too many partitions, which are described by the functions f_{cf1} and f_{cf2}, very many functional coefficients are needed. For this reason, in one embodiment, subdivision into four partitions of 256 time values each is performed in the case of a fixed overall block length of 1024 time values. So as to be able to decide, for each partition, whether f_{cf1} or f_{cf2} is better suited for curve fitting, an adequate decision criterion is needed. The decision criterion should be easy to determine, on the one hand, and should be expressive, on the other hand. So as to guarantee this, at first the residual signal of the respective function is formed and an estimation of the bit need is performed. Since function f_{cf1} needs twice as many coefficients as f_{cf2}, 32 bits are estimated additionally for f_{cf1}.

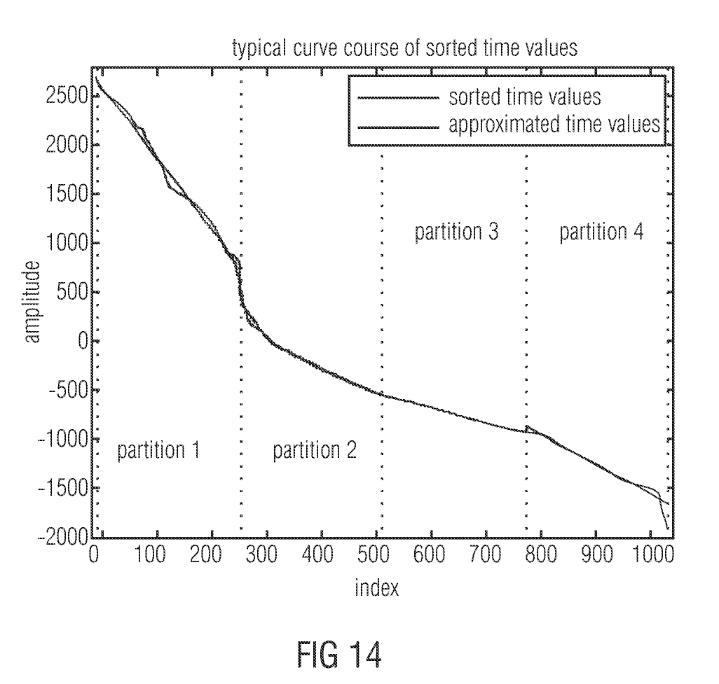

In FIG. 14, the functioning of curve fitting is illustrated. In this frame, the first and fourth partition is described by fcf2, and the second and third partition by fcf1.

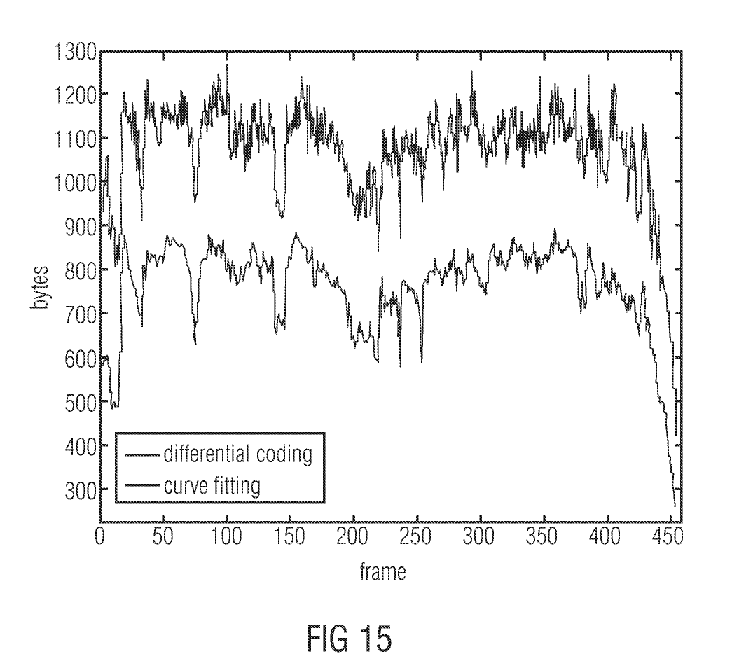

Finally, a direct comparison between the differential coding and decorrelation by way of curve fitting is to be drawn up. To this end, the respective costs in bytes per frame are indicated. So as to guarantee for direct comparison of both coding methods, in both cases forward-adaptive Rice coding with only one parameter is used. In all blocks, the differential coding outperforms the curve fitting indicated here; a comparison is shown in FIG. 15.

In the following, details of embodiments of the present invention will be explained in greater detail. The following table lists the audio material used in the following, to which reference will be made in the corresponding passages.

| | | Sampling | | | | | |
|---|---|---|---|---|---|---|---|
| No. | File name | rate | Bits | Channels | Remark | Source | Style |
| 1 | adia m.wav | 44100 Hz | 16 | 1 | | n.d. | Pop |
| 2 | white m.wav | 44100 Hz | 16 | 1 | 0dBFS | s.e. | White noise |
| 3 | es01 m.wav | 44100 Hz | 16 | 1 | Suzanne Vega | n.d. | Pop |
| 4 | es02 m.wav | 44100 Hz | 16 | 1 | cut | SQAM | German Male |
| 5 | es03 m.wav | 44100 Hz | 16 | 1 | cut | SQAM | English Female |
| 6 | si01 m.wav | 44100 Hz | 16 | 1 | cut | SQAM | Harpsichord |
| 7 | si02 m.wav | 44100 Hz | 16 | 1 | cut | SQAM | Castagnets |
| 8 | si03 m.wav | 44100 Hz | 16 | 1 | | n.d. | Pitch Pipe |
| 9 | sm01 m.wav | 44100 Hz | 16 | 1 | | n.d. | Bagpipe |
| 10 | sm02 m.wav | 44100 Hz | 16 | 1 | | n.d. | Chimes |
| 11 | sm03 m.wav | 44100 Hz | 16 | 1 | | n.d. | Dulzimer |
| 12 | sc01 m.wav | 44100 Hz | 16 | 1 | cut | SQAM | Trumpet concerto |
| 13 | sc02 m.wav | 44100 Hz | 16 | 1 | Richard Wagner | n.d. | Meistersinger |
| 14 | sc03 m.wav | 44100 Hz | 16 | 1 | | n.d. | Pop |
| 15 | sine1 kHz 0dB.wav | 44100 Hz | 16 | 1 | 0dBFS | s.e. | 1 kHz sine |
| 16 | adia LeqR.wav | 44100 Hz | 16 | 2 | L = R | s.e. | Pop |
| 17 | adia.wav | 44100 Hz | 16 | 2 | | n.d. | Pop |
| 18 | es01.wav | 44100 Hz | 16 | 2 | Suzanne Vega | n.d. | Pop |
| 19 | es02.wav | 44100 Hz | 16 | 2 | cut | SQAM | German Male |
| 20 | es03.wav | 44100 Hz | 16 | 2 | cut | SQAM | English Female |
| 21 | si01.wav | 44100 Hz | 16 | 2 | cut | SQAM | Harpsichord |
| 22 | si02.wav | 44100 Hz | 16 | 2 | cut | SQAM | Castagnets |
| 23 | si03.wav | 44100 Hz | 16 | 2 | | n.d. | Pitch Pipe |
| 24 | sm01.wav | 44100 Hz | 16 | 2 | | n.d. | Bagpipe |
| 25 | sm02.wav | 44100 Hz | 16 | 2 | cut | SQAM | Chimes |
| 26 | sm03.wav | 44100 Hz | 16 | 2 | | n.d. | Dulzimer |
| 27 | sc01.wav | 44100 Hz | 16 | 2 | cut | SQAM | Trumpet concerto |
| 28 | sc02.wav | 44100 Hz | 16 | 2 | Richard Wagner | n.d. | Meistersinger |
| 29 | sc03.wav | 44100 Hz | 16 | 2 | | n.d. | Pop |

The lossless coding may roughly be divided into two fields. There are universal methods capable of working with data of the most diverse kinds, and there are specialized methods optimized for compressing very specific data, such as audio signals.

Universal methods like GZIP or ZIP for the compression of digital data have been in existence for many years now. GZIP uses the Deflate algorithm for compression, which is a combination of LZ77 (see Ziv, Jacob; Lempel, Abraham: A Universal Algorithm for Sequential Data Compression. IEEE Transactions on Information Theory, Vol. IT-23, No. 3, May 1977) and Huffman coding (see Huffman, David A.: A Method for the Construction of Minimum-Redundancy Codes. Proceedings of the I.R.E, September, 1952). The ZIP file format uses a similar algorithm for compression. Another universal method is BZIP2. Here, pre-coding with the Burrows-Wheeler transform (BWT) (see Burrows, M.; Wheeler, D.: A block sorting lossless data compression algorithm. Technical Report 124, Digital Equipment Corporation, 1994) takes place prior to the actual coding of the data.

BZIP2 also used Huffman coding. These programs can be applied to any data, such as text, program code, audio signals, etc. Due to their functioning, these methods indeed achieve significantly better compression with text than with audio signals. A direct comparison of GZIP and the SHORTEN compression method specialized in audio signals (see Robinson, Tony: SHORTEN: Simple lossless and near lossless waveform compression. Technical report CUED/FINFENG/TR.156, Cambridge University Engineering Department, December 1994) confirms this (see the following table). The respective standard settings have been used for the test.

| | File size | GZIP | | SHORTEN | |
|---|---|---|---|---|---|
| Piece No. | (Bytes) | File size | F | File size | F |
| 13 | 2246022 | 1962100 | 1.145 | 1102557 | 2.037 |
| 14 | 2037842 | 1724447 | 1.182 | 1304845 | 1.562 |
| 17 | 1912876 | 1753719 | 1.091 | 1117413 | 1.712 |

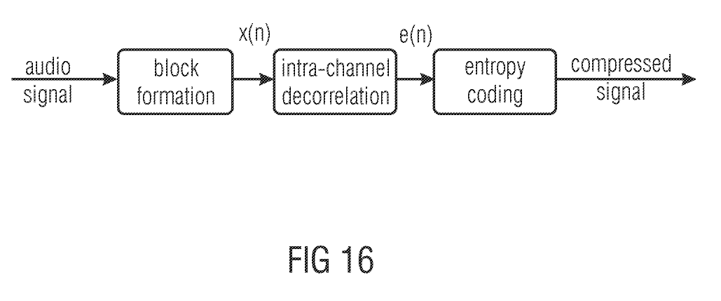

Thus, to obtain a good compression factor for audio signals, the special properties of audio signals must be taken into account in the compression. Most lossless audio coding methods share the block circuit diagram shown in FIG. 16.

FIG. 16 exemplarily shows processing steps of most lossless audio compression algorithms. The illustration in FIG. 16 shows a block circuit diagram, wherein the audio signal at first is supplied to block formation or a “framing” block dividing the audio signal into signal blocks. Subsequently, an intra-channel decorrelation block decorrelates individual the signal, for example by way of differential coding. In an entropy coding block, the signal finally is entropy coded, cf. also Hans, Mat; Schafer, Ronald W.: Lossless Compression of Digital Audio. IEEE Signal Processing Magazine, July 2001.

At first, the data to be processed is decomposed into signal portions (frames) x(n)εZ (Z corresponds to the set of integers) of a certain size. Then a decorrelation step follows, in which it is attempted to remove the redundancy from the signal as well as possible. Finally, the signal e(n)εZ obtained from the decorrelation step is entropy coded. Previously, there have been two basic procedures for the decorrelation step. Most lossless audio coding methods use a kind of linear prediction to remove the redundancy from the signal (predictive modeling). Other lossless audio coding methods are based on a lossy audio coding method in which, apart from the lossy data, the residual or error signal is encoded in addition to the original signal (lossy coding model). Subsequently, the different approaches are to be considered in more detail.

The linear prediction (Linear Predictive Coding—LPC) is widespread mainly in digital speech signal processing. Its significance does not only lie in high efficiency, but also in relatively low computational complexity. The basic idea of prediction is to predict a value x(n) from previous values x(n−1), x(n−2), . . . , x(n−p). If p previous values are used for prediction, it is referred to as a p^{th}-order predictor. The prediction coding methods used in lossless audio coding usually have the basic structure shown in FIG. 12. Â(z) and \hat{B}(z) here designate z-transform polynomials (see Mitra, Sanjit K.: Digital Signal Processing. New York: McGraw-Hill, 2001, pp. 155-176) with quantized coefficients âₖ and \hat{b}ₖ. Q stands for quantization to the same word length as x(n). The z-transform is the time-discrete analog of the Laplace transform of time-continuous signals.

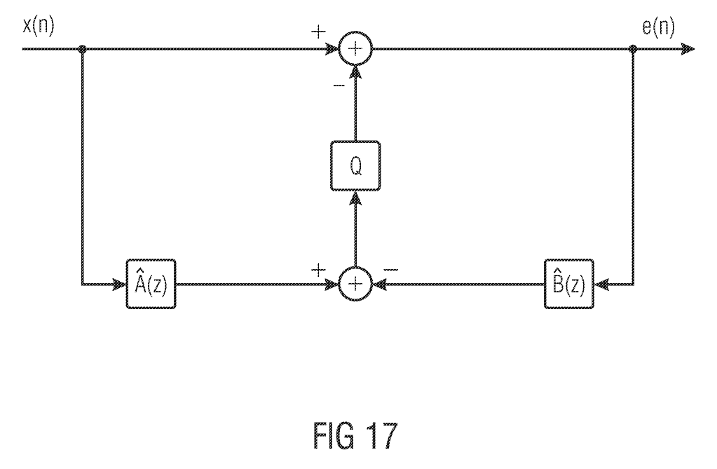

FIG. 17 shows an embodiment of a structure of prediction coding. In principle, FIG. 17 shows an IIR filter structure with a feedforward branch with filter coefficients Â(z), a feedback branch with filter coefficients \hat{B}(z) and a quantization Q.

FIG. 17 is based on the equation of

$$e ( n ) = x ( n ) Q {\underbrace{{\sum }_{k = 1}^{p} {\hat{a}}_{k} x ( nk )}}_{feedforward term} {\underbrace{{\sum }_{k = 1}^{q} {\hat{b}}_{k} e ( nk )}}_{feedback term}$$

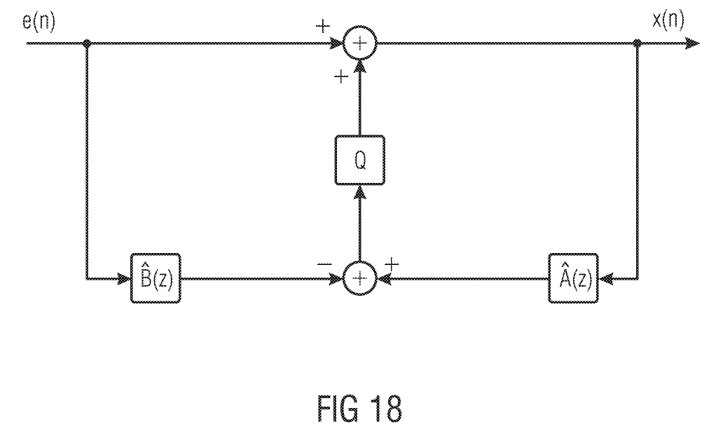

If the prediction coding method works optimally, a large part of the redundancy is removed from x(n) and is represented by the coefficients of Â(z) and \hat{B}(z). The resulting residual signal e(n) then is uncorrelated and clearly smaller in amplitude than the original signal x(n). Thereby, a coding gain is achieved. If \hat{B}(z)=0, i.e. the feedback term equals 0, this is referred to as an FIR predictor. Otherwise, i.e. \hat{B}(z)≠0, this is referred to as an IIR predictor. IIR predictors are not to be considered in greater detail here. IIR predictors are significantly more complex, but may achieve better coding gain than FIR predictors in some cases (see Craven, P.; Law, M.; Stuart, J.: Lossless Compression using IIR prediction filters. Munich: 102^{nd} AES Conv., 1997). So as to be able to reconstruct the original signal again from the residual signal e(n) and the predictor coefficients, the procedure is like in FIG. 18.

FIG. 18 shows an embodiment of a structure of a reconstruction in prediction coding. FIG. 18 shows an implementation as an IIR filter structure with a feedforward branch with filter coefficients \hat{B}(z), a feedback branch with filter coefficients Â(z), and a quantization Q.

FIG. 18 is based on the equation of

$$x ( n ) = e ( n ) + Q [ {\sum }_{k = 1}^{p} {\hat{a}}_{k} x ( n - k ) - {\sum }_{k = 1}^{q} {\hat{b}}_{k} e ( n - k ) ]$$

The predictor coefficients are determined and transmitted for each signal portion to be processed each time anew. The adaptive determination of the coefficients ak of a p^{th}-order predictor can be done with either the covariance method or the autocorrelation method, which uses the autocorrelation function. With the autocorrelation method, the coefficients are obtained via the solution of a linear equation system of the following form:

$$( \begin{matrix}{r}_{xx} ( 1 ) \\ {r}_{xx} ( 2 ) \\ {r}_{xx} ( 3 ) \\ ⋮ \\ {r}_{xx} ( p )\end{matrix} ) = ( \begin{matrix}{r}_{xx} ( 0 ) & {r}_{xx} ( 1 ) & {r}_{xx} ( 2 ) & … & {r}_{xx} ( p - 1 ) \\ {r}_{xx} ( 1 ) & {r}_{xx} ( 2 ) & {r}_{xx} ( 1 ) & … & {r}_{xx} ( p - 2 ) \\ {r}_{xx} ( 2 ) & {r}_{xx} ( 3 ) & {r}_{xx} ( 0 ) & … & {r}_{xx} ( p - 3 ) \\ ⋮ & ⋮ & ⋮ & … & ⋮ \\ {r}_{xx} ( p - 1 ) & {r}_{xx} ( p - 2 ) & {r}_{xx} ( p - 3 ) & … & {r}_{xx} ( 0 )\end{matrix} ) ( \begin{matrix}{a}_{1} \\ {a}_{2} \\ {a}_{3} \\ ⋮ \\ {a}_{p}\end{matrix} ) .$$

Wherein rₓₓ(k)=E(s(n)s(n+k)) applies (see Sayood, Khalid: Introduction to Data Compression. San Francisco: Morgan Kaufmann, Third Edition, 2006, p. 333). Alternatively, this can be represented by

r=Ra

in matrix notation. Since R is invertible, the coefficients are obtained by

a=R⁻¹r.

How the linear equation system for determining the optimum predictor coefficients is obtained exactly is described in detail in Jayant, N. S., Noll, P.: Digitial Coding of Waveforms—Principles and Applications to Speech and Video. Prentice Hall, Englewood Cliffs, N.J., 1984, pp. 267-269, Sayood, Khalid: Introduction to Data Compression. San Francisco: Morgan Kaufmann, Third Edition, 2006, pp. 332-334 and Rabiner, L. R.; Schafer, R. W.: Digital Processing of Speech Signals. New Jersey: Prentice-Hall, 1978, pp. 396-404. Due to the matrix properties of R, the equation can be solved very effectively with the Levinson-Durbin algorithm (see Yu, R.; Lin, X.; Ko, C. C.: A Multi-Stage Levinson-Durbin Algorithm. IEEE Proc., Vol. 1, pp. 218-221, November 2002).

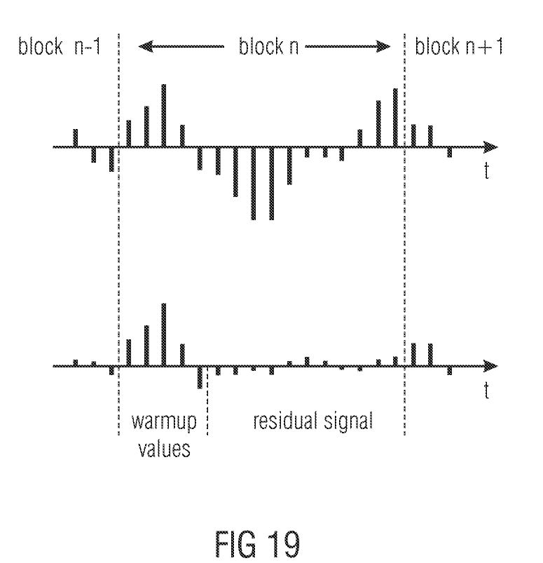

For prediction, a division of the time values into blocks of the size N is performed. Assuming it is desired to use a 2^{nd}-order predictor to predict the time values from the current block n, the problem arises of how to deal with the first two values from block n. Either the last two values from the preceding block n−1 may be used to predict same, or the first two values of block n are not predicted and are left in their original form. If the values of the preceding block n−1 are used, then block n can be decoded only if block n−1 has been decoded successfully. Yet, this would lead to block dependencies and contradict the principle of treating each block (frame) as an autonomously decodable unit. If the first p values are left in their original form, they are referred to as warmup or warmup values (see FIG. 19) of the predictor. Since the warmup usually has other size ratios and statistical properties than the residual signal, it is not entropy coded in most cases.

FIG. 19 shows an example of warmup values of a prediction filter. In the upper region of FIG. 19, unchanged input signals are illustrated, and warmup values and a residual signal are illustrated in the lower region.

Another way of realizing prediction is to not determine the coefficients for each signal portion anew, but to use fixed predictor coefficients. If the same coefficients are used, this is also referred to as a fixed predictor.

As an example, AudioPaK (see Hans, Mat; Schafer, Ronald W.: Lossless Compression of Digital Audio. IEEE Signal Processing Magazine, July 2001, pp. 28-31), a representative of predictive modeling, is now to be considered in some more detail. In AudioPak, at first the audio signal is decomposed into independent, autonomously decodable portions. Usually, multiples of 192 samples (192, 576, 1152, 2304, 4608) are used. For the decorrelation, an FIR predictor with fixed integer coefficients is used (fixed predictor). This FIR predictor was first used in SHORTEN (see Robinson, Tony: SHORTEN: Simple lossless and near lossless waveform compression. Technical report CUED/FINFENG/TR.156, Cambridge University Engineering Department, December 1994, pp. 3-4). Internally, the fixed predictor has four different prediction models.

\hat{x}₀(n)=0

\hat{x}₁(n)=x(n−1)

\hat{x}₂(n)=2x(n−1)−x(n−2)

\hat{x}₃(n)=3x(n−1)−3x(n−2)+x(n−3)

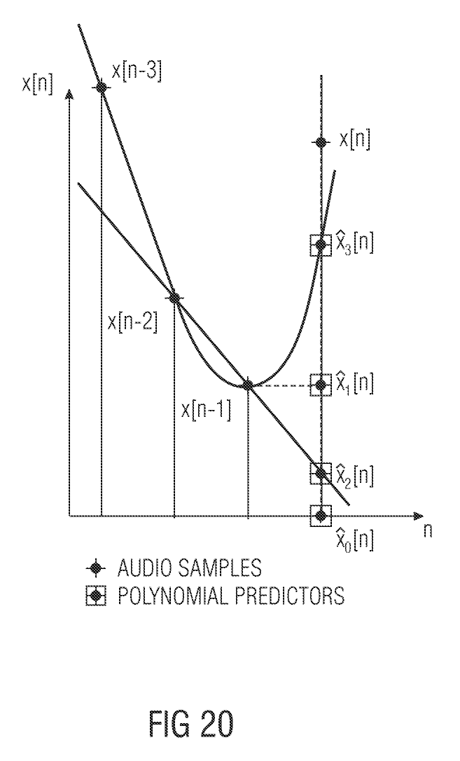

In principle, there are polynomial approximation and/or prediction methods in the equation. The preceding p samples x(n−1), x(n−2), . . . , x(n−p) may be described by p−1-order polynomials. Upon evaluating this polynomial at the location n, the predicted value \hat{x}(n) is obtained. This may be illustrated graphically as shown in FIG. 20. FIG. 20 shows an embodiment of a prediction model, in a polynomial predictor.

The residual signals eₚ(n)=x(n)−\hat{x}ₚ(n) obtained by the prediction can be recursively computed in a relatively easy manner like in the following equation.

e₀(n)=x(n)

e₁(n)=e₀(n)−e₀(n−1)

e₂(n)=e₁(n)−e₁(n−1)

e₃(n)=e₂(n)−e₂(n−1)

Ultimately, the best prediction model is determined by the fact that the sum of the magnitudes of the residual signal values becomes smallest. AudioPak uses Rice coding. Since the values of the residual signal are eᵢ(n)εZ, but the Rice coding works with values from N₀, at first a mapping of the residual values eᵢ(n) to N₀ is performed.

$$M ( {e}_{i} ( n ) ) = \begin{matrix}2 {e}_{i} ( n ) & if {e}_{i} ( n ) \geq 0 \\ 2 \vert {e}_{i} ( n ) \vert - 1 & else\end{matrix}$$

The Rice parameter k is determined per block (frame) and assumes values of 0, 1, . . . , (b−1). Here, b represents the number of bits per audio sample. k is determined via the following equation

k=┌log₂(E(|eᵢ(n)|))┐

A straightforward estimation of k without any floating-point operations may, for example, be done as follows:

for (k=0, N=framesize; N<AbsError; k++, N*=2) {NULL;},
wherein framesize represents the number of samples per frame, and AbsError the sum of the absolute values of the residual signal. Further representatives of predictive modeling are SHORTEN (see Robinson, Tony: SHORTEN: Simple lossless and nearlossless waveform compression. Technical report CUED/FINFENG/TR.156, Cambridge University Engineering Department, December 1994), FLAC (see Coalson, Josh: FLAC—Free Lossless Audio Codec; http://flac.sourceforge.net), MPEG-4 Audio Lossless Coding (MPEG-4 ALS) (see Liebchen, Tilman; Reznik, Yuriy; Moriya, Takehiro; Yang, Dai Tracy: MPEG-4 Audio Lossless Coding. Berlin, Germany: 116th AES Convention, May 2004) and Monkey's Audio (see Ashland, Matthew T.: Monkey's Audio—a fast and powerful lossless audio compressor; http://www.monkeysaudio.com/index.html).

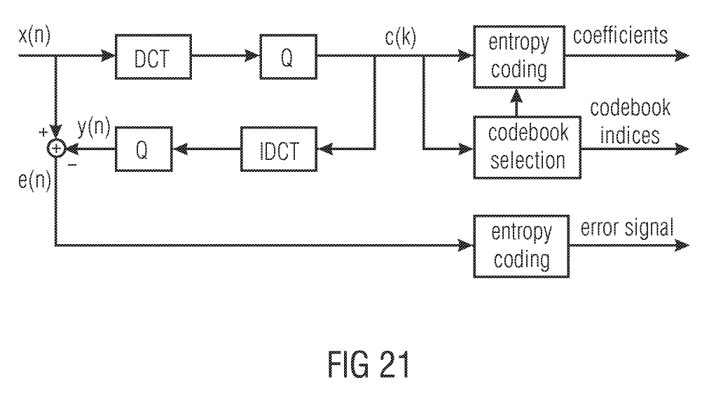

The second way of realizing a lossless audio coding method is to build on a lossy audio coding method. One representative of the lossy coding model is LTAC, wherein the abbreviation LTC (Lossless Transform Coding) is also used instead of LTAC (Lossless Transform Audio Compression), see Liebchen, Tilman; Purat, Marcus; Noll, Peter: Lossless Transform Coding of Audio Signals. Munich, Germany: 102^{nd} AES Convention, 1997. The principle functioning of the encoder is illustrated in FIG. 21.

FIG. 21 shows a block diagram of a structure of an LTAC (Lossless Transform Coding) encoder. The encoder includes a “DCT” block to transform an input signal x(n) into the frequency domain, followed by quantization Q. The quantized signal c(n) may then be transformed back into the time domain by an “IDCT” block, where it may then be quantized by a further quantizer Q and subtracted from the original input signal. The residual signal e(n) may then be transmitted in an entropy-coded manner. The quantized signal c(n) may also be encoded via entropy coding, which may choose from among various codebooks, corresponding to FIG. 21.

In LTAC, the time values x(n) are transformed into the frequency domain by an orthogonal transform (DCT—Discrete Cosine Transform). In the lossy part, then the spectral values are quantized c(k) and entropy coded.

So as to now realize a lossless coding method, the quantized spectral values c(k) are additionally transformed back with the inverse transform (IDCT=Inverse Discrete Cosine Transform) and again quantized y(n). The residual signal is calculated by way of e(n)=x(n)−y(n). Then, e(n) is entropy coded and transmitted. In the decoder, y(n) can be obtained again from c(k) by way of the IDCT with ensuing quantization. Finally, perfect reconstruction of x(n) in the decoder is realized by way of y(n)+e(n)=y(n)+[x(n)−y(n)]=x(n).

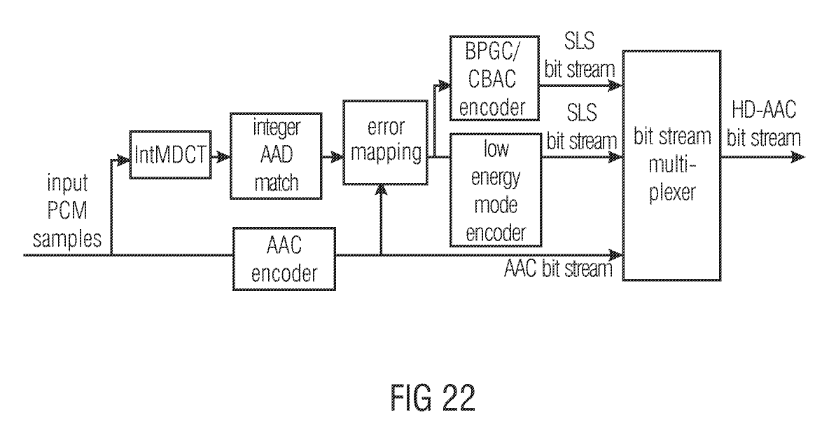

A further method falling into the category of the lossy coding model is MPEG-4 Scalable Lossless Audio Coding SLS) (see Geiger, Ralf; Yu, Rongshan; Herre, Jürgen; Rahardja, Susanto; Kim, Sang-Wook; Lin, Xiao; Schmidt, Markus: ISO/IEC MPEG-4 High-Definition Scalable Advanced Audio Coding. Paris: 120^{th} AES Convention, May 2006). It combines functionalities of lossless audio coding, lossy audio coding and scalable audio coding. On bit stream level, MPEG-4 SLS is backwardly compatible to MPEG-4 Advanced Audio Coding (MPEG-4 AAC) (see ISO/IEC JTC1/SC29/WG11: Coding of Audiovisual Objects, Part 3. Audio, Subpart 4 Time/Frequency Coding. International Standard 14496-3, 1999). FIG. 22 shows a block diagram of an MPEG-4 SLS (SLS=Scalable Lossless Audio Coding) encoder.

At first, the audio data is transformed into the frequency domain with an IntMDCT (Integer Modified Discrete Cosine Transform) (see Geiger, Ralf; Sporer, Thomas; Koller, Jürgen; Brandenburg, Karlheinz: Audio Coding Based on Integer Transforms; New York: 111^{nd} AES Conv., 2001) and then processed further by temporal noise shaping (TNS) and mid/side-channel coding (integer AAC tools/adaptation). Everything the AAC encoder has encoded is then removed from the IntMDCT spectral values by error mapping. What remains is a residual signal, which is subjected to entropy coding. For the entropy coding, a BPGC (Bit-Plane Golomb Code), CBAC (Context-Based Arithmetic Code) and low energy mode are used.

Sound transmission via two or more channels is referred to as stereophony. In practice, the term stereo is mostly used exclusively for two-channel pieces. If there are more than two channels, it is referred to as multi-channel sound. This master-degree paper only deals with signals having two channels, for which the designation stereo signals is used synonymously. One possibility of processing stereo signals is to encode both channels independently of each other. In this case, this is called independent stereo coding. Apart from “pseudo-stereo” versions of old mono recordings (both channels identical) or two-channel sound in television (independent channels), stereo signals usually have both differences and commonalities (redundancy) between the two channels. If one is successful in determining the commonalities and transmitting them only once for both channels, one can reduce the bit rate. In this case, this is called dependent stereo coding (Joint Stereo Coding). One way of reducing the redundancy between stereo signals is the mid/side-channel coding (MS coding). This technique was described first for lossy audio coding methods in Johnston, J. D.; Ferreira, A. J.: Sum-Difference Stereo Transform Coding, IEEE International Conference, ICASSP, 1992. The following equation shows how to generate a mid channel M and a side channel S from a left channel L and a right channel R.

$$( \begin{matrix}\frac{1}{2} & \frac{1}{2} \\ \frac{1}{2} & - \frac{1}{2}\end{matrix} ) ( \begin{matrix}L \\ R\end{matrix} ) = ( \begin{matrix}M \\ S\end{matrix} )$$

Since

$$det ( \begin{matrix}\frac{1}{2} & \frac{1}{2} \\ \frac{1}{2} & - \frac{1}{2}\end{matrix} ) \neq 0 ,$$

the MS coding is invertible

$$( \begin{matrix}1 & 1 \\ 1 & - 1\end{matrix} ) ( \begin{matrix}M \\ S\end{matrix} ) = ( \begin{matrix}L \\ R\end{matrix} ) .$$

Lossless audio coding methods also utilize the MS coding. Yet, since the above equation has the property of floating-point numbers instead of integers resulting in some cases, some lossless audio coding methods (see Ashland, Matthew T.: Monkey's Audio—a fast and powerful lossless audio compressor; http://www.monkeysaudio.com/index.html) use the following equation for MS coding

$$M = NINT ( \frac{L + R}{2} )$$

$$S = L - R$$

NINT here means rounding to the closest integer with respect to zero.

Apart from MS coding, lossless audio coding methods also use LS coding and/or RS coding (see Coalson, Josh: FLAC—Free Lossless Audio Codec; http://flac.sourceforge.net). In order to obtain the right channel from LS coding and/or the left channel from RS coding, one must proceed like in the following equation

L=R+S

R=L−S.

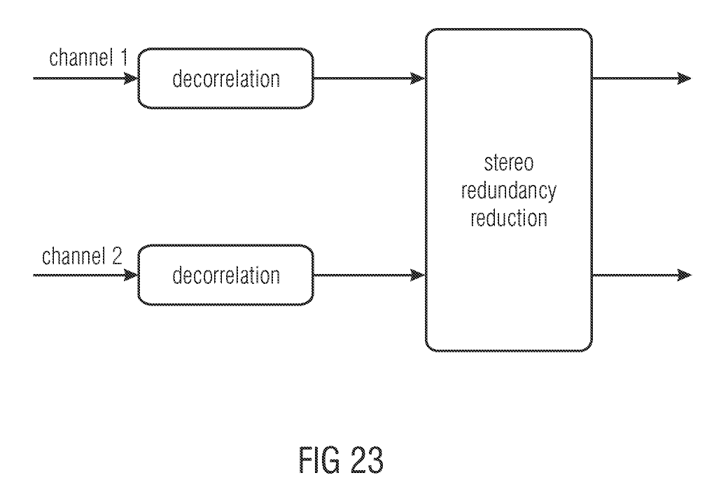

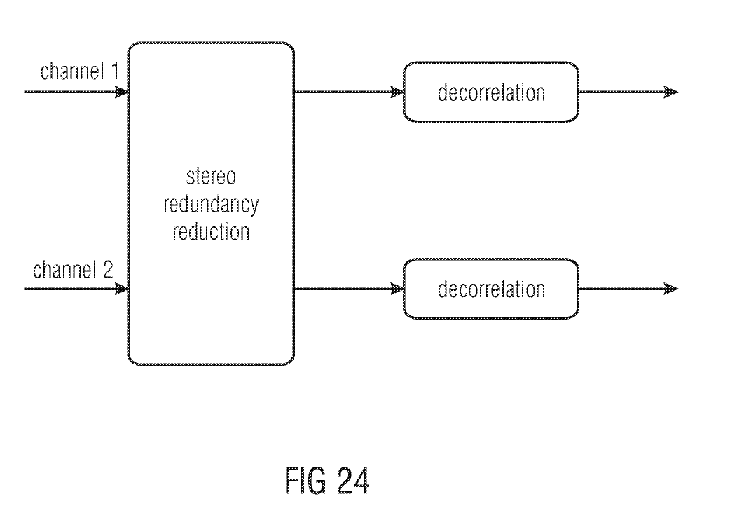

There are two basic possibilities of performing stereo redundancy reduction (SRR). Either after the decorrelation of the individual channels (see FIG. 23) or prior to the decorrelation of the individual channels (see FIG. 24). FIG. 23 shows stereo redundancy reduction (SRR) after the decorrelation of individual channels, and FIG. 24 stereo redundancy reduction prior to the decorrelation of individual channels. Both methods have specific advantages and disadvantages. In the following, however, method 2 is to be used exclusively.

In this section, a suitable quantization is to be developed for the linear prediction (LPC=Linear Prediction Coding) presented. The coefficients a_{z} determined usually are floating-point values (real numbers), which can only be represented with finite accuracy in digital systems. Thus, quantization of the coefficients a_{z} has to take place. However, this may lead to greater prediction errors and is to be taken into account in the generation of the residual signal. For this reason, it makes sense to control the quantization via an accuracy parameter g. If g is large, finer quantization of the coefficients takes place and more bits are needed for the coefficients. If g is small, rougher quantization of the coefficients takes place and fewer bits are needed for the coefficients. So as to be able to realize a quantization, at first the largest coefficient aₘₐₓ in terms of magnitude is determined.

aₘₐₓ=max(|aᵢ|) for i=1, 2, . . . , p.

The maximum predictor coefficient aₘₐₓ thus determined is now decomposed into a mantissa M and into an exponent E to the base 2, i.e.

aₘₐₓ=2^{E}·M.

The mantissa M is no longer required in the following, but the exponent E serves to determine the scaling factor s by way of the following equation

s=g−E−1.

The subtraction from 1 serves to take signed coefficients into consideration. The quantized predictor coefficients for i=1, 2, . . . , p are obtained by way of the equation of

âᵢ=└aᵢ·2^{s}┘.

With the scaling factor s and the quantized predictor coefficients âᵢ, the residual signal e(n) to be transmitted is determined

$$e ( n ) = x ( n ) - ⌊ ( {\sum }_{k = 1}^{p} {\hat{a}}_{i} x ( n - k ) ) \cdot {2}^{- s} ⌋ .$$

The equation ensures that e(n)εZ applies. By way of a transmission of the warmup, the parameters g, s, p, âᵢ and the residual signal e(n) to the decoder, perfect reconstruction of the original values x(n) of this signal portion is possible thereby

$$x ( n ) = e ( n ) + ⌊ ( {\sum }_{k = 1}^{p} {\hat{a}}_{i} x ( n - k ) ) \cdot {2}^{- s} ⌋ .$$

If the order of the predictor is increased, this usually decreases the variance and amplitude of the residual signal. This entails a lower data rate for the residual signal. On the other hand, there is the fact that more coefficients and a larger warmup, i.e. more side information, have to be transmitted for a higher predictor order. Thereby, the overall data rate increases again. Hence, it is the object to find an order at which the overall data rate is minimized.

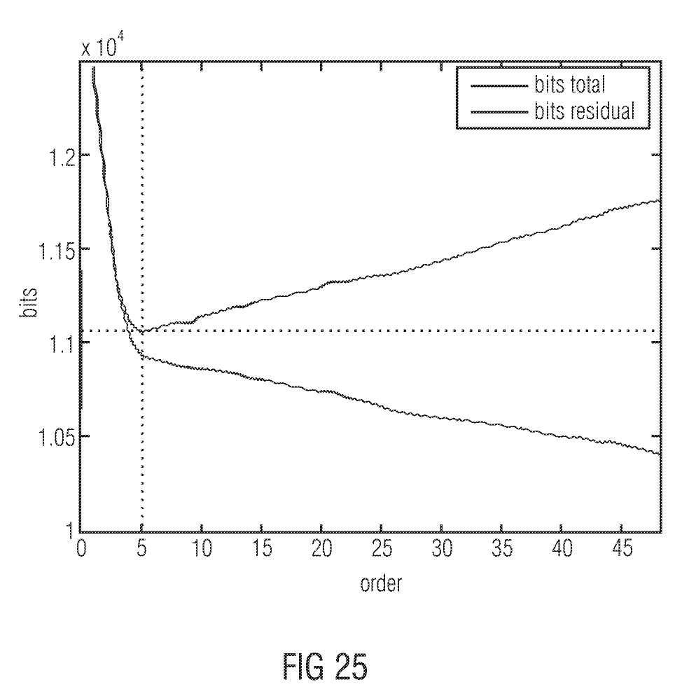

FIG. 25 illustrates the connection of predictor order and overall bit consumption. It can be seen clearly that with rising order the residual signal needs less and less bits for coding. Yet, the data rate for the side information (quantized predictor coefficients and warmup) continuously increases, whereby the overall data rate again rises starting from some point. Usually, a minimum is reached at 1<p<16. In FIG. 25, an optimal order is obtained at p=5. A fixed value for the quantization control of g=12 and a resolution of 16 bits per sample for the input signal were used for FIG. 25.

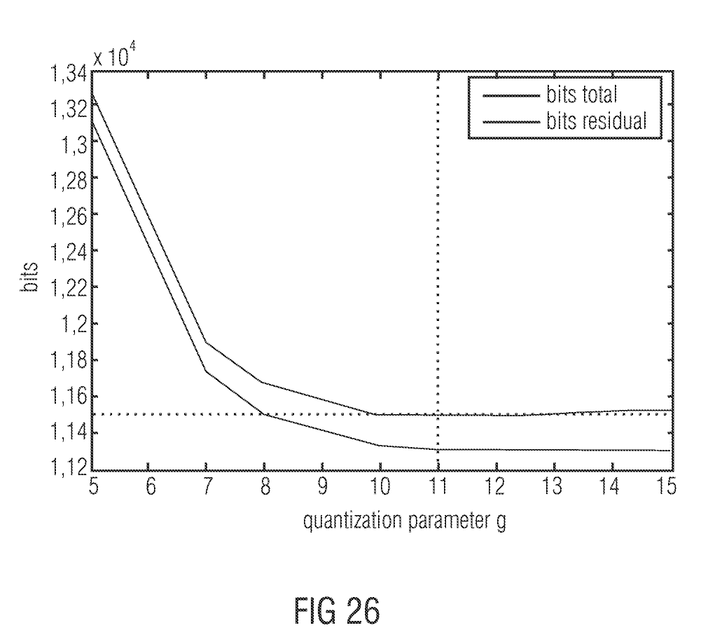

FIG. 26 shows an illustration of the connection of the quantization parameter g and the overall bit consumption. Regarding the overall bit rate depending on the quantization parameter g (see FIG. 26), the bit consumption for the residual signal decreases continuously up to a certain value. From here onward, further increase of the quantization accuracy is no use any longer. This means that the number of bits needed for the residual signal remains almost constant. The overall data rate continuously decreases in the beginning, but then again rises due to increasing side information for the quantized predictor coefficients. In most cases, an optimum is obtained at 5<g<15. In FIG. 26, the minimum is at g=11. A constant predictor order of p=7 and a resolution of 16 bits per sample for the input signal were used for FIG. 26.

The findings just obtained are now to be used to indicate an algorithm for lossless linear prediction in simplified MATLAB code representation (see lpc( )). MATLAB is a commercial mathematics software designed for calculations with matrices. The name MATrix LABoratory originates therefrom. Programming in MATLAB is in a proprietary, platform-independent programming language, which is interpreted on the respective computer. At first, some variables are initialized according to the limit values determined in FIG. 25 and FIG. 26. Then, the predictor coefficients are determined via the autocorrelation and the Levinson-Durbin algorithm. The core of the algorithm is formed by two interleaved for-loops. The outer loop runs via the predictor order p. The inner loop runs via the quantization parameter g. Within the inner loop, the quantization of the coefficients, the calculation of the residual signal and entropy coding of the residual signal take place. Instead of complete entropy coding of the residual signal, estimation of the bit consumption would also be possible, which might be quicker to execute. Finally, the variant with the lowest bit consumption is secured. What follows is an embodiment of a MATLAB code:

```
lpc(data, bitsPerSample)
% initialize bestBits with maximum value
    bestBits = INT_MAX;
% limits of the predictor order
    max_lpc_order = 16;
    min_lpc_order = 1;
% limits of the quantization accuracy
    min_quant_precision = 5;
    max_quant_precision = 15;
% calculate autocorrelation
    autoc = CalcAutocorr(data, max_lpc_order);
% determine coefficients for all relevant
% orders with the Levinson-Durbin algorithm
    coeffs = CalcCoeff(autoc, max_lpc_order);
% find the best order p
    for p = min_lpc_order:1:max_lpc_order
% find the best quantization parameter g
        for g = min_quant_precision:1:max_quant_precision
% quantize the coefficients
          [qcoeffs, s] = QuantCoeffs(coeffs, p, g);
% calculate residual signal (actual prediction)
          [residual, warmup] = CalcResidual(data, p, s, qcoeffs);
% entropy coding of the residual signal
          bitsResidual = EntropyCoding(residual);
% bits needed for the coefficients
          bitsQCoeffs = g * p;
% bits needed for the warmup
          bitsWarmup = bitsPerSample * p;
% determine overall bit consumption
          bitsTotal = bitsResidual + bitsQCoeffs + bitsWarmup;
% store best variant
          if (bitsTotal < bestBits)
              bestOrder = p;
              bestWarmup = warmup;
              bestQuantScal = s;
              bestPrecision = g;
              bestQCoeffs = qcoeffs;
              bestResidual = residual;
              bestBits = bitsTotal;
          end
        end
    end
end
```

Here, it is to be examined whether the above-described FIR predictor can be extended with fixed and integer coefficients (fixed predictor) in a profitable way. From the above section, we know that an optimum order p lies in the range of 1<p<16. The fixed predictor in Robinson, Tony: SHORTEN: Simple lossless and nearlossless waveform compression; Technical report CUED/FINFENG/TR.156, Cambridge University Engineering Department, December 1994,

uses a maximum order of p=3. In Hans, Mat; Schafer, Ronald W.: Lossless Compression of Digital Audio, IEEE Signal Processing Magazine, July 2001, p. 30, the transfer function of the fixed predictor

H(z)=(1−z⁻¹)^{p}

and the magnitude frequency course

|H(e^{jωT})=|2·sin(ωT/2)|^{p}

are indicated. Here, T designates the sampling rate, and ω=2πf. The transfer function is a mathematical description of the behavior of a linear, time-invariant system, which has an input and an output. By way of the frequency response, the behavior of a linear time-invariant system is described, wherein the output quantity is compared with the input quantity and recorded depending on the frequency. Utilizing the above equation, two further orders p=4 and p=5 are designed:

\hat{x}₀(n)=0

\hat{x}₁(n)=x(n−1)

\hat{x}₂(n)=2x(n−1)−x(n−2)

\hat{x}₃(n)=3x(n−1)−3x(n−2)+x(n−3)

\hat{x}₄(n)=4x(n−1)−6x(n−2)+4x(n−3)−x(n−4)

\hat{x}₅(n)=5x(n−1)−10x(n−2)+10x(n−3)−5x(n−4)+x(n−5).

The corresponding residual signals are obtained by way of the following equation, and the formation of the warmup is done equivalently to the above section:

e₀(n)=x(n)

e₁(n)=e₀(n)−e₀(n−1)

e₂(n)=e₁(n)−e₁(n−1)

e₃(n)=e₂(n)−e₂(n−1)

e₄(n)=e₃(n)−e₃(n−1)

e₅(n)=e₄(n)−e₄(n−1).

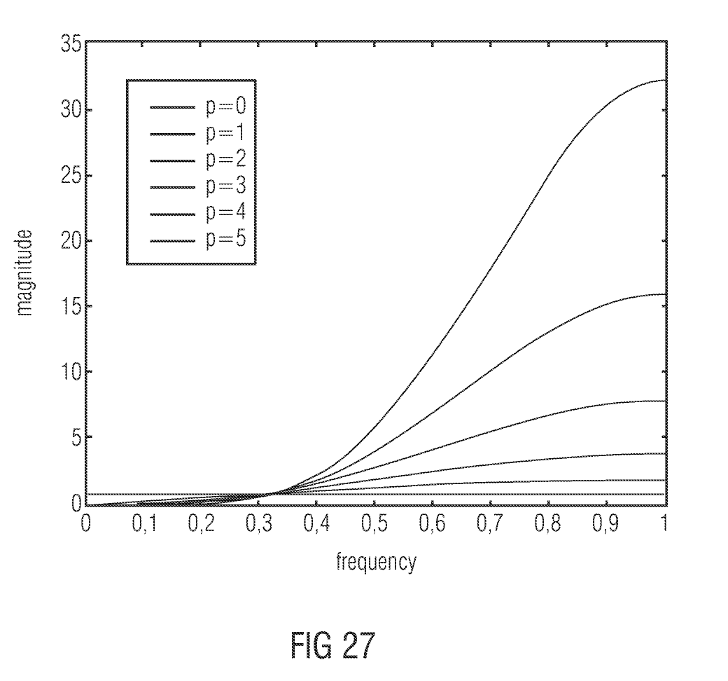

FIG. 27 shows an illustration of a magnitude frequency response of a fixed predictor, depending on its order p. The effect of the different predictor orders becomes obvious on the basis of a consideration of their frequency responses (see FIG. 27). At an order of p=0, the residual signal corresponds to the input signal. Thereby, a magnitude frequency response of constantly 1 is obtained. An increase in the order leads to stronger attenuation of the low-frequency signal proportions, on the one hand, but to an increase of the high-frequency signal proportions, on the other hand. The frequency axis was normalized to half the sampling frequency for illustration, whereby the 1 results at half the sampling frequency (here 22.05 kHz).

An examination now is to show whether a coding gain can be achieved by the inclusion of p=4 and p=5. To this end, various pieces of music are examined, and the order necessitating the fewest bits is selected per block.

In the following table, it is illustrated how often which order was selected as the best one, as summed across the entire audio file. A constant block length of 1024 time values was chosen for the creation of this table.

| | | | | | | | overall block |
|---|---|---|---|---|---|---|---|
| Piece No. | p = 0 | p = 1 | p = 2 | p = 3 | p = 4 | p = 5 | number |
| 1 | 0 | 14 | 316 | 67 | 57 | 0 | 454 |
| 4 | 15 | 69 | 161 | 79 | 0 | 0 | 324 |
| 6 | 5 | 173 | 115 | 27 | 0 | 0 | 320 |
| 7 | 3 | 74 | 189 | 43 | 0 | 0 | 309 |
| 8 | 0 | 221 | 959 | 0 | 0 | 0 | 1180 |
| 14 | 2 | 30 | 279 | 158 | 4 | 0 | 473 |
| 15 | 0 | 0 | 0 | 0 | 0 | 216 | 216 |

From the above table it can be seen that there is no predictor order that is optimal in all cases. For this reason, it makes sense to determine the best order for each block again. Orders p=2, p=3 and p=1 are selected most frequently. Orders p=0 and p=4 are used less frequently. Some coding gain is achieved in piece number 1 by the extension of the fixed predictor by p=4. The order p=5 provides coding gain only in piece 15. Since piece number 15 is no “usual” piece of music, but a 1 kHz sine, the benefit of p=5 is questionable. Moreover, this also indicates that p>5 usually no longer provides any great coding gain and only increases complexity. Like in the above section, the findings just obtained are to be used to indicate an algorithm (see fixed( )). At first, the maximum and minimum orders are defined. Then follows a for-loop, which runs across all orders. Within this loop, the residual signal with the corresponding bit consumption and the costs of the warmup depending on the order are determined. Finally, the best variant is selected.

```
fixed(data, bitsPerSample)
% initialize bestBits with maximum value
      bestBits = INT_MAX
% limits of the predictor order
      max_fixed_order = 5;
      min_fixed_order = 0;
      for p = min_fixed_order:1:max_fixed_order
% calculate residual signal (actual prediction)
            [residual, warmup] = CalcResidual(data, p);
% entropy coding of the residual signal
            bitsResidual = EntropyCoding(residual);
% bits needed for the warmup
            bitsWarmup = bitsPerSample * p;
% determine overall bit consumption
            bitsTotal = bitsResidual + bitsWarmup;
% store best variant
            if (bitsTotal < bestBits)
                  bestOrder = p;
                  bestWarmup = warmup;
                  bestResidual = residual;
                  bestBits = bitsTotal;
            end
      end
end
```

In the differential coding, as implied by the name, it is not the actual value, but the difference of successive values that is encoded. If the differences are smaller than the original values, higher compression can be achieved. The fixed predictor described in the above section uses differential coding for p=1.

Definition (differential coding): Let iεN with 1<i<n<oo and xᵢεZ, then the differential coding is defined as:

$$δ ( x ) = \{ \begin{matrix}{x}_{i} & if i = 1 \\ {x}_{i - 1} - {x}_{i} & else .\end{matrix}$$

The differential coding is invertible.

Definition (inverse differential coding): Let iεN with 1<i<n<oo and xᵢεZ, then the inverse differential coding is defined as:

$${δ}^{- 1} ( x ) = \{ \begin{matrix}{x}_{1} & if i = 1 \\ {x}_{i - 1} - δ ( {x}_{i} ) & else .\end{matrix}$$

Like in the case of the predictors, the warmup (a time value at i=1) is excluded from the entropy coding. δ has the property of the residual signal completely lying within N₀ in the case of decreasingly sorted time values. Thereby, subsequent entropy coding can be designed to be simpler. Differential coding works optimally if the values to be encoded lie very closely together, i.e. are strongly correlated. By way of the sorting of the time values, the time values are brought into strong correlation. FIG. 12 has already shown the effect of differential coding applied to sorted time values. The matching value of the sorted and the decorrelated time signal at index 1 (warmup) can be seen clearly. Furthermore, the substantially smaller dynamic range of the residual signal of the differential coding as opposed to the sorted time values is noticeable. Details regarding FIG. 12 are indicated in the following table. The differential coding thus represents a simple and efficient method to encode sorted time values.

| | max. value | | |
|---|---|---|---|
| piece no. 2 | (without warmup) | min. value | warmup |
| sorted time values | 32425 | −32768 | 32767 |
| residual signal δ | 2630 | 0 | 32767 |

In the following two sections, methods of how to effectively encode permutations are developed. Assuming memory-less consideration of a permutation, the entropy of an arbitrary permutation σ with |σ|<oo is given by the following equation. The with-memory consideration of a permutation is to be omitted deliberately here, because a memory-less consideration represents the simplest kind of encoding of permutation

H(σ)=log₂(|σ|).

H(σ) then describes the number of bits/characters needed for a binary coding of a σ(i). So as to represent, e.g., a permutation of the length 256, 8 bits per element are needed. This is due to the fact that the occurrence of the elements of the permutation is equally probable. The permutation obtained in the encoding of an audio signal (e.g. 16 bits resolution) by sorting the time values would need half the input data rate alone in this example. Since this data volume is already relatively high, the following question arises: Is it possible to binarily encode permutations with less than log₂(|σ|) bits per element?

In the above section, it has been shown that it can be switched from the permutation representation to an equivalent inversion chart illustration and back. Therefore, it is to be examined whether a binary representation of the inversion chart needs a smaller data rate than that of the permutation. An example is to provide clarity here.

Example: The following permutations are given

$$σ = ( \begin{matrix}1 & 2 & 3 & 4 \\ 4 & 2 & 1 & 3\end{matrix} ) , π = ( \begin{matrix}1 & 2 & 3 & 4 \\ 4 & 3 & 2 & 1\end{matrix} )$$

If the inversion chart of σ and n is formed, I(σ)=(2110), I(π)=(3210) is obtained. The following applies

H(I(σ))=1.5 Bit<2 Bit=H(σ).

This means that the entropy of the inversion chart is actually smaller than that of the permutation. Yet, the following is obtained for π

H(I(π))=2 Bit=H(π).

In the case of π, the entropy of the inversion chart thus is just as great as that of the permutation. Yet, considering π in reverse order, i.e. π(4), π(3), π(2), π(1), the identical permutation is obtained, and its inversion chart has very little entropy. At any rate, the following applies for an arbitrary permutation σ with |σ|<oo:

H(I(σ))≦H(σ).

Now, further inversion chart formation rules are to be defined to counteract the problem with n described in the above example. At first, for completeness' sake, the inversion chart formation rule (inversion chart LB in the following) described in the above section is to be mentioned again.

Definition (LB=left bigger): Let σεSₙ be a permutation, and bⱼ with j=1, 2, . . . , n be the number of elements to the left of j greater than j. Then, I_{lb}(σ)=(b₁b₂ . . . bₙ) represents the inversion chart LB of σ.

Definition (LS=left smaller): Let σεSₙ be a permutation, and bⱼ with j=1, 2, . . . , n be the number of elements to the left of j smaller than j. Then, Iᵢₛ(σ)=(b₁b₂ . . . bₙ) represents the inversion chart LB of σ.

Definition (RB=right bigger): Let σεSₙ be a permutation, and bⱼ with j=1, 2, . . . , n be the number of elements to the right of j greater than j. Then, I_{rb}(σ)=(b₁b₂ . . . bₙ) represents the inversion chart LB of σ.

Definition (RS=right smaller): Let σεSₙ be a permutation, and bⱼ with j=1, 2, . . . , n be the number of elements to the right of j greater than j. Then, Iᵣₛ(σ)=(b₁b₂ . . . bₙ) represents the inversion chart LB of σ.

Example: An example of the formation of an inversion chart RS and the corresponding generation of the permutation is shown here exemplarily,

$$σ = ( \begin{matrix}1 & 2 & 3 & 4 \\ 4 & 2 & 1 & 3\end{matrix} ) .$$

At first, one takes the element of the permutation with σ(i)=1 and counts the elements to the right of σ(i)=1 in σ that are smaller than 1. Here, this is none of the elements. Then, one takes the element of the permutation with σ(i)=2 and counts the smaller elements to the right of σ(i)=1 in σ. Here, no element to the right of σ(i)=2 is smaller than 2. Continuing exactly like this up to |σ|, finally Iᵣₛ(σ)=(b₁, . . . , b₄)=(0023) is obtained. When proceeding step by step, j=1, 2, . . . |σ|, the corresponding permutation can be generated again from an inversion chart RS. To this end one proceeds in an inverse manner and inserts j so that bⱼ elements to the right thereof are smaller than j.

b1=0 1

b2=0 1 2

b3=2 3 1 2

b4=3 4 3 1 2

If the inversion charts LB, LS and RB of σare formed,

I_{lb}(σ)=(2210)

Iₗₛ(σ)=(0100)

I_{lb}(σ)=(1000)

is obtained.

A comparison of the entropies of the inversion charts from above shows that their entropies in part have significant differences and are smaller here than the entropy of the permutation (2 bits) in all cases.

H(I_{lb}(σ))=1.5 Bit<2 Bit=H(σ)

H(Iₗₛ(σ))≈0.81 Bit<2 Bit=H(σ)

H(I_{rb}(σ))≈0.81 Bit<2 Bit=H(σ)

H(Iᵣₛ(σ))=1.5 Bit<2 Bit=H(σ)

ARNAVUT, Ziya: Permutation Techniques in Lossless Compression. Nebraska, University, Computer Science, Dissertation, 1995, pp. 58-78 used several different methods for the formation of inversion charts in his dissertation. However, he used different formation rules for the inversion charts. These are the Lehmer inversion charts. When inversion charts are mentioned in the following, the non-Lehmer inversion charts are meant. In the case of Lehmer inversion charts, “Lehmer” is added explicitly. These are now to be described and also used in the following.

Definition (Lehmer inversion chart RS (right smaller)): Let σεSₙ be a permutation. The Lehmer inversion chart RS Iᵣₛₗ(σ)=(b₁, b₂, . . . , bₙ) then is defined as

bₖ=|{j:k<j≦n̂σ(k)>σ(j)}| für 1≦k≦n

The addition rsl stands for “right smaller Lehmer”. The same applies for the following definitions. Of course, the permutation may again be generated from the Lehmer inversion chart RS. In ARNAVUT, Ziya: Permutation Techniques in Lossless Compression. Nebraska, University, Computer Science, Dissertation, 1995 on p. 62-63, the following algorithm has been indicated for this. In the algorithm, l represents a concatenated list

$$Algorithm \text{:} {1}_{rsl}^{- 1} ( σ )$$

$$1. Set i ← 1 , l ← ( 1 , 2 , … , n )$$

$$2. σ ( i ) ← l ( {b}_{i} + 1 )$$

$$3. l ← l - l ( {b}_{i} + 1 ) ( remove l ( {b}_{i} + 1 ) from l )$$

$$4. i ← i + 1 , if i > n stop , otherwise go to 2.$$

ARNAVUT, Ziya: Permutation Techniques in Lossless Compression. Nebraska, University, Computer Science, Dissertation, 1995 indeed pointed out, in his dissertation, that he used several Lehmer inversion chart formation rules, but no definitions of the remaining three inversion chart formation rules (RBL, LSL and LBL) in greater detail nor corresponding algorithms for restoring the permutation were indicated. For this reason, the corresponding definition and algorithms shall be indicated here.

Definition (Lehmer inversion chart RB). Let σεSₙ be a permutation. The Lehmer inversion chart RB I_{rbl}(σ)=(b₁, b₂, . . . , bₙ) is then defined as

$${b}_{k} = \vert \{ j \text{:} k < j \leq n ⋀ σ ( k ) < σ ( j ) \} \vert for 1 \leq k \leq n . \\ Algorithm \text{:} {1}_{rbl}^{- 1} ( σ )$$

$$1. Set i ← 1 , l ← ( n , n - 1 , … , 1 )$$

$$2. σ ( i ) ← l ( {b}_{i} + 1 )$$

$$3. l ← l - l ( {b}_{i} + 1 ) ( remove l ( {b}_{i} + 1 ) from l )$$

$$4. i ← i + 1 , if i > n stop , otherwise go to 2.$$

Definition (Lehmer inversion chart LS). Let σεSₙ be a permutation. The Lehmer inversion chart LS Iₗₛₗ(σ)=(b₁, b₂, . . . , bₙ) is then defined as

$${b}_{k} = \vert \{ j \text{:} j < k \leq n ⋀ σ ( k ) < σ ( j ) \} \vert for 1 \leq k \leq n$$

$$Algorithm \text{:} {1}_{lsl}^{- 1} ( σ )$$

$$1. Set i ← n , l ← ( 1 , 2 , … , n )$$

$$2. σ ( i ) ← l ( {b}_{i} + 1 )$$

$$3. l ← l - l ( {b}_{i} + 1 ) ( remove l ( {b}_{i} + 1 ) from l )$$

$$4. i ← i - 1 , if i > n stop , otherwise go to 2.$$

Definition (Lehmer inversion chart LB). Let σεSₙ be a permutation. The Lehmer inversion chart LB I_{lbl}(σ)=(b₁, b₂, . . . , bₙ) is then defined as

$${b}_{k} = \vert \{ j \text{:} j < k \leq n ⋀ σ ( k ) < σ ( j ) \} \vert for 1 \leq k \leq n . \\ Algorithm \text{:} {1}_{lbl}^{- 1} ( σ )$$

$$1. Set i ← n , l ← ( n , n - 1 , … , 1 )$$

$$2. σ ( i ) ← l ( {b}_{i} + 1 )$$

$$3. l ← l - l ( {b}_{i} + 1 ) ( remove l ( {b}_{i} + 1 ) from l )$$

$$4. i ← i + 1 , if i > n stop , otherwise go to 2.$$

Example: The construction of a Lehmer inversion chart LB and the corresponding restoration of the permutation are to be shown exemplarily for all four Lehmer inversion charts here, too. What is given is

$$σ = ( \begin{matrix}1 & 2 & 3 & 4 \\ 4 & 3 & 1 & 2\end{matrix} ) .$$

At first, one takes the first element of the permutation σ(1)=4 and counts the elements to the left of σ(1) in σ that are greater than 4. Here, these are 0 elements. Then, one takes the second element of the permutation σ(2)=3 and counts the greater elements to the left of σ(2) in σ. Here, one element next to σ(2) is greater than 3. If one proceeds exactly like this up to |σ|, finally I_{lbl}(σ)=(b₁, b₂, . . . , b₄)=(0111) is obtained. From a Lehmer inversion chart LB, the corresponding permutation can be regenerated by way of the algorithm I_{lbl}⁻¹(σ)

$$\begin{matrix} & & & & & l = ( 4 , 3 , 2 , 1 ) \\ {b}_{4} = 2 & & & & 2 & l = ( 4 , 3 , 1 ) \\ {b}_{3} = 2 & & & 1 & 2 & l = ( 4 , 3 ) \\ {b}_{2} = 1 & & 3 & 1 & 2 & l = ( 4 ) \\ {b}_{1} = 0 & 4 & 3 & 2 & 1 & l = \{ \}\end{matrix} .$$

If one forms the Lehmer inversion charts RSL, RBL and LSL of σ, one obtains

lᵣₛₗ(σ)=(3200)

l_{rbl}(σ)=(0010)

lₗₛₗ(σ)=(0001)

The shown property of the elements of the inversion chart LB also applies for the inversion charts RB, RBL and RSL. For the inversion charts LS, RS, LBL and LSL, however, the elements have the following properties

0≦bⱼ≦j−1 (∀j=1, 2, . . . , n).

Among the inversion charts and the Lehmer inversion charts, there is the following connection with respect to the entropy

H(l_{lb}(σ))=H(l_{lbl}(σ))

H(lₗₛ(σ))=H(lₗₛₗ(σ))

H(l_{rb}(σ))=H(l_{rbl}(σ))

H(lᵣₛ(σ))=H(lᵣₛₗ(σ)).

This is due to the fact that when forming the respective inversion chart and/or Lehmer inversion chart, the elements only are considered in another order.

So as to obtain a statement as to how high the data rate for encoding a permutation is, now a measure of this coding effort is defined. For this measure, the entropies of the various inversion charts and/or Lehmer inversion charts are considered.

Definition (codability measure): Let σ be a permutation with |σ|<∞, and I_{lb}(σ), Iₜₛ(σ), Iₗₛ(σ), I_{rb}(σ) be the corresponding inversion charts and/or I_{lbl}(σ), Iₗₛₗ(σ), I_{rbl}(σ), Iᵣₛₗ(σ) the corresponding Lehmer inversion charts, then the codability measure for permutations is defined by

$$\begin{matrix}C ( σ ) = min ( H ( {l}_{lsl} ( σ ) ) , H ( {l}_{lbl} ( σ ) ) , H ( {l}_{rsl} ( σ ) ) , H ( {l}_{rbl} ( σ ) ) ) \\ = min ( H ( {l}_{ls} ( σ ) ) , H ( {l}_{l b} ( σ ) ) , H ( {l}_{rs} ( σ ) ) , H ( {l}_{rb} ( σ ) ) ) .\end{matrix}$$

Signaling as to which of the 8 inversion chart formation rules was used can be done with 3 bits. Hence, the use of the best variant is more inexpensive than usual binary coding of the permutation if the following inequality for |σ|<∞ applies:

3<(H(σ)−C(σ))·|σ|.

By way of experimentation, it has been found that H(σ)>C(σ) applies for |σ|>1 and hence this equation holds true, starting at |σ|>4. This also answers the question raised at the beginning as to whether a permutation can be encoded with less than log₂(|σ|). For reasons of measurability, it is desirable to scramble permutations piece by piece, starting from the identical permutation. To this end, an algorithm from KNUTH, Donald E.: The Art of Computer Programming; Massachusetts: Addison Wesley, 1998 (Vol. 2, p. 145) can be used.

Algorithm P (Shuffling): Let X₁, X₂, . . . , Xₜ be a number of t numbers to be scrambled.

P1. Initialization: Set j←t

P2. Generate U: Generate a random number U between 0 and 1 (equally distributed).

P3. Commutation: Set k←└jU┘+1 Commute Xₖ [symbol] Xⱼ.

P4. Decrease j: Decrease j by 1. If j<1 go to P2.

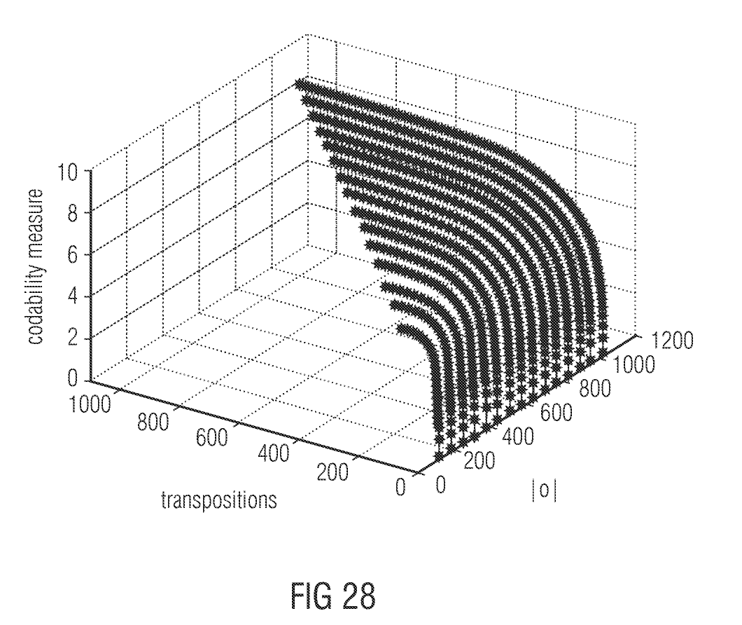

What is disadvantageous in the algorithm is the choice of U. Independently of the fact of which U is chosen in randomized form, the t numbers are scrambled sometimes a bit more and/or sometimes a bit less in a transposition step. What is substantial here, however, is the property of the algorithm proceeding step by step and decreasing the scrambling of an originally unscrambled permutation (identical permutation) piece by piece. From FIG. 28, a property between the length of the permutation, the number of transpositions and the codability measure can be read out clearly. FIG. 28 shows an illustration of the connection of permutation lengths |s|, number of transpositions and codability measure. If the identical permutation is given, then the codability measure equals 0. If only few elements of the permutation are interchanged, the codability measure instantly rises sharply. Then, if even more permutation elements are interchanged by transpositions, the curve flattens toward the top and does toward the empirically determined bit values from the following table.

| | \|σ\| | | | | | | | | | | | | | | |
|---|---|---|---|---|---|---|---|---|---|---|---|---|---|---|---|
| | 128 | 192 | 256 | 320 | 384 | 448 | 512 | 576 | 640 | 704 | 768 | 832 | 896 | 960 | 1024 |
| H(σ) | 7.00 | 7.59 | 8.00 | 8.32 | 8.59 | 8.81 | 9.00 | 9.17 | 9.32 | 9.46 | 9.59 | 9.70 | 9.81 | 9.91 | 10.00 |
| C(σ) | 5.72 | 6.35 | 6.73 | 7.08 | 7.33 | 7.53 | 7.74 | 7.90 | 8.07 | 8.19 | 8.32 | 8.43 | 8.53 | 8.65 | 8.74 |

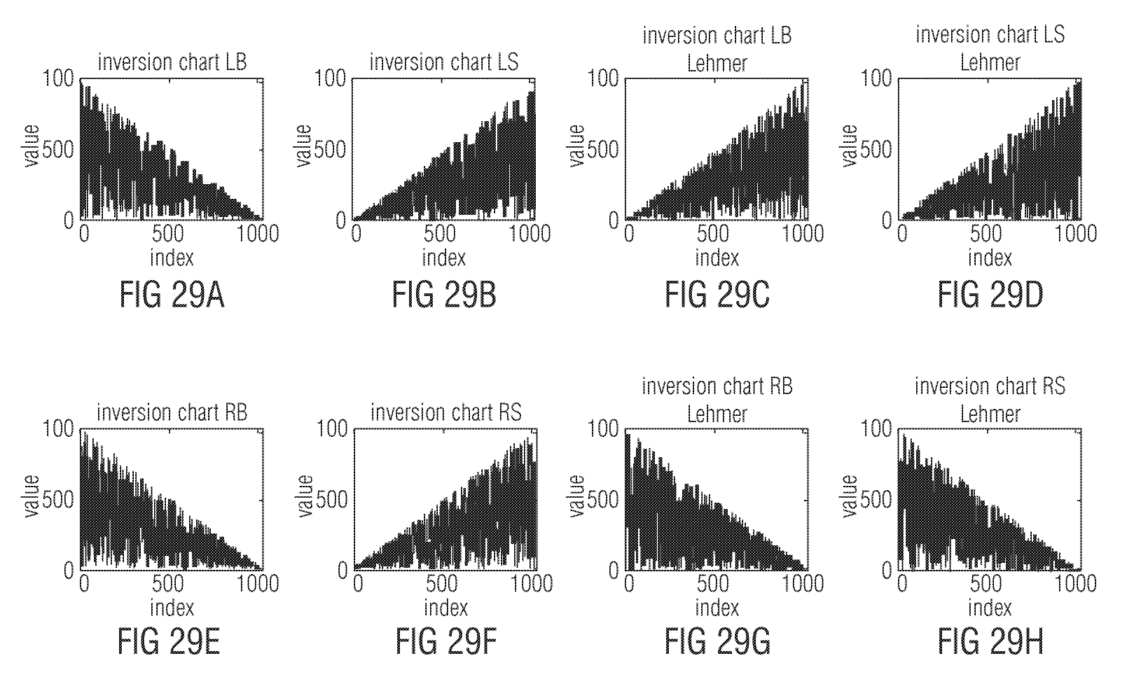

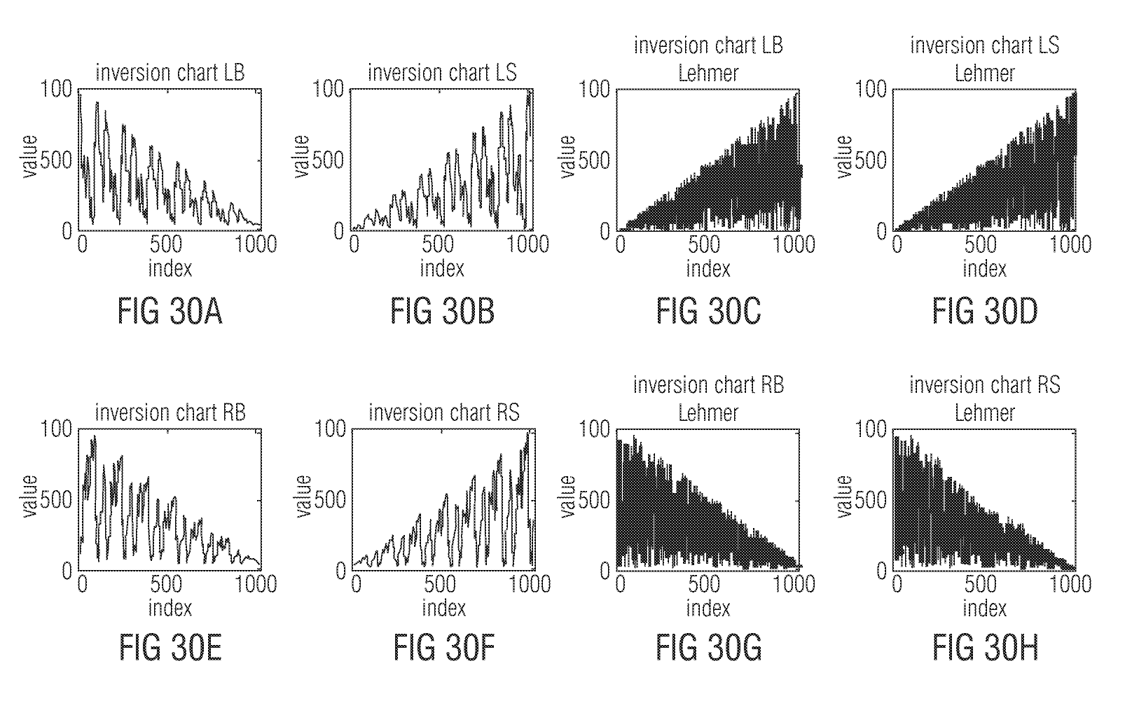

Now, it shall be shown which form the inversion charts and Lehmer inversion charts of a permutation obtained by the sorting of the time values have in a variety of music. To this end, a very tonal piece and a noise-like piece are used. FIGS. 29A-29H show an illustration of inversion charts in the 10^{th} block (frame) of a noise-like piece. FIGS. 30A-30H show an illustration of inversion charts in the 20^{th} block (frame) of a tonal piece. The basis is a block size of 1024 time values.

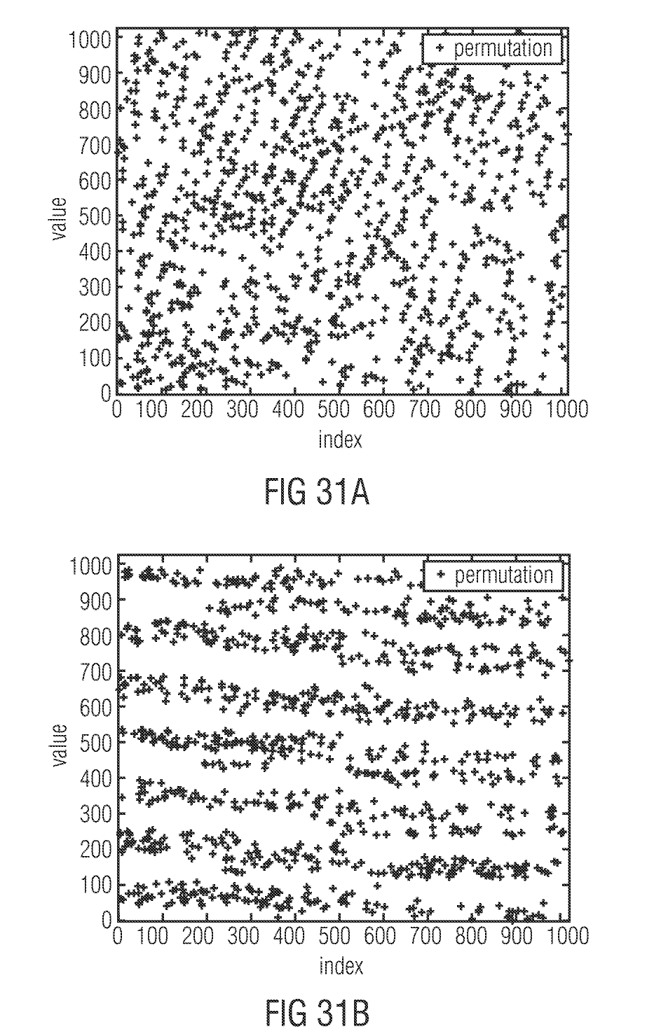

In FIGS. 29A-29H and 30A-30H, the increasing and/or decreasing triangular curve shape is noticeable at first. This curve shape is induced by the underlying inversion chart formation rule and those equations. Furthermore, it is noticeable that the Lehmer inversion charts, both in the noise-like piece of music (see FIGS. 29A-29H) and in the tonal piece of music (see FIGS. 30A-30H), are very uncorrelated. Whereas a clear difference can be seen in the inversion charts between the tonal piece of music and the noise-like piece of music. Considering the permutations belonging to the above inversion charts and Lehmer inversion charts, the permutation obtained by sorting the tonal piece of music is also substantially more correlated there than that of the noise-like piece of music (see FIGS. 31A, 31B). FIGS. 31A, 31B show an illustration of a permutation, obtained from sorting time values, of a noise-like piece in the 10^{th} block and a tonal piece.

The right permutation from FIG. 31 reminds one of an audio signal mirrored on the main axis. It seems as if there is a direct connection between the audio signal, the reverse-sorting rule, and even the inversion charts.

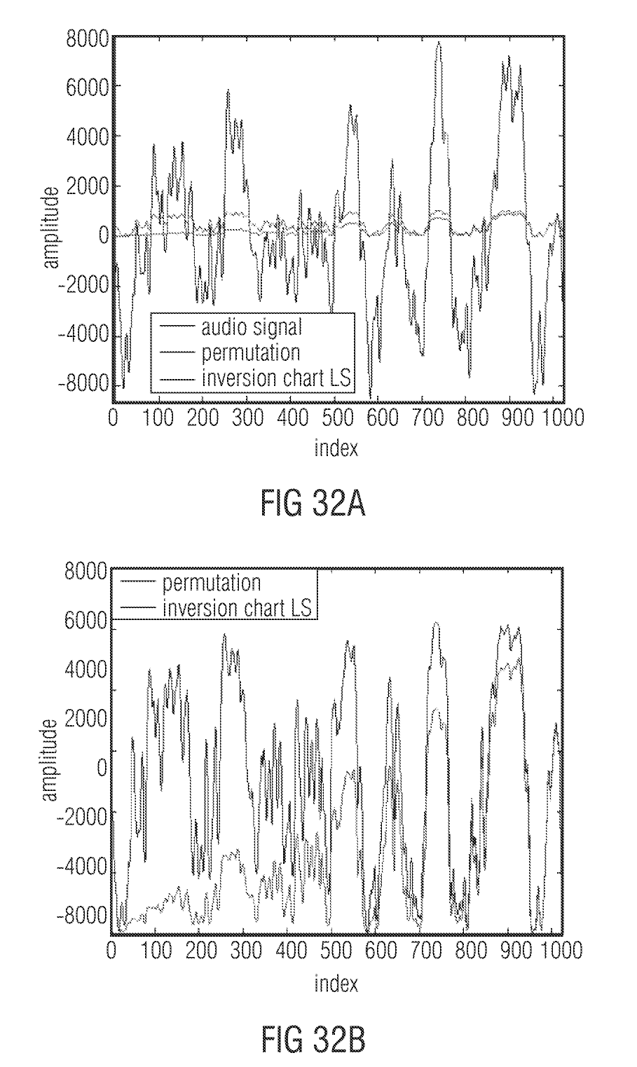

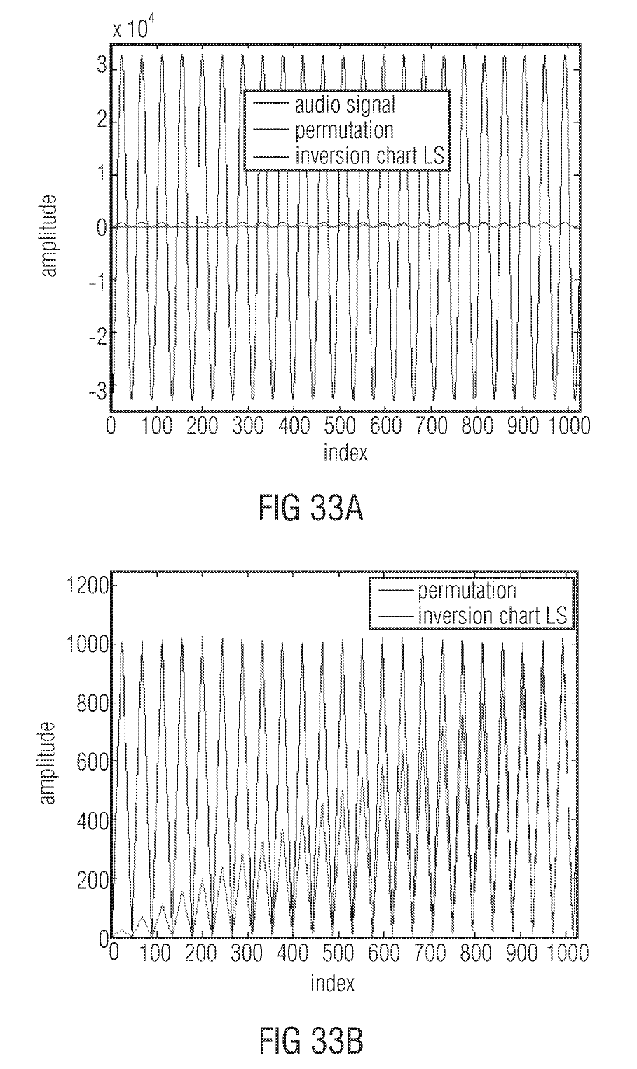

FIGS. 32A, 31B and 33A, 33B show the audio signal of a block, the corresponding permutation at which the x and y coordinate was exchanged, and the corresponding inversion chart LS. FIG. 32A shows part of an audio signal, the corresponding permutation and the inversion chart LS, and FIG. 32B shows the permutation and the inversion chart LS from FIG. 32A in an enlarged manner. FIG. 33A shows part of an audio signal, the corresponding permutation and the inversion chart LS, and FIG. 33B shows the permutation and the inversion chart LS from FIG. 33A in an enlarged form.

FIGS. 32A, 32B and 33A, 33B clearly show the connectedness of the original audio signal, permutation and inversion chart. I.e., if the amplitude of the original signal increases, the amplitude of the permutation and the inversion chart also rises, and vice versa. The amplitude ratios are also worth mentioning. The maximum and minimum amplitude of the permutation remains within a limited range from min(σ(i))=1 to max(σ(i))=|σ|. The inversion chart even has smaller amplitude values from min(σ(i))−1 to max(σ(i))−1, due to the above equations. In contrast thereto, an audio signal of 16 bits has a maximum amplitude range from

$$- \frac{{2}^{16}}{2} to \frac{{2}^{16}}{2} - 1.$$

The principle just observed shall now be set forth explicitly.

Principle of the correlation transfer: The correlation of the audio signal is usually mirrored in the xy-exchanged permutation and the inversion chart correspondingly belonging to the permutation. Because of the principle of the correlation transfer shown above, prediction of the inversion charts lends itself for further processing. The fixed predictor described is to be used for the prediction. In general, prediction of the Lehmer inversion charts does not provide a good result. In very rare exceptional cases, however, it occurs that the residual signal of the prediction of a Lehmer inversion chart sometimes needs fewer bits than the residual signal of the inversion charts. For this reason, all 8 inversion chart formation rules are used. This can be represented as a simplified MATLAB code like in permCoding( ).

```
permCoding(perm)
% generate inversion charts
      invLB = calcInvVecLB(perm);
      invLS = calcInvVecLS(perm);
      invRB = calcInvVecRB(perm);
      invRS = calcInvVecRS(perm);
% generate Lehmer inversion charts
      invLBL = calcInvVecLBLehmer(perm);
      invLSL = calcInvVecLSLehmer(perm);
      invRBL = calcInvVecRBLehmer(perm);
      invRSL = calcInvVecRSLehmer(perm);
% prediction of the inversion charts
      restsignalLB = fixed(invLB);
      restsignalLS = fixed(invLS);
      restsignalRB = fixed(invRB);
      restsignalRS = fixed(invRS);
% prediction of the Lehmer inversion charts
      restsignalLBL = fixed(invLBL);
      restsignalLSL = fixed(invLSL);
      restsignalRBL = fixed(invRBL);
      restsignalRSL = fixed(invRSL);
% determine bit requirement
      [bitsLB, bitsLS, bitsRB, bitsRS
      bitsLBL, bitsLSL, bitsRBL, bitsRSL] =
      getBitConsumption(restsignalLB,
                  restsignalLS,
                  restsignalRB,
                  restsignalRS,
                  restsignalLBL,
                  restsignalLSL,
                  restsignalRBL,
                  restsignalRSL);
% determine the most bit-saving variant
      [bestInvVecBits,bestInvVecVersion] =
      min([bitsLB, bitsLS, bitsRB, bitsRS,
                  bitsLBL, bitsLSL, bitsRBL, bitsRSL]);
end
```

From the above section, it is known that the inversion charts have one form resembling a triangle. In rare cases, it may happen that the prediction of the inversion charts and the Lehmer inversion chart is inefficient. So as to deal with this problem, the triangular shape of the inversion charts and Lehmer inversion charts may now be utilized to realize a relatively inexpensive binary coding in the worst case. The worst case occurs, for example, if noise-like or transient audio signals are to be encoded. After all, in these cases a prediction of the inversion charts and/or Lehmer inversion charts sometimes does not provide any good results. To this end, depending on the respective inversion chart formation rule, as many bits as needed, but as few as possible, are allocated for a conventional binary representation of the elements. The corresponding dynamic bit allocation functions are defined as follows.

Definition (dynamic bit allocation function LS, RS, LBL, LSL). Let εσSₙ., be a permutation, and bⱼ with j=1, 2, . . . , n be the elements of an inversion chart formation rule, then the dynamic bit allocation function LS, RS, LBL, LSL is defined as

$$d ( {b}_{j} ) = \{ \begin{matrix}1 & Bit for j = 1 \\ ⌊ {log}_{2} ( j - 1 ) ⌋ + 1 & Bit else .\end{matrix}$$

Definition (dynamic bit allocation function LB, RB, RBL, RSL). Let σεSₙ be a permutation, and bⱼ with j=1, 2, . . . , n be the elements of an inversion chart formation rule, then the dynamic bit allocation function LB, RB, RBL, RSL is defined as

$$d ( {b}_{j} ) = \{ \begin{matrix}1 & Bit for j = n \\ ⌊ {log}_{2} ( n - j ) ⌋ + 1 & Bit else .\end{matrix}$$

The following table shows the performance of this coding approach.

| \|σ\| | dynamic bit allocation | static bit allocation |
|---|---|---|
| 32 | 4.063 Bit | 5 Bit |
| 64 | 5.031 Bit | 6 Bit |
| 128 | 6.016 Bit | 7 Bit |
| 256 | 7.008 Bit | 8 Bit |
| 512 | 8.004 Bit | 9 Bit |
| 1024 | 9.002 Bit | 10 Bit |
| 2048 | 10.001 Bit | 11 Bit |

By way of dynamic bit allocation realized via the inversion charts and/or Lehmer inversion charts, roughly 1 bit can be saved per element as opposed to conventional binary coding of the permutation. This coding approach thus represents a simple and profitable procedure for the worst case.

In this section, it is to be examined how entropy coding is to be designed for the residual signals of the decorrelation methods just described, in order to achieve maximum compression possible. In ROBINSON, Tony: SHORTEN: Simple lossless and nearlossless waveform compression. Technical report CUED/FINFENG/TR.156, Cambridge University Engineering Department, December 1994, REZNIK, Y.: Coding of Prediction Residual in MPEG-4 Standard for Lossless Audio Coding (MPEG-4 ALS). IEEE Proc., ICASSP, 2004 and LIEBCHEN, Tilman; REZNIK, Yuriy; MORIYA, Takehiro; YANG, Dai Tracy: MPEG-4 Audio Lossless Coding. Berlin, Germany: 116th AES Convention, May 2004, it has been shown that the residual signal of a prediction of time values approximately has a Laplace distribution. This also applies for the residual signal of a prediction of the non-Lehmer inversion charts. The principle of the correlation transfer described in the above section is the reason for this.

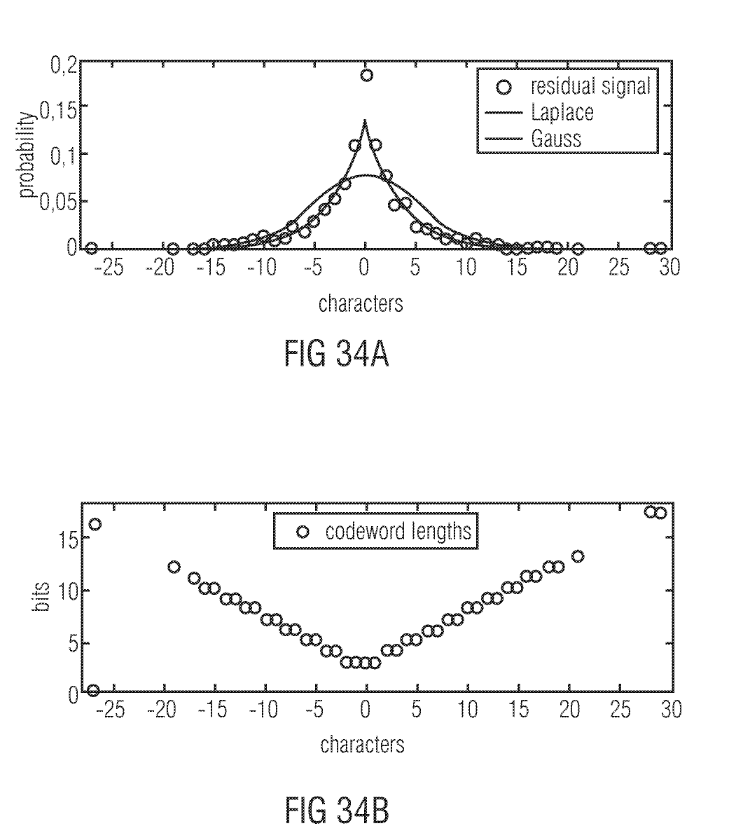

FIG. 34A shows a probability distribution and FIG. 34B a length of the code words of a residual signal of an inversion chart LB, obtained by prediction (fixed predictor). FIG. 34A shows the probability distribution of the residual signal of a non-Lehmer inversion chart LB, obtained by applying a fixed predictor. For the determination of the code word lengths of the residual signal, a forward-adaptive Rice coding with a parameter of k=2 is the basis. It can be seen clearly that the probability distribution of the residual signal approximately corresponds to a Laplace distribution. In the case of a Laplace distribution, Golomb and/or Rice coding is optimally suited as an entropy coding method (see GOLOMB, S. W.: Run-length encodings. IEEE Transactions on Information Theory, IT-12(3), pp. 399-401, July 1966, GALLAGER, Robert G.; VAN VOORHIS, David C.: Optimal Source Codes for Geometrically Distributed Integer Alphabets. IEEE Transactions on Information Theory, March 1975 and SALOMON, David: Data Compression. London: Springer-Verlag, Fourth Edition, 2007, SALOMON, David: Data Compression. London Springer-Verlag, Fourth Edition, 2007).

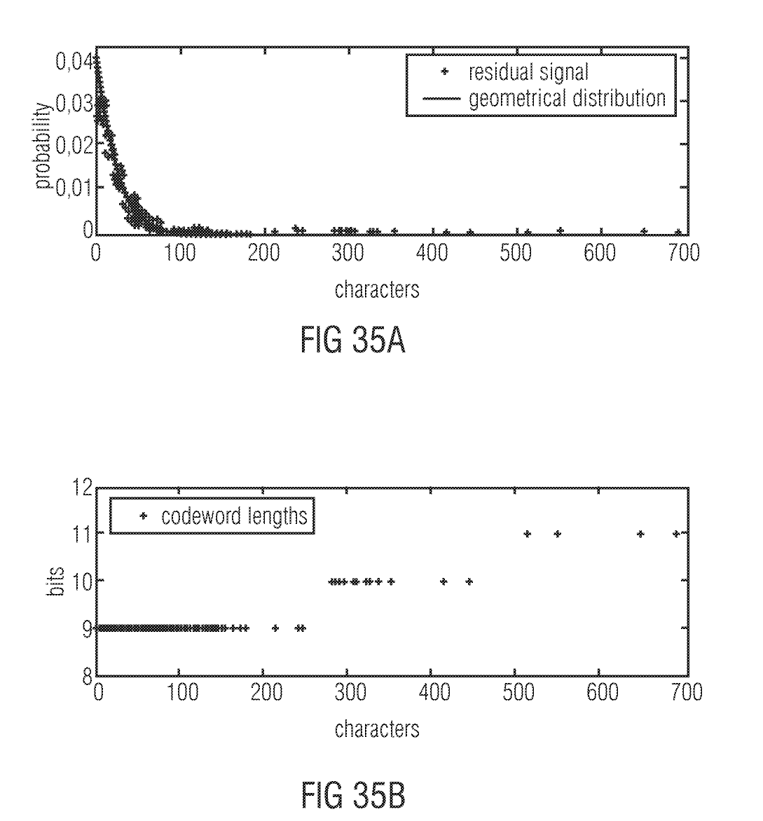

Finally, the probability distribution of the residual signal of the differential coding of the sorted time values remains to be considered. FIG. 35A shows a probability distribution and FIG. 35B a length of code words of a residual signal obtained by differential coding of sorted time values. It can be seen clearly in FIG. 35A that the residual signal has an approximately geometrical probability distribution. In this case, Golomb and/or Rice coding is also very well suited as an entropy coding method. In FIG. 35B, forward-adaptive Rice coding with a parameter of k=8 was used for representing the code word lengths.

In addition to the specific probability distributions, the residual signals have the property that the value ranges partially vary significantly from block to block and many values of the value range do not even occur. In FIG. 34, this is the case e.g. between −25, . . . , −20. In FIG. 35, this can also be seen for values>350. Tabular storage of the codes or their transmission as side information, as this would be the case e.g. in Huffman coding, is therefore unsuited. Since each Rice or Golomb code is uniquely described by the parameter k or m, only k or m is to be transmitted as side information if there is to be discrimination between different Rice or Golomb codes. Based on the knowledge that Rice or Golomb coding is excellently suited for the residual signals present in SOLO, various variants of Rice or Golomb coding shall now be developed.

The determination of the Rice parameter k or the Golomb parameter m is essential here. If the parameter is chosen too large, this increases the number of bits needed for the small numbers. If the parameter is chosen too small, the number of bits needed for the unarily encoded part increases sharply, especially with high values to be encoded. A incorrectly chosen parameter thus may significantly increase the data rate of the entropy code and therefore downgrade the compression. There are two possibilities of designing Rice or Golomb coding:

1. forward-adpative Rice/Golomb coding
2. backward-adpative Rice/Golomb coding

Some methods of forward-adaptively computing the Rice parameter k have already been shown. Further facts of the forward-adaptive Rice parameter determination shall now be explained. If there is a residual signal e(i)εZ for i=1, 1, . . . , n, then at first a mapping M(e(i)) of Z to N₀ is performed. If the residual signal already lies completely within N₀, as this also is the case with the residual signal of the differential coding of the sorted time values, then this mapping is omitted. The mapping Z to N₀ is assumed for e(i) E Z in the following. Hence, the following equation

$$μ = \{ \begin{matrix}\frac{1}{n} {\sum }_{i = 1}^{n} M ( e ( i ) ) & for & e ( i ) ∈ Z \\ \frac{1}{n} {\sum }_{i = 1}^{n} e ( i ) & for & e ( i ) ∈ {N}_{0} .\end{matrix}$$

is obtained with two different formation rules for the arithmetic mean value.

The simplest way of determining the Rice parameter is to test all Rice parameters in question and select the parameter with the least bit consumption. This is not very complex, because the value range of the Rice parameters to be tested is limited by the bit resolution of the time signal. At a resolution of 16 bits, a maximum of 16 Rice parameters are to be verified. The corresponding bit requirement per parameter may in the end be determined on the basis of few bit operations or arithmetic operations. This procedure of finding the optimum Rice parameter is slightly more intensive than the direct computation of the parameter, but guarantees obtaining the optimum Rice parameter. In the method of lossless audio coding presented here, this method for determining the Rice parameter is used in most cases. In a direct determination of the Rice parameter, the parameter limit values deduced in KIELY, A.: Selecting the Golomb Parameter in Rice Coding. IPN Progress Report, Vol. 42-159, November 2004, can be utilized.

$${k}_{min} ( μ ) = max \{ 0 , ⌊ {log}_{2} ( \frac{2}{3} ( μ + 1 ) ) ⌋ \}$$

$${k}_{max} ( μ ) = max \{ 0 , ⌊ {log}_{2} ( μ ) ⌋ \}$$

Thereby, the range of the optimum Rice parameter k is limited to

kₘₐₓ(μ)−kₘᵢₙ(μ)≦2 ∀μ,

and a maximum of 3 different Rice parameters have to be tested so as to be able to determine the optimum parameter. If there is a geometrical probability distribution, the optimum Rice parameter is obtained by way of the following equation

$${k}_{geo} = max \{ 0 , 1 + ⌊ {log}_{2} ( \frac{ln ( φ - 1 )}{ln ( \frac{μ}{μ + 1} )} ) ⌋ \} ,$$

wherein ø=(\sqrt{5}+1)/2, see KIELY, A.: Selecting the Golomb Parameter in Rice Coding. IPN Progress Report, Vol. 42-159, November 2004, p. 6.

In forward-adaptive Golomb coding, parameter determination on the basis of a search method, as it was indeed acceptable in Rice coding, is substantially more complex. This is due to the fact that the Golomb coding has many more intermediate gradations of the parameter m. For this reason, the Golomb parameter is computed as follows

$$m = max \{ 1 , NINT ( - \frac{ln ( 1 + θ )}{ln ( θ )} ) \} ,$$

cf. Reznik, Y.: Coding of Prediction Residual in MPEG-4 Standard for Lossless Audio Coding (MPEG-4 ALS). IEEE Proc., ICASSP, 2004. Here, θ is computed by way of

$$θ = \frac{{\sum }_{i = 1}^{n} e ( i )}{n + {\sum }_{i = 1}^{n} e ( i )} .$$

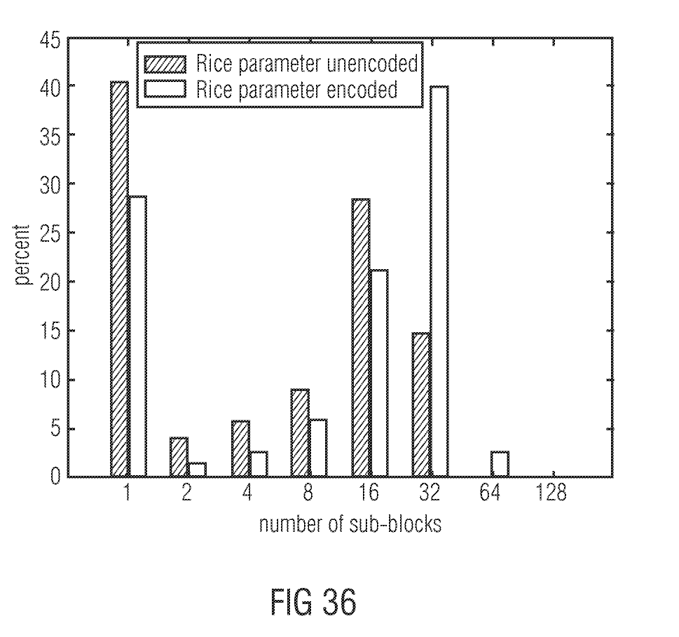

In forward-adaptive Rice/Golomb coding, it is possible to decompose a data block to be encoded into several sub-blocks and determine and transmit a parameter of its own for each sub-block. With an increasing number of sub-blocks, the side information needed for the parameters increases. The effectiveness of the sub-block decomposition strongly depends on how the parameters to be transmitted are encoded themselves. Since the parameters of successive blocks mostly do not vary particularly strongly, differential coding of the parameters with ensuing forward-adaptive Rice coding is the obvious thing. When now summing up the data rate of the entropy-coded data blocks, including the accompanying parameter side information, across the entire block and counting how often which sub-block decomposition needed the least amount of data, FIG. 36 is obtained for the entire coding process of a piece No. 1. FIG. 36 shows a percentage proportion of a sub-block decomposition with the least amount of data of a forward-adaptive Rice coding versus a residual signal of a fixed predictor of a piece including side information for parameters, with the overall block length amounting to 1024 time values.

| | number of sub-blocks | | | | | | | |
|---|---|---|---|---|---|---|---|---|
| | 128 | 64 | 32 | 16 | 8 | 4 | 2 | 1 |
| uncoded | 488 | 243 | 121 | 60 | 30 | 15 | 8 | 4 |
| parameters | | | | | | | | |
| coded | 304 | 153 | 80 | 44 | 25 | 16 | 10 | 6 |
| parameters | | | | | | | | |
| sum of the | 9748 | 9796 | 9833 | 9872 | 9911 | 9926 | 9938 | 9952 |
| sub-block | | | | | | | | |
| data rates | | | | | | | | |

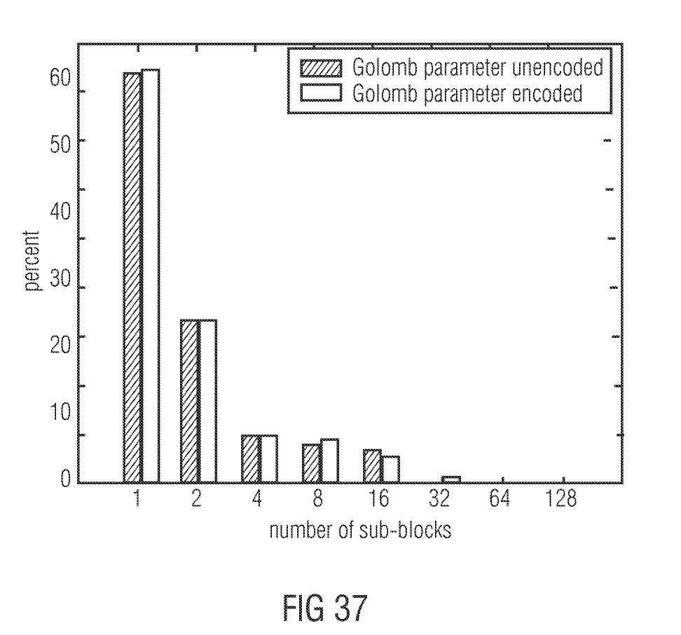

With uncoded Rice parameters, sub-block decomposition is mostly not particularly profitable. If the Rice parameters are encoded, decomposition to 32 sub-blocks often is better than no sub-block decomposition (cf. also the following table). In forward-adaptive Golomb coding, sub-block decomposition mostly is not advantageous either for uncoded Golomb parameters or for coded Golomb parameters (see FIG. 37 and the following table). FIG. 37 shows a percentage proportion of a sub-block decomposition with the least amount of data of a forward-adaptive Golomb coding across the residual signal of a fixed predictor of a piece, including side information for parameters, with the overall block length being 1024 time values. Yet, there would be the possibility of still quantizing Golomb parameters prior to encoding same, in order to thereby reduce their data rate. Since the Rice parameters basically already represent quantized Golomb parameters, this shall not be considered further here.

| | number of sub-blocks | | | | | | | |
|---|---|---|---|---|---|---|---|---|
| | 128 | 64 | 32 | 16 | 8 | 4 | 2 | 1 |
| uncoded | 1242 | 603 | 293 | 142 | 69 | 34 | 17 | 9 |
| parameters | | | | | | | | |
| coded | 1123 | 552 | 278 | 139 | 68 | 36 | 19 | 11 |
| parameters | | | | | | | | |
| sum of the | 9752 | 9794 | 9827 | 9863 | 9899 | 9913 | 9924 | 9938 |
| sub-block data | | | | | | | | |
| rates | | | | | | | | |

From FIGS. 36 and 37, it can be seen that there is no optimum sub-block decomposition for all cases. Hence, two possibilities are obtained:
1. Testing all sub-block decompositions in question, and choosing the one with the smallest data rate.
2. Using sub-block decomposition that is well suited on average for all cases.

Since the 1^{st} possibility strongly increases the complexity of the system at marginally better compression, no sub-block decomposition will be used in the following. FwAdaptCoding( ) shows how forward-adaptive Rice and/or Golomb coding is realized in practice. At the beginning, a mapping to N0 takes place for a signed residual signal. With this, then the Rice/Golomb parameter is determined, and finally all characters are encoded with this parameter. An example code follows.

```
FwAdaptCoding(data, signedData)
      if (signedData)
% mapping to natural numbers including zero
            udata = Fold(data);
      else
            udata = data;
      end
% determining parameters
      parameter = DetermineParameter(udata);
% running across all data to be coded
      for i=1:length(udata)
% encoding a value
            code(i) = EncodeValue(udata(i), parameter);
      end
end
```

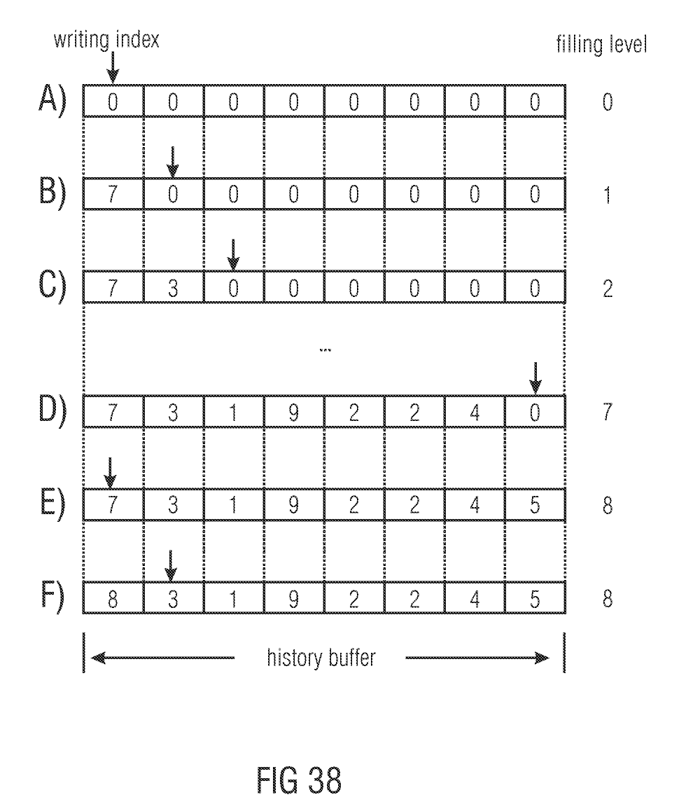

Backward-adaptive Rice/Golomb coding calculates the parameter from previous characters already encoded. To this end, the characters just encoded are cyclically entered into a history buffer. There are two variables for the history buffer. One holds the current filling level of the history buffer, and the other variable stores the next writing position. In FIG. 38, the basic functioning of the history buffer of the size 8 is illustrated.

At the beginning, the history buffer is initialized with zero, the filling level is zero, and the writing index is one (see a)). Then, one character after the other is entered into the history buffer and the writing index (arrows) and the filling level are updated (see b)-e)). Once the history buffer is completely filled, the filling level remains constant (here 8) and only the writing index is adapted (see e)-f)). The computation of the backward-adaptive Rice parameter is done as follows. Let e(i)εN₀ with i=1, 2, . . . , W be the residual signal values contained in the history buffer, W the size of the history buffer and F the current filling level, then the backward-adaptive Rice parameter is calculated by way of equation

$$k = max \{ 1 , NINT ( \frac{{\sum }_{101}^{w} 1 ( e ( i ) ) + ⌊ \frac{F}{2} ⌋}{F} ) \} ,$$

wherein the function l(e(i)) determines the number of bits needed for e(i), i.e.

$$l ( e ( i ) ) = \{ \begin{matrix}1 & if e ( i ) = 0 \\ ⌊ {log}_{2} ( e ( i ) ) ⌋ + 1 & else .\end{matrix}$$

The computation of the backward-adaptive Golomb parameter is done by way of equation

$$m = max \{ 1 , NINT ( ln ( 2 ) \cdot \frac{{\sum }_{i = 1}^{W} e ( i )}{F} \cdot C ) \} .$$

Empiric experiments have shown that C=1.15 makes sense. For the size of the history buffer, a size of W=16 will be used in the following, both for backward-adaptive Rice coding and for backward-adaptive Golomb coding. This represents a good compromise between an adaptation that is too slow and an adaptation reacting too abruptly. Like in the backward-adaptive arithmetic coding, the adaptation used in the decoding must be synchronized for encoding, or else perfect reconstruction of the data is not possible. In some cases, the history buffer, which is not yet completely filled at the beginning, does not provide for good prediction of the parameter in the reverse adaptation. For this reason, use is made of a variant that calculates a forward-adaptive parameter for the first W values, and only when the history buffer is filled completely, are adaptive parameters calculated therefrom.

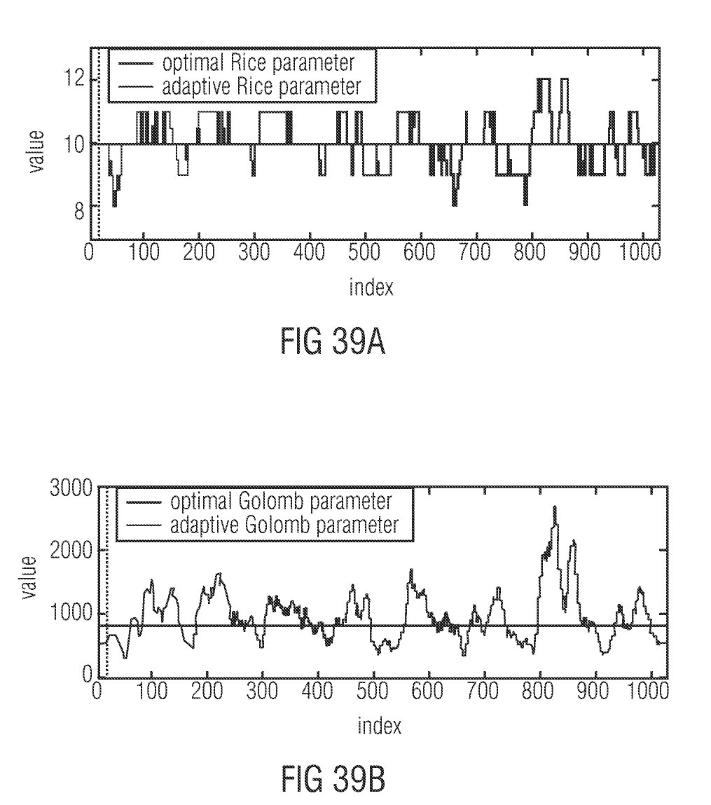

FIGS. 39A, 39B show in detail how the adaptive parameter determination works. FIGS. 39A, 39B show an illustration of the functioning of an adaptation as compared with one optimal parameter for the entire block. Here, the lighter-colored lines represent the border area from which on the adaptive parameters are used. In a simplified manner, this procedure just described can be represented as in BwAdaptivCoding( ). In the case of e(i)εZ, at first there is again a mapping to N₀. Then a forward-adaptive parameter, with which the first W values are encoded, is determined via the first W values (size of the history buffer). If the history buffer is completely filled, the adaptive parameters are used for the further coding. An example code follows.

```
FwAdaptCoding(data, signedData)
      if (signedData)
% mapping to natural numbers including zero
            udata = Fold(data);
      else
            udata = data;
      end
% determining parameters
      parameter = DetermineParameter(udata);
% running across all data to be coded
      for i=1:length(udata)
% encoding a value
            code(i) = EncodeValue(udata(i), parameter);
      end
end
```

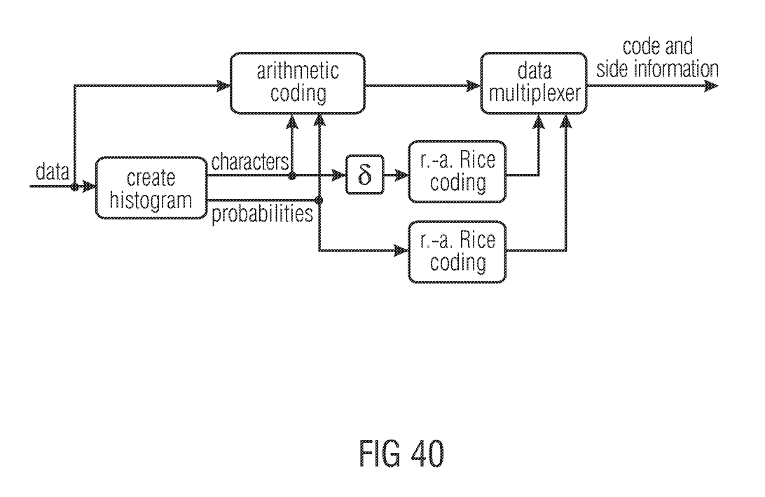

So as to be able to more fully assess the performance of the Rice/Golomb entropy coding methods just developed, a forward-adaptive arithmetic coding shall be developed additionally, utilizing backward-adaptive Rice coding. To this end, at first a histogram of the data to be encoded is established. With this histogram, it is possible to generate a code close to the entropy boundary by way of the arithmetic coding. Yet, the characters included and their occurrence probabilities must be transmitted additionally. Since the characters in the histogram are arranged in a strictly monotonously increasing manner, differential coding δ will suggest itself here prior to backward-adaptive Rice coding. The probabilities only are Rice-coded backward-adaptively. Finally, the overall costs of this procedure result from the sum of the code of the arithmetic coding, the Rice-coded characters and the Rice-coded probabilities (see FIG. 40). FIG. 40 shows an embodiment of forward-adaptive arithmetic coding, utilizing backward-adaptive Rice coding.

Now, the five different entropy-coding methods shall be compared with each other. To this end, tables of all methods of residual signal generation existing in the overall system are established, and the amount of data will be indicated in bytes averaged per block across the entire respective piece. The following table shows a comparison of different entropy coding methods applied to the residual signal of the LPC predictor.

| | summed | f.-a. Rice | b.-a. Rice | f.-a. Golomb | b.-a. Golomb | f.-a. arith. |
|---|---|---|---|---|---|---|
| piece no. | entropy | coding | coding | coding | coding | coding |
| 1 | 1117 | 1242 | 1252 | 1241 | 1239 | 1599 |
| 2 | 1249 | 1980 | 1998 | 1981 | 1984 | 2548 |
| 4 | 910 | 988 | 974 | 985 | 960 | 1201 |
| 13 | 1026 | 1096 | 1111 | 1095 | 1098 | 1350 |
| 14 | 1111 | 1278 | 1291 | 1276 | 1279 | 1668 |

The following table shows a comparison of different entropy coding methods applied to the residual signal of the fixed predictor.

| | summed | f.-a. Rice | b.-a. Rice | f.-a. Golomb | b.-a. Golomb | f.-a. arith. |
|---|---|---|---|---|---|---|
| piece no. | entropy | coding | coding | coding | coding | coding |
| 1 | 1100 | 1243 | 1246 | 1241 | 1233 | 1599 |
| 2 | 1249 | 1982 | 1999 | 1983 | 1986 | 2543 |
| 4 | 908 | 1001 | 978 | 995 | 964 | 1218 |
| 13 | 989 | 1050 | 1064 | 1049 | 1052 | 1276 |
| 14 | 1140 | 1370 | 1381 | 1367 | 1370 | 1797 |

The following table shows a comparison of different entropy coding methods applied to the residual signal of a non-Lehmer inversion chart LB decorrelated with the fixed predictor.

| | summed | f.-a. Rice | b.-a. Rice | f.-a. Golomb | b.-a. Golomb | f.-a. arith. |
|---|---|---|---|---|---|---|
| piece no. | entropy | coding | coding | coding | coding | coding |
| 1 | 674 | 705 | 677 | 698 | 665 | 780 |
| 2 | 1114 | 1241 | 1203 | 1237 | 1189 | 1603 |
| 4 | 683 | 767 | 764 | 755 | 721 | 833 |
| 13 | 659 | 687 | 670 | 680 | 656 | 754 |
| 14 | 856 | 922 | 907 | 914 | 883 | 1058 |

The following table shows a comparison of different entropy coding methods applied to the residual signal of the differential coding of the sorted time values.

| | summed | f.-a. Rice | b.-a. Rice | f.-a. Golomb | b.-a. Golomb | f.-a. arith. |
|---|---|---|---|---|---|---|
| piece no. | entropy | coding | coding | coding | coding | coding |
| 1 | 711 | 756 | 730 | 750 | 721 | 819 |
| 2 | 868 | 949 | 914 | 937 | 905 | 1051 |
| 4 | 471 | 547 | 487 | 528 | 476 | 540 |
| 13 | 610 | 660 | 624 | 653 | 615 | 694 |
| 14 | 605 | 678 | 622 | 665 | 613 | 697 |

If one forms the rounded-up arithmetic mean values from the above tables, the following table is obtained

| | |
|---|---|
| summed entropy | 903 |
| b.-a. Golomb coding | 1031 |
| b.-a. Rice coding | 1045 |
| f.-a. Golomb coding | 1052 |
| f.-a. Rice coding | 1058 |
| f.-a. arithmetic coding | 1282 |

For the final analysis of the above table, it is also to be taken into consideration that the Golomb parameter needs a slightly higher side information data rate than the Rice parameter. Nevertheless, the backward-adaptive Golomb coding on average represents the best entropy coding method for the residual signals present in SOLO. In very rare cases, it may happen that the adaptation strategy fails and does not provide any good results. For this reason, a combination of backward-adaptive Golomb coding and forward-adaptive Rice coding ultimately is employed in SOLO.

So as to define a suitable block size for an audio coding method, the following facts are to be borne in mind:
If the block length is chosen too small, relatively much data for the side information is needed in relation to the mere coding data
If the block length is chosen too large, both the encoder and the decoder need large data structures so as to keep the data to be processed in the memory. In addition, at greater block length, the first decoded data also is available only later than in the case of smaller block lengths.

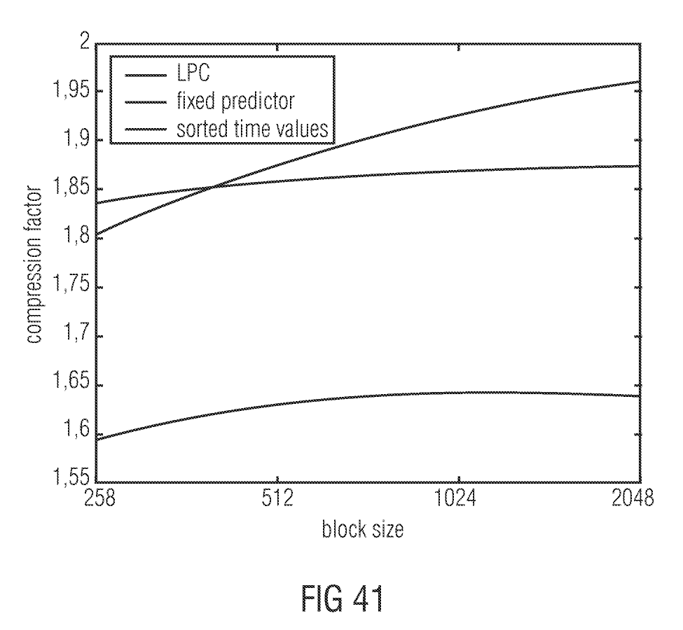

Substantially, the block length is thus determined by the requirements made with respect to the coding method. If the compression factor is in the foreground, a very large block length may be acceptable. Yet, if a coding method with little delay time or little memory consumption is demanded, very large block length is certainly not useful. Already existing audio coding methods usually utilize block lengths of 128 to 4608 samples. At a sampling rate of 44.1 kHz, this corresponds to 3 to 104 milliseconds. An examination is to explain how the different decorrelation methods used by SOLO behave at different block lengths. To this end, various pieces are encoded at block lengths of 256, 512, 1024 and 2048 samples, and the compression factor F is determined with the inclusion of the respective side information. The arithmetic mean value is then formed of the seven compression factors of a block length. FIG. 41 illustrates the result of this examination.

FIG. 41 shows an illustration of the influence of the block size on the compression factor F. It can be seen clearly that the predictors achieve a better compression factor with increasing block length, wherein, in the fixed predictor, this is not pronounced as strongly as in the LPC coding method. The decorrelation method, which works in accordance with the sorting model, has an optimum at a block length of 1024 samples. Since a high compression factor at minimum block length is desirable, a block length of 1024 samples is used in the following. However, SOLO may optionally be operated at a block length of 256, 512 or 2048 samples.

It has been shown in the above section that lossless stereo redundancy reduction can be realized. It is a difficulty here that the mid channel M has been obtained by division by 2 with ensuing rounding to the next integer value with respect to zero. Thereby, information has been lost in some cases. This is the case, e.g., at L=5, R=4. In this example, it is assumed that only one value is present in each channel. In reality, the left channel L or the right channel R are vectors, of course.

Here, we obtain

$$M = NINT ( \frac{L + R}{2} ) = NINT ( \frac{5 + 4}{2} ) = NINT ( 4 , 5 ) = 4.$$

However, this information is still included in the side channel S=L−R=5−4=1. Lossy rounding of M has taken place whenever S is odd-numbered. This is to be taken into consideration in the decoding correspondingly. This possibility of the correction of the mid channel just described may, however, also be avoided if M is generated from R and S

$$S = L - R$$

$$M = NINT ( \frac{S}{2} ) + R .$$

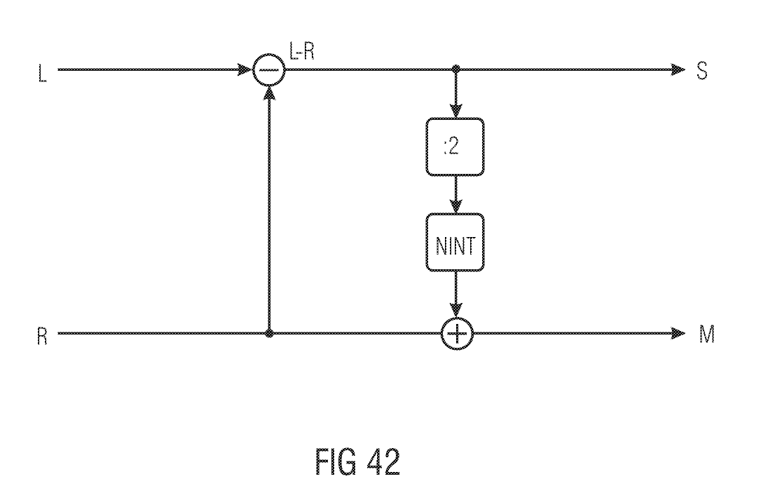

Graphically, the equation can be represented like in FIG. 42. FIG. 42 shows an illustration on the lossless MS encoding. The MS decoding inverts the computation rule of the MS encoding and generates the right channel R and the left channel L again from M and S

$$R = M - NINT ( \frac{S}{2} ) . \\ L = S + R$$

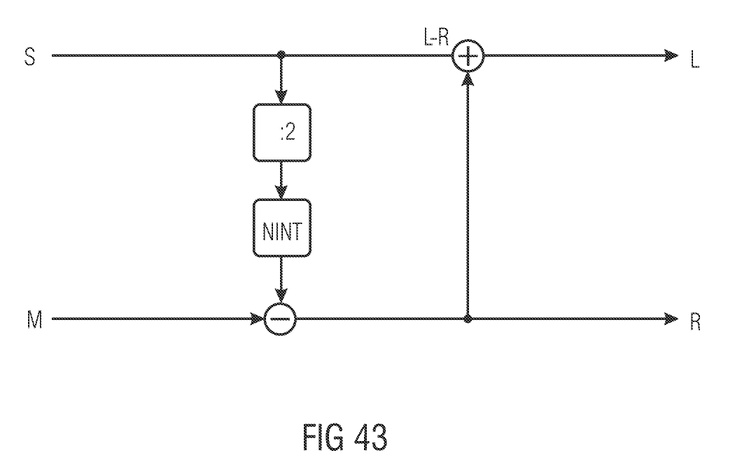

A graphical illustration of the equation is shown in FIG. 43. FIG. 43 shows a further illustration on the lossless MS encoding.

Apart from MS coding, also LS and RS coding is to be used within SOLO for stereo redundancy reduction. Hence, there are a total of four variants for the coding of stereo signals:

1. LR coding: no stereo redundancy reduction
2. LS coding: left channel and side channel
3. RS coding: right channel and side channel
4. MS coding: mid channel and side channel

How is one to decide which coding is best? One possibility would be to develop a criterion selecting the variant with the least amount of data before one performs the decorrelation and entropy coding of the respective channel. This possibility needs much less memory and is only half as computationally complex as the procedure described in the following. However, the quality here mainly depends on the decision criterion. The entropy (equation 2.3) could be used for this. Experimentation has shown, however, that the entropy does not represent a reliable decision criterion for this.

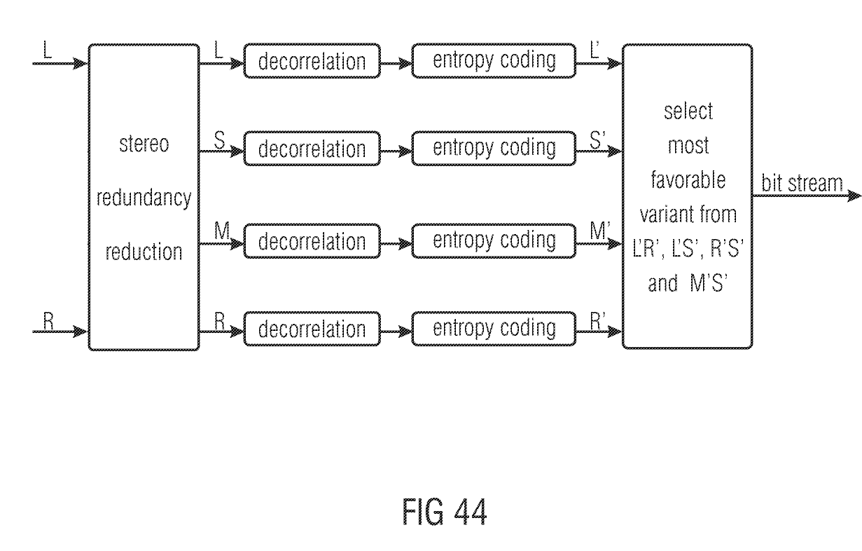

Another possibility would be to process L, R, M and S completely, and to decide which variant is to be used, depending on the bit consumption. Here, more memory and computation time are needed, but it is possible to select the most favorable variant. In the following, only the second possibility is utilized (see FIG. 44). FIG. 44 shows an illustration on the selection of the best variant for stereo redundancy reduction.

Experimentation is now to show how this procedure performs with stereo signals. In the following table, the averaged entropy over the entire piece of the different variants is shown in comparison. A block length of 1024 time values per channel was used throughout. In the last column (best variant) the averaged entropy of the procedure according to FIG. 44 is illustrated.

| piece | | | | | | | | | best |
|---|---|---|---|---|---|---|---|---|---|
| no. | L | R | S | M | LR | LS | RS | MS | variant |
| 16 | 9.64 | 9.64 | 0 | 9.64 | 19.28 | 9.64 | 9.64 | 9.64 | 9.64 |
| (L = | | | | | | | | | |
| R) | | | | | | | | | |
| 17 | 9.64 | 9.62 | 9.55 | 9.63 | 19.26 | 19.19 | 19.17 | 19.18 | 19.16 |
| 18 | 8.74 | 8.77 | 7.62 | 8.74 | 17.51 | 16.36 | 16.39 | 16.36 | 16.34 |
| 19 | 7.79 | 7.84 | 4.32 | 7.83 | 15.63 | 12.11 | 12.16 | 12.15 | 12.10 |
| 20 | 8.29 | 8.30 | 5.07 | 8.30 | 16.59 | 13.36 | 13.37 | 13.37 | 13.35 |
| 27 | 9.18 | 9.18 | 9.23 | 9.11 | 18.36 | 18.41 | 18.41 | 18.34 | 18.32 |
| 28 | 9.36 | 9.38 | 9.41 | 9.33 | 18.74 | 18.77 | 18.79 | 18.74 | 18.72 |
| 29 | 9.12 | 9.10 | 9.15 | 9.07 | 18.22 | 18.27 | 18.25 | 18.22 | 18.20 |

The procedure according to FIG. 44 is most profitable in stereo signals with identical channels. In the case of strongly mono-like voice pieces, the stereo redundancy reduction presented is very useful, whereas only very little coding gain is achieved in normal pieces of music like 17, 27, 28 and 29 between the LR coding and the selection of the best variant.

Specifically, it is pointed out that, depending on the conditions, the inventive concept may also be implemented in software. The implementation may take place on a digital storage medium, particularly a floppy disc or a CD with electronically readable control signals capable of cooperating with a programmable computer system and/or microcontroller so that the corresponding method is executed. In general, the invention thus also consists in a computer program product with a program code stored on a machine-readable carrier for performing the inventive method, when the computer program product is executed on a computer and/or microcontroller. In other words, the invention may thus be realized as a computer program with program code for performing the method, when the computer program is executed on a computer and/or microcontroller.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

1-70. (canceled)

71. An apparatus for encoding a sequence of samples of an information signal, with each sample within the sequence comprising an original position, comprising:
a sorter for sorting the samples depending on their sizes, in order to acquire a sorted sequence of samples, with each sample comprising a sorting position within the sorted sequence;
an adjuster for adjusting functional coefficients of a functional rule for adaptation of the functional rule to a partial range of the sorted sequence; and
an encoder for encoding the functional coefficients, the samples outside the partial range and information on a relation between the original and sorting positions of the samples.

72. The apparatus according to claim 71, further comprising a preprocessor formed to perform filtering, time/frequency transform, prediction or multi-channel redundancy reduction for generating the sequence of samples.

73. The apparatus according to claim 71, wherein the information signal includes an audio signal.

74. The apparatus according to claim 71, wherein the encoder is formed to encode the information on the relation between the original and sorting positions as an index permutation or as an inversion chart.

75. The apparatus according to claim 71, wherein the encoder is formed to encode the sorted samples, the information on the relation between the original and sorting positions with differential and ensuing entropy coding or only entropy coding.

76. The apparatus according to claim 71, wherein the encoder is formed to determine and encode coefficients of a prediction filter on the basis of the samples, a permutation or an inversion chart.

77. The apparatus according to claim 76, wherein the encoder is further formed to encode a residual signal corresponding to a difference between the samples and an output signal of a prediction filter.

78. A method of encoding a sequence of samples of an information signal, with each sample within the sequence comprising an original position, comprising:
sorting the samples depending on their sizes, in order to acquire a sorted sequence of samples, with each sample comprising a sorting position within the sorted sequence;
adjusting functional coefficients of a functional rule for adaptation of the functional rule to a partial range of the sorted sequence; and
encoding the functional coefficients, the samples outside the partial range and information on a relation between the original and sorting positions of the samples.

79. An apparatus for decoding a sequence of samples of an information signal, with each sample within the sequence comprising an original position, comprising:
a receiver for receiving encoded functional coefficients, sorted samples and information on a relation between a sorting position and the original position of samples;
a decoder for decoding samples;
an approximator for approximating samples on the basis of functional coefficients in a partial range of the sequence; and
a re-sorter for re-sorting the samples and the partial range on the basis of the information on the relation between the original and sorting positions, so that each sample comprises its original position.

80. The apparatus according to claim 79, wherein the information signal includes an audio signal.

81. The apparatus according to claim 79, wherein the receiver is formed to receive the information on the relation between the original and sorting positions as an index permutation or as an inversion chart.

82. The apparatus according to claim 79, wherein the decoder is further formed to decode the functional coefficients, the sorted samples or the information on the relation between the original and sorting positions with entropy and ensuing differential decoding or only entropy decoding.

83. The apparatus according to claim 79, wherein the receiver is formed to receive encoded coefficients of a prediction filter, and the decoder is formed to decode the encoded coefficients, wherein the apparatus further comprises a predictor for predicting samples on the basis of the coefficients.

84. The apparatus according to claim 79, wherein the receiver is formed to receive a residual signal which corresponds to a difference between the samples and an output signal of the prediction filter or the approximator, and the decoder is formed to adapt the samples on the basis of the residual signal.

85. A method of decoding a sequence of samples of an information signal, with each sample within the sequence comprising an original position, comprising:
receiving encoded functional coefficients, sorted samples and information on a relation between a sorting position and the original position of samples;
decoding samples;
approximating samples on the basis of the functional coefficients in a partial range of the sequence; and
re-sorting the samples and the partial range on the basis of the information on the relation between the original and sorting positions, so that each sample comprises its original position.

86. An apparatus for encoding a sequence of samples of an information signal, with each sample within the sequence comprising an original position, comprising:
a sorter for sorting the samples depending on their sizes, in order to acquire a sorted sequence of samples, with each sample comprising a sorting position within the sorted sequence;
a generator for generating a series of numbers depending on a relation between the original and sorting positions of the samples, and for determining coefficients of a prediction filter on the basis of the series of numbers; and
an encoder for encoding the sorted samples and the coefficients.

87. The apparatus according to claim 86, further comprising a preprocessor formed to perform filtering, time/frequency transform, prediction or multi-channel redundancy reduction for generating the sequence of samples.

88. The apparatus according to claim 86, wherein the information signal comprises an audio signal.

89. The apparatus according to claim 86, wherein the generator for generating the series of numbers is formed to generate an index permutation or an inversion chart.

90. The apparatus according to claim 86, wherein the generator for generating the series of numbers is formed to further generate a residual signal corresponding to a difference between the series of numbers and a prediction series predicted on the basis of the coefficients.

91. The apparatus according to claim 86, wherein the encoder is formed to encode the sorted samples or the coefficients in accordance with differential or entropy coding.

92. The apparatus according to claim 90, wherein the encoder is further formed to encode the residual signal.

93. A method of encoding a sequence of samples of an information signal, with each sample within the sequence comprising an original position, comprising:
sorting the samples depending on their sizes, in order to acquire a sorted sequence of samples, with each sample comprising a sorting position within the sorted sequence;
generating a series of numbers depending on a relation between the original and sorting positions of the samples, and determining coefficients of a prediction filter on the basis of the series of numbers; and
encoding the sorted samples and the coefficients.

94. An apparatus for decoding a sequence of samples of an information signal, with each sample within the sequence comprising an original position, comprising:
a receiver for receiving coefficients of a prediction filter and a sequence of samples, with each sample comprising a sorting position;
a predictor for predicting a series of numbers on the basis of the coefficients; and
a re-sorter for re-sorting the sequence of samples on the basis of the series of numbers, so that each sample comprises its original position.

95. The apparatus according to claim 94, wherein the information signal comprises an audio signal.

96. The apparatus according to claim 94, wherein the predictor for predicting the series of numbers predicts an index permutation or an inversion chart as the series of numbers.

97. The apparatus according to claim 94, wherein the receiver is further formed to receive an encoded residual signal, and the predictor is formed to take the residual signal into account in the prediction of the series of numbers.

98. The apparatus according to claim 94, further comprising a decoder for decoding formed to decode samples, residual signals or coefficients in accordance with differential or entropy coding.

99. A method of decoding a sequence of samples of an information signal, with each sample within the sequence comprising an original position, comprising:
receiving coefficients of a prediction filter and a sequence of samples, with each sample comprising a sorting position;
predicting a series of numbers on the basis of the coefficients; and
re-sorting the sequence of samples on the basis of the series of numbers, so that each sample comprises its original position.

100. An apparatus for encoding a sequence of samples, with each sample within the sequence comprising an original position, comprising:
a sorter for sorting the samples depending on their sizes, in order to acquire a sorted sequence of samples, with each sample comprising a sorting position within the sorted sequence; and
an encoder for encoding the sorted samples and for encoding a series of numbers with information on the relation between the original and sorting positions of the samples, with each element within the series of numbers being unique, and with the encoder associating a number of bits with an element of the series of numbers, such that the number of bits associated with a first element is greater than the number of bits associated with a second element if, prior to the encoding of the first element, less elements have already been encoded than prior to the encoding of the second element.

101. The apparatus according to claim 100, wherein the encoder is formed to encode a series of numbers of the length N and to encode a number of X elements at the same time, wherein G bits are associated with the number of X elements, according to
$$G = ⌈ {log}_{2} ( \frac{N !}{( N - X ) !} ) ⌉ \qquad with 0 < X \leq N .$$

102. The apparatus according to claim 100, wherein the encoder is formed to encode a series of numbers of the length N, wherein X is a number of already encoded elements of the series of numbers, wherein G bits are associated with the next element of the series of numbers, according to
G=┌log₂(N−X)┐ with 0≦X<N.

103. A method of encoding a sequence of N samples, with each sample within the sequence comprising an original position, comprising:
sorting the samples depending on the sizes, in order to acquire a sorted sequence of samples, with each sample comprising a sorting position within the sorted sequence;
encoding the sorted samples; and
encoding a series of numbers with information on the relation between the original and sorting positions of the samples, with each element within the series of numbers being unique, and with a number of bits being associated with an element of the series of numbers when encoding, such that the number of bits associated with a first element is greater than the number of bits associated with a second element if,
prior to the encoding of the first element, less elements have already been encoded than prior to the encoding of the second element.

104. An apparatus for decoding a sequence of samples, with each sample within the sequence comprising an original position, comprising:
a receiver for receiving an encoded series of numbers and a sequence of samples, each sample comprising a sorting position;
a decoder for decoding a decoded series of numbers with information on a relation between the original and sorting positions on the basis of the encoded series of numbers, with each element within the encoded series of numbers being unique, and with the decoder associating a number of bits with an element of the series of numbers, such that the number of bits associated with a first element is greater than the number of bits associated with a second element if, prior to the decoding of the first element, less elements have already been decoded than prior to the encoding of the second element; and
a re-sorter for re-sorting the sequence of samples on the basis of the decoded series of numbers, so that each sample within the decoded sequence comprises its original position.

105. The apparatus according to claim 104, wherein the decoder is formed to decode a series of numbers of the length N and to decode a number of X elements at the same time, wherein G bits are associated with the number of X elements, according to
$$G = ⌈ {log}_{2} ( \frac{N !}{( N - X ) !} ) ⌉ \qquad with 0 < X \leq N .$$

106. The apparatus according to claim 104, wherein the decoder is formed to decode a series of numbers of the length N, wherein X is a number of already encoded elements of the series of numbers, wherein G bits are associated with the next element of the series of numbers, according to
G=┌log₂(N−X)┐ with 0≦X<N.

107. A method of decoding a sequence of samples, with each sample within the sequence comprising an original position, comprising:
receiving an encoded series of numbers and a sequence of samples, with each sample comprising a sorting position;
decoding the encoded series of numbers with information on a relation between the original and sorting positions on the basis of the encoded series of numbers, with each element within the decoded series of numbers being unique, and with a number of bits being associated with an element of the series of numbers when decoding, such that the number of bits associated with a first element is greater than the number of bits associated with a second element if, prior to the decoding of the first element, less elements have already been decoded than prior to the encoding of the second element; and
re-sorting the sequence of samples on the basis of the decoded series of numbers, so that each sample within the decoded sequence comprises its original position.
